(19) United States
(12) Patent Application Publication
(10) Pub. No.: US 2026/0252098 A1
(43) Pub. Date: Aug. 27, 2026

(54) AUTONOMOUS GOLF VEHICLE SYSTEM

(71) Applicant: Textron Inc., Providence, RI (US)

(72) Inventors: Samuel Smith, Martinez, GA (US); Charles Daniel Dauchess, North Augusta, SC (US); Ricky Veldee Kemp, Augusta, GA (US); Donny Lee Hammond, Augusta, GA (US); Baily Guyton Wood, Dublin, GA (US); Trevor Douglas Roebuck, Evans, GA (US)

(73) Assignee: Textron Inc., Providence, RI (US)

(21) Appl. No.: 19/061,645

(22) Filed: Feb. 24, 2025

(51) Int. Cl. G05D 1/646; G05D 1/223; G05D 1/248; G05D 1/644; G05D 105/22; G05D 107/20; G05D 109/10

(52) U.S. Cl. CPC G05D 1/646; G05D 1/223; G05D 1/248; G05D 1/644; G05D 2105/22; G05D 2107/24; G05D 2109/10

(57) ABSTRACT

An autonomous golf cart system includes one or more processing circuits configured to generate a green location proximate a green of a hole of a golf course, monitor a current location of an autonomous golf cart, acquire sensor data regarding an area of the golf course surrounding the autonomous golf cart, and control operation of the autonomous golf cart to navigate from the current location to the green location based on the sensor data.

### BACKGROUND

Golf carts are commonly used by golfers while playing a round of golf to drive between holes, to their ball, and to carry their bags. Other vehicles, such as drink carts, ground maintenance vehicles, recreational vehicles, utility vehicles, etc. are also commonly found at a golf course.

### SUMMARY

One embodiment relates to an autonomous golf cart system. The autonomous golf cart system includes one or more processing circuits configured to generate a green location proximate a green of a hole of a golf course, monitor a current location of an autonomous golf cart, acquire sensor data regarding an area of the golf course surrounding the autonomous golf cart, and control operation of the autonomous golf cart to navigate from the current location to the green location based on the sensor data.

Another embodiment relates to an autonomous golf vehicle. The autonomous golf vehicle includes a plurality of tractive elements, a prime mover configured to drive at least one of the plurality of tractive elements to propel the autonomous golf vehicle, a steering system configured to steer at least one of the plurality of tractive elements, a sensor system, and one or more processing circuits configured to acquire an indication of a green location proximate a green of a golf course, acquire sensor data from the sensor system regarding an area of the golf course surrounding the autonomous golf vehicle, and control the prime mover and the steering system to navigate the autonomous golf vehicle from a current location to the green location based on the sensor data.

Still another embodiment relates to an autonomous golf cart system. The autonomous golf cart system includes an autonomous golf cart and one or more processing circuits. The autonomous golf cart includes a plurality of tractive elements, a prime mover configured to drive at least one of the plurality of tractive elements to propel the autonomous golf cart, a steering system configured to steer at least one of the plurality of tractive elements, and a sensor system configured to acquire sensor data regarding an area of a golf course surrounding the autonomous golf cart, the golf course including a green and a cart path. The one or more processing circuits are configured to generate a green location proximate the green of the golf course, monitor a current location of the autonomous golf cart, and control the prime mover and the steering system to navigate the autonomous golf cart at least partially along the cart path from the current location to the green location based on the sensor data.

This summary is illustrative only and is not intended to be in any way limiting. Other aspects, inventive features, and advantages of the devices or processes described herein will become apparent in the detailed description set forth herein, taken in conjunction with the accompanying figures, wherein like reference numerals refer to like elements.

### BRIEF DESCRIPTION OF THE DRAWINGS

FIG. 1A is a front perspective view of a vehicle, according to an exemplary embodiment.

FIG. 1B is a rear perspective view of the vehicle of FIG. 1A, according to an exemplary embodiment.

FIG. 2 is a schematic block diagram of the vehicle of FIG. 1A, according to an exemplary embodiment.

FIG. 3 is another schematic block diagram of the vehicle of FIG. 1A, according to an exemplary embodiment.

FIG. 4 is a schematic block diagram of a fleet monitoring and control system including a plurality of the vehicles of FIG. 1A, according to an exemplary embodiment.

FIG. 5 is a schematic diagram of a golf course upon which the vehicle of FIG. 1A drives, according to an exemplary embodiment.

FIG. 6 is a schematic diagram of a golf course including the vehicle of FIG. 1A, according to an exemplary embodiment.

FIG. 7 is a schematic diagram of a golf course including the vehicle of FIG. 1A, according to an exemplary embodiment.

FIG. 8 is a flow diagram of a method for traversing a route from a current location to a final location in a staging area proximate a green, according to an exemplary embodiment.

FIG. 9 is a schematic block diagram of the vehicle of FIG. 1 configured with a go to green functionality, according to an exemplary embodiment.

FIG. 10 is an illustrative view of a vehicle demarcated with path pylons, according to an exemplary embodiment.

FIG. 11 is an illustrative view of a cart path demarcated with landmark indicators, according to an exemplary embodiment.

FIG. 12 is an illustrative view of a cart path demarcated with specific surface materials, according to an exemplary embodiment.

FIG. 13 is an illustrative view of a cart path demarcated with path beacons, according to an exemplary embodiment.

FIG. 14 is an illustrative view of a cart path demarcated with a path stripe, according to an exemplary embodiment.

FIG. 15 is an illustrative view of path markers with direction indicators, according to an exemplary embodiment.

FIG. 16 is an overhead view of a golf course with direction finding towers, according to an exemplary embodiment.

FIG. 17 is a flow diagram of a method for traversing a path back to the cart path, according to an exemplary embodiment.

FIG. 18 is a flow diagram of a method for navigation by similarity scores of an image, according to an exemplary embodiment.

FIG. 19 is a flow diagram of a method for navigation along a cart path, according to an exemplary embodiment.

FIG. 20 overhead view of a cart path showing various routes to a final location proximate the green, according to an exemplary embodiment.

FIG. 21 is a cart path connectivity graph used for optimizing the distance traveled to the final destination, according to an exemplary embodiment.

FIG. 22 is a block diagram for a method for determining a route, according to an exemplary embodiment.

FIG. 23 is a block diagram for a method for operating the vehicle of FIG. 1A along a route, according to an exemplary embodiment.

FIG. 24A is a schematic diagram of a golf course upon which the vehicle of FIG. 1A drives, according to an exemplary embodiment.

FIG. 24B is a schematic diagram of a golf course upon which the vehicle of FIG. 1A drives, according to an exemplary embodiment.

FIG. 25 is a perspective of view of the vehicle of FIG. 1A including an activator system including a first activator, according to an exemplary embodiment.

FIG. 26 is a perspective of view of the vehicle and the activator system of FIG. 25 including a second activator, according to an exemplary embodiment.

FIG. 27 is a perspective of view of the vehicle and the activator system of FIG. 25 including a third activator, according to an exemplary embodiment.

FIG. 28 is a perspective of view of the vehicle and the activator system of FIG. 25 including a fourth activator, according to an exemplary embodiment.

FIG. 29 is a schematic diagram of a golf course upon which the vehicle of FIG. 1A including the activator system of any one of FIGS. 25-28 drives, according to an exemplary embodiment.

FIG. 30 is a schematic illustration of an operating environment for a vehicle, according to an exemplary embodiment.

FIG. 31 is a schematic illustration of the operating environment shown in FIG. 30 including a user device associated with a user and a fixed button, according to an exemplary embodiment.

FIG. 32 is a schematic illustration of multiple routes for a vehicle to navigate along a cart path toward a user identified by a control system, according to an exemplary embodiment.

FIG. 33 is a flow diagram illustrating a method for determining and executing an optimal route based on a summon command, according to an exemplary embodiment.

FIG. 34 is a diagram of a vehicle passing operation for the vehicle of FIG. 1A, according to an exemplary embodiment.

FIG. 35 is a diagram of a vehicle passing operation for the vehicle of FIG. 1A, according to an exemplary embodiment.

FIG. 36 is a flow diagram of a method of performing a vehicle passing operation for the vehicle of FIG. 1A, according to an exemplary embodiment.

FIG. 37 is a flow diagram of a method for performing a vehicle passing operation for the vehicle of

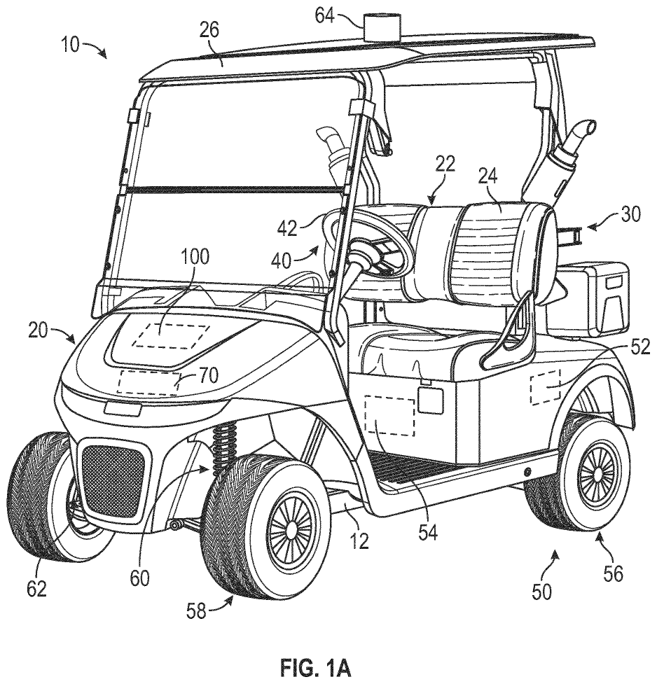

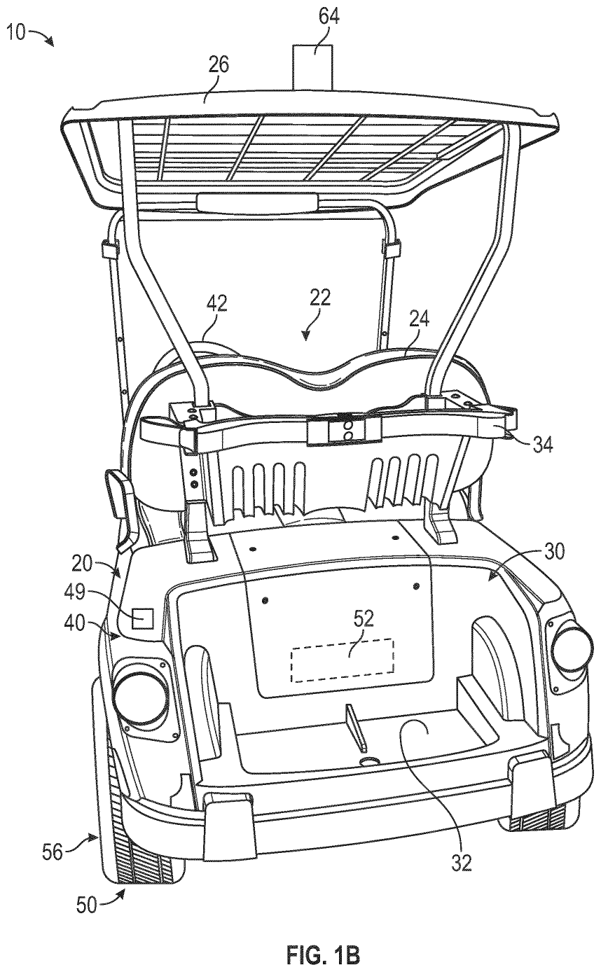

FIG. 1A, according to an exemplary embodiment.

FIG. 38 is a schematic illustration of a golfer within the vehicle of FIG. 1A, according to an exemplary embodiment.

FIG. 39 is a schematic illustration of a golfer within an occupant area and a golfer on a storage area of the vehicle of FIG. 1A, according to an exemplary embodiment.

FIG. 40 is a flow diagram of a method for manipulating an autonomous mode of operation based on a detected occupancy, according to an exemplary embodiment.

FIG. 41 is a perspective view of a plurality of the vehicles of FIG. 1A, according to an exemplary embodiment.

FIG. 42 is a flow chart of a method for operating an indicator of a vehicle, according to an exemplary embodiment.

FIG. 43 is a flow chart of a method for facilitating communication between a plurality of vehicles, according to an exemplary embodiment.

FIG. 44 is a flow chart of a method for operating a vehicle, according to an exemplary embodiment.

### DETAILED DESCRIPTION

Before turning to the figures, which illustrate certain exemplary embodiments in detail, it should be understood that the present disclosure is not limited to the details or methodology set forth in the description or illustrated in the figures. It should also be understood that the terminology used herein is for the purpose of description only and should not be regarded as limiting.

### Overall Vehicle

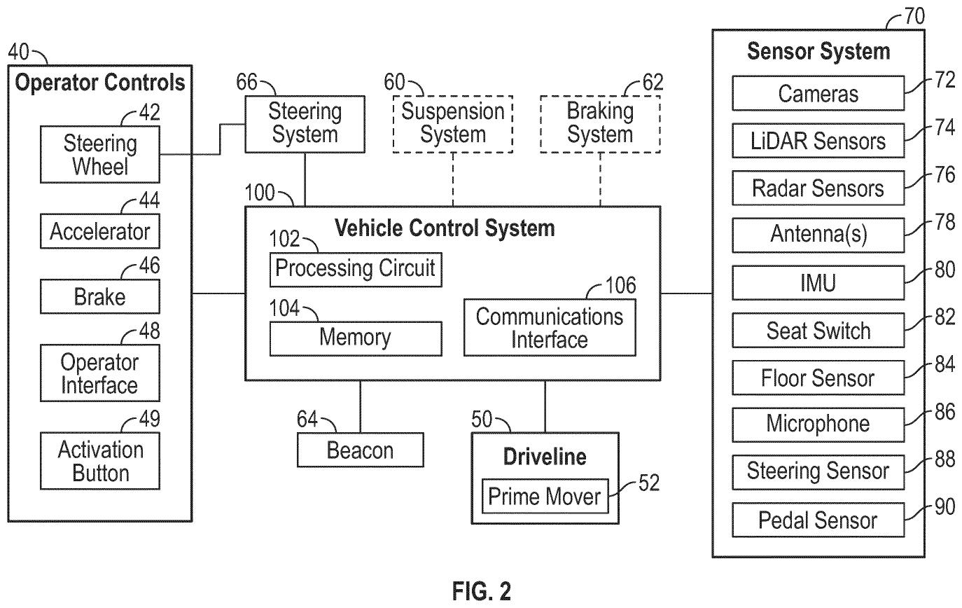

As shown in FIGS. 1A-2, a machine or vehicle, shown as vehicle 10, includes a chassis, shown as frame 12; a body assembly, shown as body 20, coupled to the frame 12 and having an occupant portion, section, or area, shown as occupant seating area 22, and a storage portion, section, or area, shown as bagwell 30; operator input and output devices, shown as operator controls 40, that are disposed within the occupant seating area 22 and/or the bagwell 30; a drivetrain, shown as driveline 50, coupled to the frame 12 and at least partially disposed under the body 20; a vehicle suspension system, shown as suspension system 60, coupled to the frame 12 and one or more components of the driveline 50; a vehicle braking system, shown as braking system 62, coupled to one or more components of the driveline 50 to facilitate selectively braking the one or more components of the driveline 50; an external indicator, shown as beacon 64; a steering assembly, shown as steering system 66; a plurality of first sensors, shown as sensor system 70; and a control system, shown as vehicle control system 100, coupled to the operator controls 40, the driveline 50, the suspension system 60, the braking system 62, and the sensor system 70. In some embodiments, the vehicle 10 includes more or fewer components.

According to the exemplary embodiment shown in FIGS. 1A and 1B, the vehicle 10 is configured as a golf vehicle or cart (e.g., a staff cart, a player cart, a drink cart or refresher, a golf course maintenance vehicle, etc.). In other embodiments, the vehicle 10 is a lightweight or recreational machine or vehicle such an all-terrain vehicle (“ATV”), a utility task vehicle (“UTV”), a low speed vehicle (“LSV”), a personal transport vehicle (“PTV”), a hauler, and/or another type of lightweight or recreational machine or vehicle. In still other embodiments, the vehicle 10 is a chore product such as a lawnmower, a turf mower, a push mower, a ride-on mower, a stand-on mower, an aerator, a turf sprayer, a bunker rake, another type of chore product that may be used on a golf course. In yet other embodiments, the vehicle 10 is a ground support equipment (“GSE”) that may be used at an airport and/or still other off-road machines or vehicles.

As shown in FIGS. 1A and 1B, the occupant seating area 22 includes a single row seating, shown as seating 24, with a roof structure, shown as canopy 26, positioned above the seating 24, and a floor surface, shown as floorboard 28, positioned beneath the seating 24. In some embodiments, the occupant seating area 22 includes one or more rear rows of seating positioned behind the seating 24. Such rear rows of seating may face forward and/or face rearward. In some embodiments, in addition to or in place of the rear seating, the vehicle 10 includes one or more rear accessories. Such rear accessories may include a golf bag rack, a bed, a cargo body (e.g., for a drink cart), and/or other rear accessories.

As shown in FIG. 1B, the bagwell 30 is positioned at the rear end of the body 20 and includes a storage compartment, shown as bag tub 32, and upper support or holder, shown as bag retention system 34. According to an exemplary embodiment, the bag tub 32 is configured to receive golf bags and the bag retention system 34 is configured to engage with an upper portion of the golf bags (e.g., via straps, retainers, etc.) to secure the golf bags within the bagwell 30.

According to an exemplary embodiment, the operator controls 40 are configured to provide an operator with the ability to control one or more functions of and/or provide commands to the vehicle 10 and the components thereof (e.g., turn on, turn off, drive, turn, brake, engage various operating modes, raise/lower an implement, etc.). As shown in FIGS. 1A-2, the operator controls 40 include a steering interface (e.g., a steering wheel, joystick(s), etc.), shown steering wheel 42, an accelerator interface (e.g., a pedal, a throttle, etc.), shown as accelerator 44, a braking interface (e.g., a pedal), shown as brake 46, one or more additional interfaces, shown as operator interface 48, and at least one autonomy activation button, shown as activation button 49. The operator interface 48 may include one or more displays and one or more input devices. The one or more displays may be or include a touchscreen, a LCD display, a LED display, a speedometer, gauges, warning lights, etc. The one or more input devices may be or include buttons, switches, knobs, levers, dials, etc. As shown in FIG. 1B, the activation button 49 is positioned at the rear of the vehicle 10, in or proximate the bagwell 30. In some embodiments, the activation button 49 is additionally or alternatively positioned. By way of example, the activation button 49 may additionally or alternatively be positioned within the occupant seating area 22. By way of another example, the activation button 49 additionally or alternatively be provided as a graphical user interface (“GUI”) element via the display of the operator interface 48.

According to an exemplary embodiment, the driveline 50 is configured to propel the vehicle 10. As shown in FIGS. 1A-2, the driveline 50 includes a primary driver, shown as prime mover 52, an energy storage device, shown as energy storage 54, a first tractive assembly (e.g., axles, wheels, tracks, differentials, etc.), shown as rear tractive assembly 56, and a second tractive assembly (e.g., axles, wheels, tracks, differentials, etc.), shown as front tractive assembly 58. In some embodiments, the driveline 50 is a conventional driveline whereby the prime mover 52 is an internal combustion engine and the energy storage 54 is a fuel tank. The internal combustion engine may be a spark-ignition internal combustion engine or a compression-ignition internal combustion engine that may use any suitable fuel type (e.g., diesel, ethanol, gasoline, natural gas, propane, etc.). In some embodiments, the driveline 50 is an electric driveline whereby the prime mover 52 is an electric motor (e.g., the motor 53) and the energy storage 54 is a battery system (e.g., the battery module 57, the add-on battery module(s) 59, etc.). In some embodiments, the driveline 50 is a fuel cell electric driveline whereby the prime mover 52 is an electric motor and the energy storage 54 is a fuel cell (e.g., that stores hydrogen, that produces electricity from the hydrogen, etc.). In some embodiments, the driveline 50 is a hybrid driveline whereby (i) the prime mover 52 includes an internal combustion engine and an electric motor/generator and (ii) the energy storage 54 includes a fuel tank and/or a battery system. According to the exemplary embodiment shown in FIGS. 1A and 1B, the rear tractive assembly 56 includes rear tractive elements and the front tractive assembly 58 includes front tractive elements that are configured as wheels. In some embodiments, the rear tractive elements and/or the front tractive elements are configured as tracks.

According to an exemplary embodiment, the prime mover 52 is configured to provide power to drive the rear tractive assembly 56 and/or the front tractive assembly 58 (e.g., to provide front-wheel drive, rear-wheel drive, four-wheel drive, and/or all-wheel drive operations). In some embodiments, the driveline 50 includes a transmission device (e.g., a gearbox, a continuous variable transmission (“CVT”), etc.) positioned between (a) the prime mover 52 and (b) the rear tractive assembly 56 and/or the front tractive assembly 58. The rear tractive assembly 56 and/or the front tractive assembly 58 may include a drive shaft, a differential, and/or an axle. In some embodiments, the rear tractive assembly 56 and/or the front tractive assembly 58 include two axles or a tandem axle arrangement. In some embodiments, the rear tractive assembly 56 and/or the front tractive assembly 58 are steerable (e.g., using the steering wheel 42, via the steering system 66, etc.). In some embodiments, both the rear tractive assembly 56 and the front tractive assembly 58 are fixed and not steerable (e.g., employ skid steer operations).

In some embodiments, the driveline 50 includes a plurality of prime movers 52. By way of example, the driveline 50 may include a first prime mover 52 that drives the rear tractive assembly 56 and a second prime mover 52 that drives the front tractive assembly 58. By way of another example, the driveline 50 may include a first prime mover 52 that drives a first one of the front tractive elements, a second prime mover 52 that drives a second one of the front tractive elements, a third prime mover 52 that drives a first one of the rear tractive elements, and/or a fourth prime mover 52 that drives a second one of the rear tractive elements. By way of still another example, the driveline 50 may include a first prime mover 52 that drives the front tractive assembly 58, a second prime mover 52 that drives a first one of the rear tractive elements, and a third prime mover 52 that drives a second one of the rear tractive elements. By way of yet another example, the driveline 50 may include a first prime mover 52 that drives the rear tractive assembly 56, a second prime mover 52 that drives a first one of the front tractive elements, and a third prime mover 52 that drives a second one of the front tractive elements.

According to an exemplary embodiment, the suspension system 60 includes one or more suspension components (e.g., shocks, dampers, springs, etc.) positioned between the frame 12 and one or more components (e.g., tractive elements, axles, etc.) of the rear tractive assembly 56 and/or the front tractive assembly 58. In some embodiments, the vehicle 10 does not include the suspension system 60.

According to an exemplary embodiment, the braking system 62 includes one or more braking components (e.g., disc brakes, drum brakes, in-board brakes, axle brakes, etc.) positioned to facilitate selectively braking one or more components of the driveline 50. In some embodiments, the one or more braking components include (i) one or more front braking components positioned to facilitate braking one or more components of the front tractive assembly 58 (e.g., the front axle, the front tractive elements, etc.) and (ii) one or more rear braking components positioned to facilitate braking one or more components of the rear tractive assembly 56 (e.g., the rear axle, the rear tractive elements, etc.). In some embodiments, the one or more braking components include only the one or more front braking components. In some embodiments, the one or more braking components include only the one or more rear braking components. In some embodiments, the one or more front braking components include two front braking components, one positioned to facilitate braking each of the front tractive elements. In some embodiments, the one or more rear braking components include two rear braking components, one positioned to facilitate braking each of the rear tractive elements. In some embodiments, electric regenerative braking is employed (e.g., via the prime mover 52, an electric motor, etc.) in combination with or instead of using the braking system 62 to facilitate braking of one or more components of the driveline 50. In such embodiments, the vehicle 10 may not include the braking system 62.

As shown in FIGS. 1A and 1B, the beacon 64 is positioned on top of the canopy 26. In other embodiments, the beacon 64 is otherwise positioned (e.g., at the front of the body 20, at the rear of the body 20, etc.). In some embodiments, the vehicle 10 includes a plurality of the beacons 64 positioned variously about the body 20. According to an exemplary embodiment, the beacon 64 is configured to include one or more lights and/or a speaker. The one or more lights and/or the speaker may be controlled to indicate a mode of operation of the vehicle 10 to the surrounding environment (e.g., golfers, other drivers, other vehicles 10, etc.). The one or more lights of the beacon 64 may be configured to emit various colors and/or light patterns to indicate the mode of operation of the vehicle 10. By way of example, a first light color (e.g., green) or pattern (e.g., a solid light) may indicate a manual mode of operation of the vehicle 10, while a second color (e.g., red) or pattern (e.g., flashing) may indicate an autonomous mode of operation of the vehicle 10. By way of another example, deactivation of the one or more lights may indicate the manual mode of operation of the vehicle 10 and activation of the one or more lights may indicate the autonomous mode of operation. The speaker may be configured to emit one or more tones or sounds to indicate the mode of operation of the vehicle 10. By way of example, a first sound may indicate the manual mode of operation of the vehicle 10, while a second sound may indicate the autonomous mode of operation of the vehicle 10. By way of another example, deactivation of the speaker may indicate the manual mode of operation of the vehicle 10 and activation of the speaker may indicate the autonomous mode of operation.

Additionally or alternatively, the beacon 64 may include a first set of lights positioned at the front of the body 20 (e.g., headlights) and/or a second set of lights positioned at the rear of the body 20 (e.g., taillights). The first set of lights and the second set of lights may be controlled to indicate (e.g., signal, communicate, etc.) with the surrounding environment (e.g., golfers, other drivers, other vehicles 10, etc.). The first set of lights of the beacon 64 may signal to other vehicles 10 ahead of the vehicle 10. By way of example, a light color or pattern of the first set of lights may indicate that the vehicle 10 is requesting to pass (e.g., move ahead of) a different vehicle 10. The second set of lights of the beacon 64 may signal to other vehicles 10 behind the vehicle 10. By way of example, a first light color or a first pattern of the second set of lights may indicate that the vehicle 10 has accepted a request for passing. By way of another example, a second light color or a second pattern of the second set of lights may indicate that passing the vehicle 10 is prohibited (e.g., due to obstacles, path constraints, etc.).

The steering system 66 may be configured to facilitate powered-steering based on user inputs to the steering wheel 42 and/or facilitate autonomous steering operations by the vehicle control system 100. The steering system 66 may include a rack, a pinion, a motor, and/or other steering components to provide powered or electronically-controlled steering capabilities.

The sensor system 70 may include various sensors positioned about the vehicle 10 to acquire (a) first information or data regarding operation of the vehicle 10, (b) second information or data regarding operation of proximate vehicles, (c) third information or data regarding the location of the vehicle 10, and (d) fourth information or data regarding the location of other vehicles or external objects (e.g., obstacles, boulders, trees, sandtraps, golfer, golf course staff, bodies of water, etc.). As shown in FIG. 2, the sensor system 70 includes one or more optical, proximity, or object detection sensors, shown as cameras 72, LiDAR sensors 74, and radar sensors 76. The cameras 72 may be variously positioned about the body 20 to capture or acquire data regarding the surrounding environment of the vehicle 10, the occupant seating area 22, and/or the bagwell 30. By way of example, the cameras 72 may include a plurality of first or exterior cameras including one or more forward facing cameras, one or more rearward facing cameras, and/or one or more side facing cameras positioned to facilitate monitoring the surrounding environment in front of, behind, and/or to the side of the vehicle 10 (e.g., to provide 360 degrees of view around the vehicle 10; for determining the location of objects, hazards, other vehicles, people, etc.; etc.). By way of another example, the cameras 72 may include one or more second or interior cameras positioned to facilitate monitoring the occupant seating area 22 and/or the bagwell 30. The LiDAR sensors 74 and the radar sensors 76 may be variously positioned about the body 20 to capture or acquire data regarding the surrounding environment of the vehicle 10 (e.g., the location of objects, hazards, other vehicles, people, etc.). In some embodiments, the LiDAR sensors 74 and/or the radar sensors 76 are mounted to the vehicle 10 lower than the cameras 72 (e.g., to minimize negative impacts of inclement weather such as precipitation, fog, etc.). In some embodiments, the sensor system 70 includes ultrasonic sensors in addition to or in place of the cameras 72, the LiDAR sensors 74, and/or the radar sensors 76.

As shown in FIG. 2, the sensor system 70 includes one or more communication devices, position sensors, or antennas, shown as antennas 78. The antennas 78 may be configured to capture or acquire data to facilitate determining a location of the vehicle 10 (e.g., on the golf course 300). The antennas 78 may include one or more longer range antennas (e.g., GPS antennas) configured to communicate with a remote GPS system (e.g., the remote systems 240, a GPS satellite, etc.) and one or more shorter range antennas (e.g., a Bluetooth antenna, a Wi-Fi antenna, a radio frequency (“RF”) antenna, etc. configured to communicate with devices and/or systems proximate the location of the vehicle 10 (e.g., RFID tags, Bluetooth beacons, markers, etc.). The longer range antennas may be mounted to the vehicle 10 at locations high on the vehicle 10 (e.g., the canopy 26) to eliminate obstructions in communication between the longer range antennas and the remote GPS system.

As shown in FIG. 2, the sensor system 70 includes one or more occupant detection sensors, shown as inertial measurement unit (“IMU”) 80, seat switch 82, floor sensor 84, microphone 86, steering sensor 88, and pedal sensor 90. The various occupant detection sensors may be used in combination with or in place of the interior cameras of the cameras 72 to detect the presence of an occupant within the occupant seating area 22, within the bagwell 30, or otherwise on the vehicle 10. The IMU 80 may include an accelerometer, a gyroscope, a compass, and/or magnetometer. The seat switch 82 may be positioned to facilitate detecting when an occupant is sitting on the seating 24. The floor sensor 84 may be positioned to facilitate detecting when an occupant is standing on the floorboard 28. The microphone 86 may be configured to facilitate detecting the voices of occupants within the occupant seating area 22. The steering sensor 88 may be configured to facilitate detecting an operator input to the steering wheel 42. The pedal sensor 90 may be configured to facilitate detecting an operator input to the accelerator 44 and/or the brake 46. In some embodiments, one or more of the antennas 78 are configured to function like an occupant detection sensor. By way of example, the one or more antennas 78 may be configured to facilitate detecting a key fob or device (e.g., user sensor 220, user device 232, etc.) carried by an operator of the vehicle 10. In some embodiments, the sensor system 70 includes one or more driveline sensors (e.g., motor sensor 92, motor controller sensor 94, BMS sensor 96, etc.). In such embodiments, the one or more driveline sensors are configured to function like an occupant detection sensor. By way of example, the one or more driveline sensors may be configured to facilitate detecting loaded or unloaded operation of the vehicle 10 based on driveline loads.

The vehicle control system 100 may be implemented as a general-purpose processor, an application specific integrated circuit (“ASIC”), one or more field programmable gate arrays (“FPGAs”), a digital-signal-processor (“DSP”), circuits containing one or more processing components, circuitry for supporting a microprocessor, a group of processing components, or other suitable electronic processing components. According to the exemplary embodiment shown in FIG. 2, the vehicle control system 100 includes a processing circuit 102, a memory 104, and a communications interface 106. The processing circuit 102 may include an ASIC, one or more FPGAs, a DSP, circuits containing one or more processing components, circuitry for supporting a microprocessor, a group of processing components, or other suitable electronic processing components. In some embodiments, the processing circuit 102 is configured to execute computer code stored in the memory 104 to facilitate the activities described herein. The memory 104 may be any volatile or non-volatile or non-transitory computer-readable storage medium capable of storing data or computer code relating to the activities described herein. According to an exemplary embodiment, the memory 104 includes computer code modules (e.g., executable code, object code, source code, script code, machine code, etc.) configured for execution by the processing circuit 102. In some embodiments, the vehicle control system 100 may represent a collection of processing devices. In such cases, the processing circuit 102 represents the collective processors of the devices, and the memory 104 represents the collective storage devices of the devices.

In one embodiment, the vehicle control system 100 is configured to selectively engage, selectively disengage, control, or otherwise communicate with components of the vehicle 10 (e.g., via the communications interface 106, a controller area network (“CAN”) bus, etc.). According to an exemplary embodiment, the vehicle control system 100 is coupled to (e.g., communicably coupled to) components of the operator controls 40 (e.g., the steering wheel 42, the accelerator 44, the brake 46, the operator interface 48, the activation button, etc.), components of the driveline 50 (e.g., the prime mover 52), components of the braking system 62, the beacon 64, the steering system 66, and the sensor system 70. By way of example, the vehicle control system 100 may send and receive signals (e.g., control signals, location signals, etc.) with the components of the operator controls 40, the components of the driveline 50, the components of the braking system 62, the beacon 64, the steering system 66, the sensor system 70, and/or remote systems or devices (via the communications interface 106 as described in greater detail herein).

### Electrified Driveline

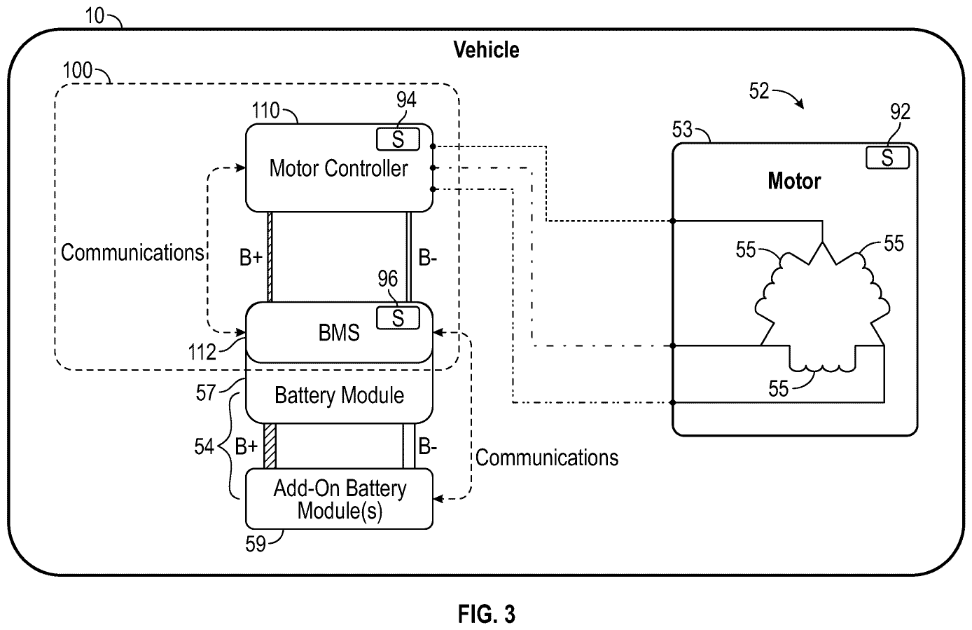

According to the exemplary embodiments shown in FIG. 3, the driveline 50 of the vehicle 10 is configured as an electrified driveline where (a) the prime mover 52 is configured as a three-phase, alternating current (“AC”) electric motor, shown as motor 53, including three sets of windings, shown as motor windings 55, and a first sensor, shown as motor sensor 92; (b) the energy storage 54 is configured as a battery system including a first battery pack or module, shown as battery module 57, and one or more second battery packs or modules, shown as add-on battery module(s) 59, electrically coupled to the battery module 57 in parallel; and (c) the vehicle control system 100 includes (i) a first controller, shown as motor controller 110, coupled to the motor 53 and including a second sensor, shown as motor controller sensor 94, and (ii) a second controller, shown as battery management system (“BMS”) 112, coupled to the motor controller 110 and the energy storage 54 (e.g., the battery system, the battery module 57, the add-on battery module(s) 59, etc.) and including a third sensor, shown as BMS sensor 96. In some embodiments, the motor 53 is configured as a separately excited DC motor. The motor sensor 92, the motor controller sensor 94, and/or the BMS sensor 96 may include a temperature sensor, a voltage sensor, a current sensor, a speed sensor, and/or another suitable sensor to facilitate monitoring at least one of the operational parameters (e.g., temperature, voltage, current, speed, SOC, rate of charge, rate of discharge, etc.) of the motor 53, the motor controller 110, the BMS 112, the battery module 57, and/or the add-on battery modules(s) 59. The motor controller 110 and the BMS 112 may each include a processing circuit 102, a memory 104, and a communications interface 106.

According to an exemplary embodiment, each of the battery module 57 and the add-on battery module(s) 59 of the battery system includes one or more rows and/or groups of battery cells. The BMS 112 may be configured to monitor characteristics of the rows and/or groups of battery cells and/or individual cells of the battery module 57 and the add-on battery module(s) 59 (e.g., using data acquired by the BMS sensor 96) including, but not limited to, voltage, temperature, current, and state of charge (“SOC”). The BMS 112 may also be configured to provide direct current (“DC”) power from the battery system to the motor controller 110 to power the motor 53 based on driving demands of the vehicle 10.

According to an exemplary embodiment, the motor controller 110 is configured to manage the power supplied to the motor 53. By way of example, the motor controller 110 may be configured to modulate the voltage, current, phase, and/or frequency of the power sent to the motor windings 55, which can influence the torque and speed output provided by the motor 53. In some embodiments, the motor controller 110 is configured to control a type of power, AC power or DC power, delivered to the motor 53. By way of example, the motor controller 110 may be configured to convert the type of power from DC power to AC power and/or regulate the AC power or DC power depending on the intended function of the motor 53. The motor controller 110 may include components to invert, convert, or otherwise modulate DC power and/or AC power.

As shown in FIG. 3, the energy storage 54 is configured to supply (e.g., via electrical wiring, electrical connections, etc.) DC power to the motor controller 110. In some embodiments, the DC power flows from the energy storage 54, through the BMS 112, and to the motor controller 110. The BMS 112 and the motor controller 110 may include communication interfaces (e.g., communications interfaces 106) that facilitate exchanging data related to operational status, command signals, and feedback therebetween. The BMS 112 and the add-on battery module 59 (e.g., a BMS thereof) may include communication interfaces that facilitate exchanging data related to operational status, command signals, and feedback therebetween. The add-on battery module(s) 59 is(are) configured to provide additional battery cells and increase the total energy storage capacity of the energy storage 54. As shown in FIG. 3, the battery module 57 and the add-on battery module(s) 59 are connected in parallel (e.g., via wires, connection busses, etc.) to provide for a pathway of electrical transfer. In other embodiments, the battery module 57 and the add-on battery module(s) 59 are connected in series.

According to an exemplary embodiment, the BMS 112 is configured to monitor (e.g., continuously, periodically, etc.) various parameters of the energy storage 54, including voltage, current, and temperature of each cell, rows/groups, and/or module within the energy storage 54. In some embodiments, the BMS 112 is configured to calculate or otherwise determine the SOC of the energy storage 54, the battery module 57, and/or the add-on battery module(s) 59. In some embodiments, the BMS 112 is configured to redistribute charge among the cells, rows/groups, and/or the modules to ensure an equal or substantially equal charge level throughout the energy storage 54. The BMS 112 can communicate with other systems or components or the vehicle 10 or with external devices (e.g., the remote systems 240) to report on battery status and diagnostics and/or to receive control commands.

According to an exemplary embodiment, the BMS 112 is configured to detect faults or failures in the energy storage 54 that may potentially lead to or that have caused an overcharge condition and, thereby, a thermal runaway event. By way of example, the BMS 112 may be configured to monitor the voltage of individual cells, rows/groups, or modules of the energy storage 54, and when deviations from normal voltage levels occur beyond a nominal range, the BMS 112 may determine that a fault or failure is present and that there is a potential for an overcharge condition or that there is an actual overcharge condition. In some implementations, the BMS 112 is configured to detect voltage imbalance or voltage imbalance trends. By way of another example, the BMS 112 may additionally or alternatively be configured to monitor current flows during charging and discharging of the energy storage 54 and identify unexpected fluctuations in current that may indicate that a fault or failure is present and that there is a potential for an overcharge condition or that there is an actual overcharge condition. By way of still another example, the BMS 112 may additionally or alternatively be configured to monitor the temperature of the cells, rows/groups, and/or modules of the energy storage 54 and identify anomalously high temperatures that may indicate that a fault or failure is present and that there is a potential for an overcharge condition or that there is an actual overcharge condition. It should be understood that the above example of detecting faults, failures, or overcharge conditions is provided for example purposes only and is not exhaustive. Other methods or techniques may be implemented to detect faults, failures, or overcharge conditions, which are intended to be included within the scope of the present disclosure.

### Fleet Monitoring and Control System

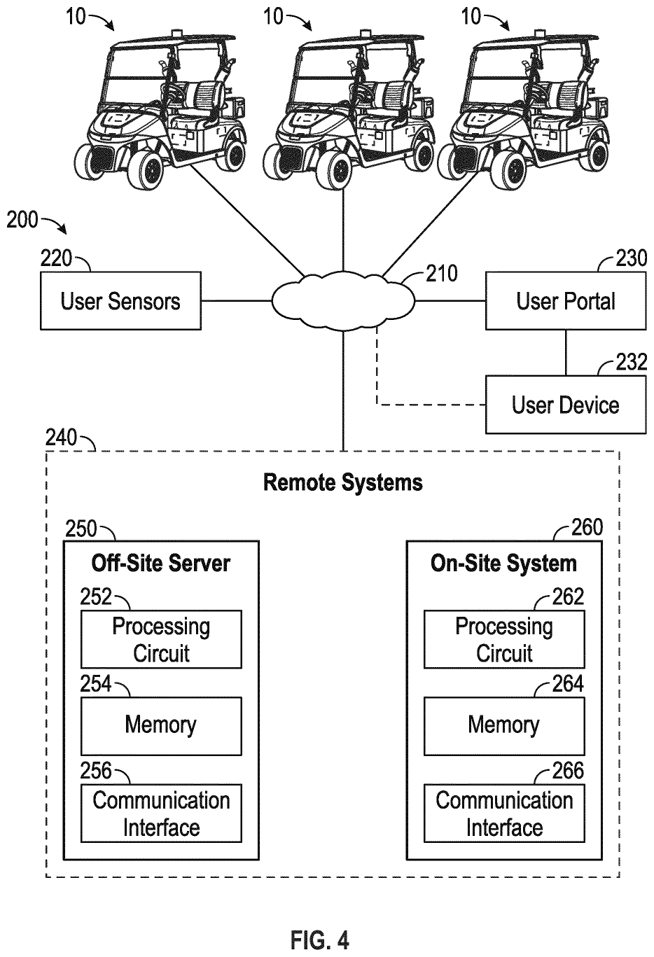

As shown in FIG. 4, a site monitoring and control system, shown as fleet monitoring and control system 200, includes one or more vehicles 10; one or more second sensors, shown as user sensors 220, positioned remote or separate from the vehicles 10; an operator interface, shown as user portal 230, positioned remote or separate from the vehicles 10; an external or remote user device, shown as user device 232, positioned remote or separate from the vehicles 10; and one or more external processing systems, shown as remote systems 240, positioned remote or separate from the vehicles 10. The vehicles 10, the user sensors 220, the user portal 230, the user device 232, and the remote systems 240 communicate via one or more communications protocols (e.g., Bluetooth, Wi-Fi, cellular, radio, through the Internet, etc.) through a network, shown as communications network 210. In some embodiments, the fleet monitoring and control system 200 does not includes the user portal 230 and/or the user device 232.

The user sensors 220 may be or include one or more sensors that are carried by or worn by an operator of one of the vehicles 10. By way of example, the user sensors 220 may be or include a wearable sensor (e.g., a smartwatch, a fitness tracker, a pedometer, a heart rate monitor, etc.) and/or a sensor that is otherwise carried by the operator (e.g., a smartphone, within the user device 232, a key fob for the vehicle 10, etc.) that facilitates acquiring and monitoring operator data (e.g., physiological conditions such a temperature, heartrate, breathing patterns, etc. ; location; movement; etc.) regarding the operator. The user sensors 220 may communicate directly with the vehicles 10, directly with the remote systems 240, and/or indirectly with the remote systems 240 (e.g., through the vehicles 10 as an intermediary).

The user portal 230 may be configured to facilitate operator access to dashboards including the vehicle data, the operator data, information available at the remote systems 240, etc. to manage and operate the site (e.g., golf course) such as for advanced scheduling purposes, to identify persons breaking course guidelines or rules, to monitor locations of the vehicles 10, etc. The user portal 230 may also be configured to facilitate operator implementation of configurations and/or parameters for the vehicles 10 and/or the site (e.g., setting speed limits, setting geofences, setting autonomous control parameters, etc.). As shown in FIG. 4, the user portal 230 is accessible via the user device 232. The user device 232 may be or include a computer, laptop, smartphone, tablet, or the like. The user portal 230 and the user device 232 may communicate via one or more communications protocols (e.g., Bluetooth, Wi-Fi, cellular, radio, through the Internet, wired connection, etc.) through a network (e.g., a CAN bus, the communications network 210, etc.). The user device 232 includes a display (e.g., a screen, etc.) configured to display one or more graphical user interfaces (“GUIs”) of the user portal 230. The user device 232 may additionally or alternatively communicate with the vehicles 10 (e.g., directly, via the communications network 210, etc.)

As shown in FIG. 4, the remote systems 240 include a first remote system, shown as off-site server 250, and a second remote system, shown as on-site system 260 (e.g., in a clubhouse of a golf course, on the golf course, etc.). In some embodiments, the remote systems 240 include only one of the off-site server 250 or the on-site system 260. As shown in FIG. 4, (a) the off-site server 250 includes a processing circuit 252, a memory 254, and a communications interface 256 and (b) the on-site system 260 includes a processing circuit 262, a memory 264, and a communications interface 266.

According to an exemplary embodiment, the remote systems 240 (e.g., the off-site server 250 and/or the on-site system 260) are configured to communicate with the vehicles 10 and/or the user sensors 220 via the communications network 210. By way of example, the remote systems 240 may receive the vehicle data from the vehicles 10 and/or the operator data from the user sensors 220. The remote systems 240 may be configured to perform back-end processing of the vehicle data and/or the operator data. The remote systems 240 may be configured to monitor various global positioning system (“GPS”) information and/or real-time kinematics (“RTK”) information (e.g., position/location, speed, direction of travel, geofence related information, etc.) regarding the vehicles 10 and/or the user sensors 220. The remote systems 240 may be configured to transmit information, data, commands, and/or instructions to the vehicles 10. By way of example, the remote systems 240 may be configured to transmit GPS data and/or RTK data based on the GPS information and/or RTK information to the vehicles 10 (e.g., which the vehicle control systems 100 may use to make control decisions). By way of another example, the remote systems 240 may send commands or instructions to the vehicles 10 to implement.

According to an exemplary embodiment, the remote systems 240 (e.g., the off-site server 250 and/or the on-site system 260) are configured to communicate with the user portal 230 via the communications network 210. By way of example, the user portal 230 may facilitate (a) accessing the remote systems 240 to access data regarding the vehicles 10 and/or the operators thereof and/or (b) configuring or setting operating parameters for the vehicles 10 (e.g., geofences, speed limits, times of use, permitted operators, autonomy settings, etc.). Such operating parameters may be propagated to the vehicles 10 by the remote systems 240 (e.g., as updates to settings) and/or used for real time control of the vehicles 10 by the remote systems 240.

### Vehicle Operating Environment

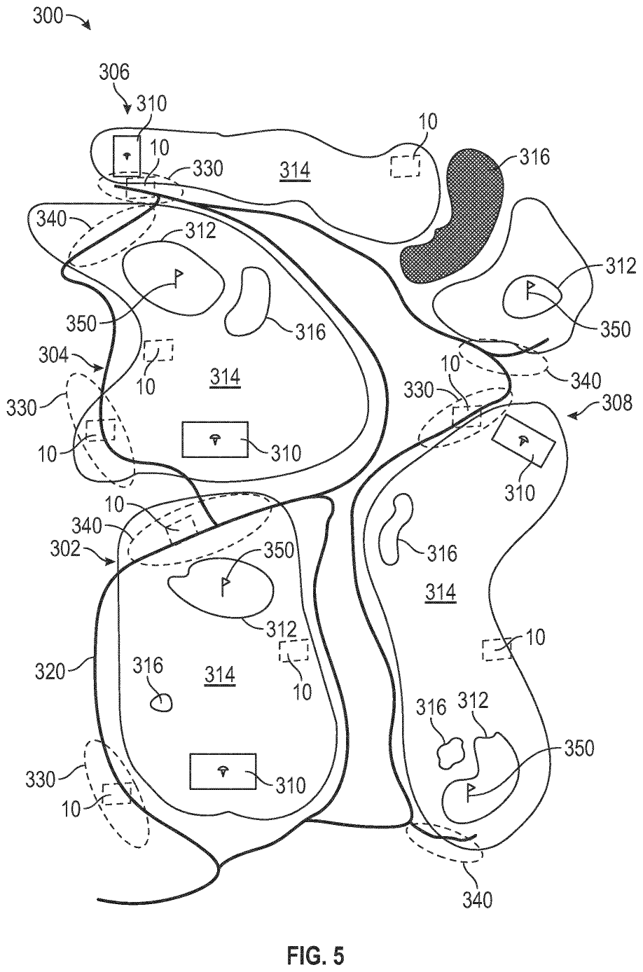

As shown in FIG. 5, the vehicles 10 are configured to be operated in a particular environment, shown as golf course 300. The golf course 300 includes a plurality of holes, shown as first hole 302, second hole 304, third hole 306, and fourth hole 308. Each of the first hole 302, the second hole 304, the third hole 306, and the fourth hole 308 includes a tee box 310, a green 312, a fairway 314, and/or one or more hazards 316 (e.g., a sand trap or bunker, a water hazard, etc.). The golf course 300 further includes a plurality of pathways, shown as cart path 320, connecting the plurality of holes such that the vehicles 10 can be driven along the cart path 320 between the plurality of holes to play a round of golf. Each of the holes also includes a first staging location, shown as tee staging location 330, and a second staging location, shown as green staging location 340. According to an exemplary embodiment, each of the tee staging locations 330 is an area (e.g., a pre-marked area, a pre-determined area, etc.) along or off to a side of the cart path 320 proximate the tee box 310 of a respective hole where the vehicle 10 should be parked when a golfer is teeing off or will be teeing off at the respective hole. Similarly, each of the green staging locations 340 is an area (e.g., a pre-marked area, a pre-determined area, etc. by a clubhouse or course staff person) along or off to a side of the cart path 320 proximate the green 312 of a respective hole where the vehicle 10 should be parked when a golfer is located or will be located at the respective hole (e.g., putting or will be putting at the respective hole, grabbing or will be grabbing a ball hit into the cup of the respective hole, grabbing or will be grabbing a ball hit onto the green 312 of the respective hole, etc.). As shown in FIG. 5, each of the greens 312 includes a hole marker or flag, shown as pin 350, used to mark the location of the cup and/or provide an indication of the current hole being played (e.g., the first hole 302, the second hole 304, etc.). While only shown as including four holes, it should be understood that the golf course 300 may include any number of holes (e.g., nine holes, eighteen holes, etc.).

### Autonomous Operation

According to an exemplary embodiment, the fleet monitoring and control system 200, including the vehicles 10 (and the sensor systems 70 and the vehicle control systems 100), the user sensors 220, the user devices 232, and/or the remote systems 240, is configured to facilitate autonomously operating the vehicles 10 about the golf course 300. As described in greater detail herein, such autonomous operation may include (a) autonomously driving from the current location of a golfer to the green staging location 340, (b) autonomously returning to the current location of the golfer from another location (e.g., when inadvertently or prematurely sent to the green staging location 340, etc.), (c) autonomously driving to a landing location of a golf ball following a golf shot/stroke, and/or (d) autonomously driving to another location selected on the golf course 300.

### Go to Green

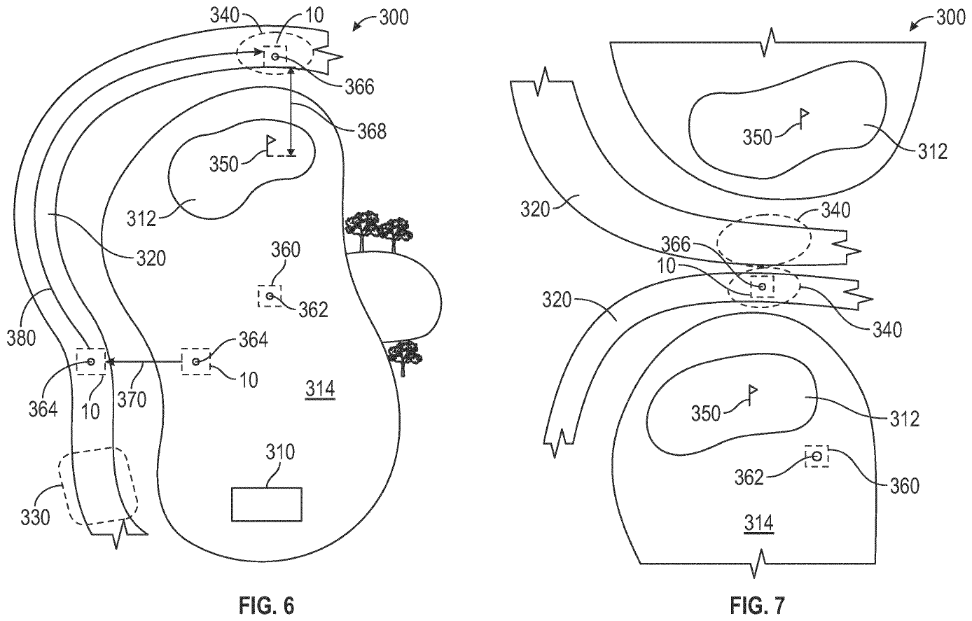

As shown in FIG. 6, the vehicle 10 is operating at a respective hole (e.g., the first hole 302, the second hole 304, the third hole 306, the fourth hole 308, etc.) of the golf course 300 that a user (e.g., operator of the vehicle 10), shown as golfer 360, is playing. The golfer 360 may operate (e.g., drive) the vehicle 10 to navigate throughout the golf course 300 such as between holes of the golf course 300, to a location of a ball hit by the golfer 360, etc. By way of example, the golfer 360 may park the vehicle 10 along the cart path 320 and exit the vehicle 10 to walk to a location (e.g., on the fairway 314, adjacent the fairway 314 in the rough, etc.) of their ball to hit their next shot. In such an example, a cart-path-only rule may be in effect at the golf course 300 such that operation of the vehicle 10 is permitted on the cart path 320 and inhibited off of the cart path 320. By way of another example, the golfer 360 may park the vehicle 10 off of the cart path 320 (e.g., on the fairway 314, adjacent the fairway 314 in the rough, etc.) adjacent to their ball and exit the vehicle 10 to hit their next shot.

As shown in FIGS. 6 and 7, the golfer 360 is located at a user location, shown as golfer location 362, at the golf course 300 and the vehicle 10 is located at a location (e.g., real-time location, actual location, corrected location, tracked location, GPS location, RTK location, etc.), shown as vehicle current location 364, at the golf course 300. In some embodiments, the golfer location 362 is determined by the fleet monitoring and control system 200 based on operator data (e.g., golfer data) received from the user sensor 220 and/or the user device 232. By way of example, the user sensors 220 may acquire GPS data and/or RTK data used to determine the golfer location 362. By way of another example, the golfer location 362 may be determined based on communications (e.g., signal strength) between (i) the user sensor 220 and/or the user device 232 and (ii) the antennas 78. In some embodiments, the golfer location 362 is determined by the fleet monitoring and control system 200 based on vision data acquired by the cameras 72, the LiDAR sensors 74, and/or the radar sensors 76. By way of example, the cameras 72, the LiDAR sensors 74, and/or radar sensors 76 may detect the golfer 360 outside of the vehicle 10 and acquire vision data including the golfer 360 used to determine the golfer location 362 relative to the vehicle 10. As discussed in greater detail above, in some embodiments, the vehicle current location 364 is determined by the fleet monitoring and control system 200 based on sensor data acquired by the sensor system 70 (e.g., the cameras 72, the LiDAR sensors 74, the radar sensors 76, the antennas 78, etc.).

As shown in FIGS. 6 and 7, the vehicle 10 is configured to navigate (e.g., autonomously navigate based on sensor data acquired by the sensor system 70 as discussed in greater detail above) from the vehicle current location 364 to a green location (e.g., a parked location, a final location, etc.), shown as vehicle final location 366. The vehicle final location 366 is located within the green staging location 340 such that, when the vehicle 10 navigates to the vehicle final location 366, the vehicle 10 is at least partially located within the green staging location 340 proximate the green 312 of a respective hole where the golfer 360 is located or will be located at (e.g., putting or will be putting at the respective hole, grabbing or will be grabbing a ball hit into the cup of the respective hole, grabbing or will be grabbing a ball hit onto the green 312 of the respective hole, etc.). In other words, the vehicle final location 366 defines a location in the green staging location 340 of where the vehicle 10 navigates to and parks at when the golfer 360 is located or will be located at the respective hole.

As shown in FIGS. 6 and 7, the vehicle final location 366 is generated (e.g., positioned, located, etc.) along a portion of the cart path 320 within the green staging location 340 such that, at the vehicle final location 366, the vehicle 10 is positioned on the cart path 320 and within the green staging location 340. In some embodiments, the vehicle final location 366 is located off of the cart path 320 and within the green staging location 340 such that, at the vehicle final location 366, the vehicle 10 is positioned off of the cart path 320 and within the green staging location 340. As shown in FIG. 6, the vehicle final location 366 is generated based on a location of the pin 350. Specifically, the vehicle final location 366 is located along the cart path 320 within the green staging location 340 at a location where a distance, shown as pin distance 368, between the pin 350 and the cart path 320 is minimized (e.g., shortest). Such positioning of the vehicle final location 366 from the pin 350 by the pin distance 368 enables the vehicle 10 to be parked as close to the pin 350 as possible while remaining parked on the cart path 320, thereby minimizing a distance the golfer 360 needs to walk from the pin 350 to the vehicle 10. In some embodiments, the pin distance 368 is a minimum distance from the pin 350 to a drivable area (e.g., an area where operation of the vehicle 10 is permitted, an area off of the green 312, etc.) within the green staging location 340. By way of example, the green staging location 340 may include a drivable area between the green 312 and the cart path 320, and the vehicle final location 366 may be located at a location in the drivable area and off of the cart path 320 a minimum distance (e.g., the pin distance 368) away from the pin 350.

As shown in FIG. 7, the golf course 300 includes a first portion of the cart path 320 located proximate a first green 312 of a first respective hole (e.g., the first hole 302, the second hole 304, the third hole 306, the fourth hole 308, etc.) and a second portion of the cart path 320 located proximate a second green 312 of a second respective hole (e.g., a different one of the first hole 302, the second hole 304, the third hole 306, the fourth hole 308, etc.). The first green 312 has a first green staging location 340 associated therewith and the second green 312 has a second green staging location 340 associated therewith. As shown in FIG. 7, the first green 312 is positioned adjacent to (e.g., proximate) the second green 312, and accordingly, the first green staging location 340 is positioned adjacent to the second green staging location 340. According to an exemplary embodiment, the vehicle final location 366 is generated based on the golfer location 362 of the golfer 360 (e.g., the golfer 360 associated with the vehicle 10). Specifically, to prevent unintentionally generating the vehicle final location 366 to be located within the second green staging location 340 instead of the first green staging location 340 (and therefore causing the vehicle 10 to navigate to and park within the second green staging location 340 instead of the first green staging location 340), or vice versa, the vehicle final location 366 is generated based on the golfer location 362 of the golfer 360. By way of example, the golfer location 362 may indicate that the golfer 360 is located at the first respective hole, and based on the golfer location 362 at the first respective hole, the vehicle final location 366 may be generated to be located within the first green staging location 340 associated with the first respective hole.

In some embodiments, the vehicle final location 366 is generated based on the vehicle current location 364 of one or more other vehicles 10 located within the green staging location 340. In such embodiments, the fleet monitoring and control system 200 may be configured to adjust (e.g., change, modify, regenerate, relocate, etc.) the vehicle final location 366 such that the vehicle 10 navigating to the vehicle final location 366 does not contact (e.g., hit, bump, drive into, etc.) the one or more other vehicles 10 located within the green staging location 340. By way of example, a first vehicle 10 may be located within the green staging location 340 and positioned (e.g., parked) such that if a second vehicle 10 were to navigate to the vehicle final location 366, the second vehicle 10 would contact the first vehicle 10. By way of another example, a group of two or more vehicles 10 may be commanded to navigate to the green staging location 340, and a first vehicle 10 of the group may navigate to a first vehicle final location 366 and a second vehicle 10 of the group may navigate to a second vehicle final location 366 generated based on the location of the first vehicle 10 at the first vehicle final location 366. In such an example, the group of vehicles 10 may navigate to and park within the green staging location 340 in response to a single command (e.g., request) without contacting each other. The new (e.g., adjusted, changed, modified, regenerated, relocated, etc.) vehicle final location 366 may be generated based on the vehicle current location 364 of the one or more other vehicles 10 located within the green staging location 340 such that the vehicle 10 is positioned adjacent to (e.g., behind, next to, in front of) the one or more other vehicles 10 or otherwise positioned to avoid contacting the one or more other vehicles 10.

In some embodiments, the vehicle final location 366 is generated based on a detection of one or more external objects (e.g., obstacles, boulders, trees, sandtraps, golfers, golf course staff, bodies of water, etc.). As discussed in greater detail above, the sensor system 70 is configured to acquire sensor data regarding the location of the external objects. In some embodiments, the vehicle final location 366 is generated such that the vehicle 10 navigating to the vehicle final location 366 avoids (e.g., does not contact, run over, fall into, etc.) the external objects. By way of example, a static obstacle such as a tree, building, body of water, etc., may be detected in the green staging location 340, and the fleet monitoring and control system 200 may be configured to generate the vehicle final location 366 such that the vehicle 10 avoids the static obstacle. By way of another example, a dynamic obstacle such as a person (e.g., employee, maintenance worker, the golfer 360, etc.) may be detected in the green staging location 340 at the vehicle final location 366, and the fleet monitoring and control system 200 may be configured to adjust the vehicle final location 366 such that the vehicle 10 avoids the dynamic obstacle. In some embodiments, the vehicle final location 366 is generated such that, at the vehicle final location 366, the vehicle 10 is accessible by the golfer 360. By way of example, the vehicle final location 366 may be generated to prevent an obstacle from inhibiting (e.g., preventing, hindering, etc.) the golfer 360 from entering the occupant seating area 22, accessing the bagwell 30, etc., from the exterior of the vehicle 10 when the vehicle 10 is located at the vehicle final location 366.

According to an exemplary embodiment, the vehicle final location 366 is generated remote from the vehicle 10. By way of example, the vehicle final location 366 may be generated based on a user input to the user device 232. In such an example, the user input to the user device 232 may include coordinates of the vehicle final location 366, a selection of a location to a GUI displaying a map of the golf course 300, among other information identifying the location of the vehicle final location 366. By way of another example, the vehicle final location 366 may be generated within the green staging location 340 by the remote systems 240 based on the location of other vehicles, the current hole being played by the golfer 360, etc.

As shown in FIG. 6, the vehicle 10 is configured to navigate from the vehicle current location 364 to the vehicle final location 366 along at least one of a first path (e.g., track, line, etc.), shown as first route 370, or a second path (e.g., track, line, etc.), shown as second route 380. The vehicle 10 may be configured to follow or otherwise drive along the first route 370 and/or the second route 380. As shown in FIG. 6, the first route 370 is established from the vehicle current location 364 on the fairway 314 to the cart path 320. In some embodiments, the vehicle 10 is otherwise located about the golf course 300 off of the cart path 320 (e.g., in the rough, in an out-of-bounds area, etc.) and the first route 370 is established from the vehicle current location 364 off the cart path 320 to the cart path 320. In other words, if the vehicle current location 364 indicates that the vehicle 10 is operating off of the cart path 320, the first route 370 is established such that the vehicle 10 navigates to the cart path 320 before navigating to the vehicle final location 366. As discussed in greater detail below, the first route 370 may be a shortest route from the vehicle current location 364 to the cart path 320 (e.g., following a 90-degree rule in accordance with course guidelines or rules), an optimized route, or another route from the vehicle current location 364 to the cart path 320. As shown in FIG. 6, the second route 380 is established from the vehicle current location 364 on the cart path 320 to the vehicle final location 366. The vehicle 10 is configured to follow the second route 380 to navigate, at least partially, along (e.g., on) the cart path 320 from the vehicle current location 364 to the vehicle final location 366. In some embodiments, a portion (e.g., section, length, etc.) of the second route 380 extends off of the cart path 320. In other embodiments, the second route 380 is established along the cart path 320 along an entirety of a length of the cart path 320 between the vehicle current location 364 and the vehicle final location 366 such that the vehicle 10 navigates entirely along the cart path 320 (e.g., without operating off of the cart path 320) from the vehicle current location 364 to the vehicle final location 366. While shown as two independent routes, it should be understood that the first route 370 and the second route 380 may be a single, continuous route including one or more additional portions, shapes, lengths, etc. of routes in addition or as an alternative to the first route 370 and the second route 380. According to an exemplary embodiment, the vehicle 10 is configured to initiate navigating from the vehicle current location 364 to the vehicle final location 366 (e.g., along the first route 370 and/or the second route 380) in response to receiving a request (as discussed in greater detail below). By way of example, the request may be generated on the vehicle 10 (e.g., in response to an input to the activation button 49). By way of another example, the request may be generated remote from the vehicle 10 (e.g., in response to an input to the user device 232).

While the contents herein are described in terms of “go to green” and the final vehicle location 366 is within the green staging area 340, it should be understood that any target destination (e.g., the final vehicle location 366) on the golf course 300 may be preset or commanded for the vehicle 10 to autonomously drive to. By way of example, the golfer 360 may choose to send the vehicle 10 to the tee staging location 330 associated with the next tee box 310 (and the golfer 360 may walk to the next tee box 310 separate from the vehicle 10 or ride with the vehicle 10). By way of another example, prior to a round of golf, a staff member in the cart barn may send the vehicle 10 to a staging location proximate the clubhouse. By way of still another example, the golfer 360 may send the vehicle 10 back to the clubhouse following a round of golf (and choose to or not to ride therein). By way of still another example, the vehicle 10 may be a drink cart or refresher that is sent autonomously to the location of the golfer 360 to bring drinks and/or snacks thereto mid-round.

### Path Selection

To navigate to the vehicle final location 366 within the green staging location 340, the vehicle 10 may be configured to determine a route from the vehicle current location 364 to the vehicle final location 366. The route may be determined using various course rules, general rules-of-the-road that are followed on the cart path 320, wayfinding, and/or optimization algorithms. After a route is determined, the vehicle 10 may be configured to navigate along the route using various sensor technologies of the sensor system 70. To stay on the route, the vehicle 10 may repeat control calculations. For example, the vehicle control system 100 may be configured to compute a forward-looking trajectory on the determined route and communicate commands to the driveline 50, the steering system 66, and the braking system 62 to traverse the route in accordance with the forward-looking trajectory.

In some embodiments, the vehicle 10 can perform sensor fusion to calculate a vehicle current location 364 and control its motion to the forward-looking trajectory using several sensing methodologies (e.g., technologies, etc.). The sensors of the sensor system 70 may be combined to reduce the uncertainty of the overall estimate of the vehicle current location 364, or the sensor that is currently most accurate may be used to determine the vehicle current location 364 and/or perform control.

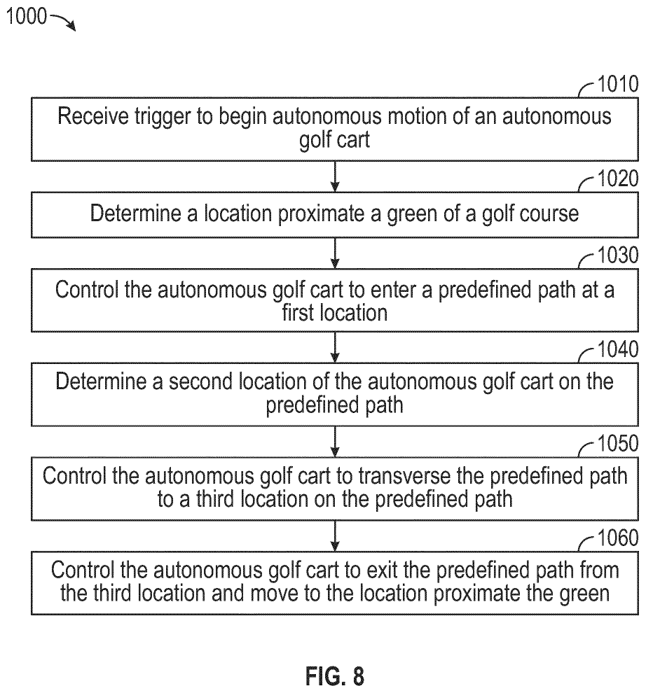

FIG. 8 shows a method 1000 for determining a route and operating the vehicle 10 along the route. In some embodiments, the vehicle 10 is configured to determine a route that at least partially follows a predefined path designed for the vehicle 10. The predefined path may be the cart path 320 along the golf course 300. The cart path 320 may be constructed from one or more surface materials (e.g., asphalt, concrete, gravel, cobblestone, brick, etc.) or the cart path 320 may be an agreed upon or predetermined path on the turf of the golf course 300. In some embodiments, the construction of the cart path 320 changes materials at different locations of the golf course 300. The cart path 320 may be demarcated (e.g., indicated, denoted, etc.) by one or more landmarks of various types as described herein. The vehicle 10 may use the landmarks to autonomously navigate from the vehicle current location 364 to the vehicle final location 366. The method 1000 may be performed by the vehicle control system 100 and/or the remote systems 240.

In some embodiments, the method 1000 includes receiving a trigger to begin autonomous motion of the vehicle 10 in the operation 1010. The trigger may be received using any of the methodologies described herein. For example, the trigger may be received by way of wireless communication (e.g., phone application, key fob, text message, etc.), by a user interface (e.g., a button or touch screen), or by way of the sensors (e.g., gesturing, calculation of the distance between the golfer 360 and the green 312 and the golfer 360 and the vehicle 10, etc.).

The method 1000 may include determining a location proximate a green 312 of a golf course in operation 1020. Some golf courses 300 have a back-and-forth configuration of the fairways 314 for the plurality of holes. At some locations of the golf course 300, the closest green 312 may not be the green 312 currently being played by the golfer 360. Additionally, after an errant shot, the golfer 360 and/or the vehicle 10 may be closer to a different hole, on a different hole, in a different fairway 314, etc. As part of the operation 1020, the vehicle 10 may determine the appropriate green 312 (e.g., of all the greens 312 of the golf course 300) to which the vehicle 10 should go. After the appropriate green 312 has been determined, the vehicle 10 may determine a vehicle final location 366 within the green staging location 340 associated with the appropriate green 312.

The method 1000 may include controlling the vehicle 10 (e.g., an autonomous golf cart) to enter a predefined path at a first location in operation 1030. For example, the vehicle 10 may determine a first route 370 from the vehicle current location 364 to the cart path 320. In some embodiments, the cart path 320 is demarcated with markers allowing for efficient autonomous control, whereas the fairway 314 and the areas immediately surrounding the fairway 314 are not. Different navigation techniques may be used to control the vehicle 10 along the first route 370. For example, the triangulation or GPS navigation may be used until camera-based path following is available on and/or near the cart path 320. Additionally, the traffic on the fairway 314 may be minimized to reduce wear. During operation 1030 the vehicle control system 100 and/or the remote systems 240 may autonomously generate commands for the steering system 66 and/or the driveline 50 of the vehicle 10 to move along the route.

The method 1000 may also include determining a second location of the vehicle 10 on the predefined path (e.g., the cart path 320) in operation 1040. To traverse the cart path to the green staging location 340 and eventually the vehicle final location 366, the vehicle 10 may be configured to determine its current location along the cart path 320. Several techniques may be used to determine the current location. One or more techniques may be performed independently or concurrently to find a best estimate of the vehicle current location 364 along the cart path 320. In some embodiments, the technique currently being used to locate the vehicle 10 changes based on conditions of the golf course 300. For example, GPS may be less accurate under trees or on days with significant cloud cover, and a secondary positioning system may be used at times when GPS is unreliable. In some embodiments, GPS is not used and/or other techniques for determining the vehicle current location 364 along the cart path 320 are primary. Additionally or alternatively, camera-based location determination systems may be more accurate and use near landmarks and other visual features that can be identified by the vehicle control system 100 and/or the remote systems 240.

The method 1000 may also include controlling the vehicle 10 to traverse the predefined path to a third location on the predefined path in operation 1050 and/or controlling the vehicle 10 to exit the predefined path from the third location and move to the location proximate to the green 312 (e.g., the vehicle final location 366 within the green staging location 340 for the appropriate hole) in operation 1060. After arriving at the vehicle final location 366, the vehicle 10 may apply a parking brake and exit autonomous mode, waiting for the golfer 360 to complete the hole and resume manual operation thereof.

In some embodiments, controlling the vehicle 10 (e.g., the vehicle 10) along the predefined path (e.g., cart path 320) includes repeating the operations 1040 and 1050 to cause the vehicle 10 to traverse the cart path 320. For example, after determining the current location of the vehicle on the cart path 320. The vehicle control system 100 may determine a target location between the current location and the third location where the vehicle 10 is to exit the cart path 320, make controlling actions to move the vehicle towards the target location, and then choose another target location. The operations may be repeated until the target location determined is the third location. In some embodiments, the next target location is chosen before the vehicle 10 reaches the target location smoothing control of the vehicle 10.

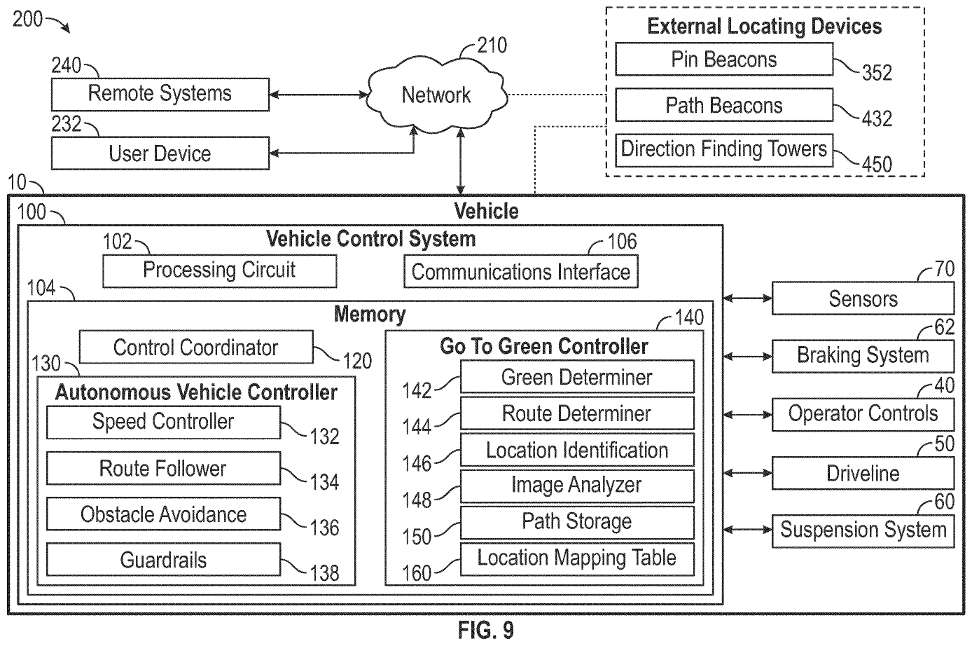

As shown in FIG. 9, the fleet monitoring and control system 200 may be configured as a go to green system and include features (e.g., components, instruction sets, devices, etc.) providing autonomous control of the vehicle 10 to an appropriate green 312. For example, the fleet monitoring and control system 200 may be configured to perform the method 1000. The fleet monitoring and control system 200 includes features that may be used to perform the operations of the method 1000 or any other methods described herein. The vehicle control system 100 is shown to include (e.g., as executable instructions for a processor of the processing circuit 102) a control coordinator 120, an autonomous vehicle controller 130, and a go to green controller 140. Additionally, in some embodiments, the fleet monitoring and control system 200 includes external locating devices to aid in geolocation, wayfinding, etc. of the vehicle 10 during navigation to the vehicle final location 366.

The control coordinator 120 may be configured control the timing and flow of data through the other circuitry of the vehicle control system 100. For example, the control coordinator 120 may cause the instruction sets or circuits to execute in a specific order to perform the function of the vehicle control system 100. In some embodiments, the control coordinator 120 may route the information and/or outputs of other instruction sets that are dependent on the information or use the information as an input. For example, the control coordinator 120 may coordinate the interaction between the go to green controller 140 and the autonomous vehicle controller 130 by updating the desired trajectory for the autonomous vehicle controller 130 to follow with a route from the go to green controller 140.

The autonomous vehicle controller 130 may be configured to control the vehicle 10 according to a trajectory or route generated by the go to green controller 140. The autonomous vehicle controller 130 may generate control signals for the various drive systems of the vehicle including the driveline 50, the braking system 62, and/or the steering system 66. The autonomous vehicle controller 130 is shown to include a speed controller 132, a route follower 134, an obstacle avoidance system 136, and guardrails 138.

The go to green controller 140 may be configured to determine a best or optimal route from the vehicle current location 364 to the vehicle final location 366 within the green staging location 340. The go to green controller 140 may generate intermediate trajectories (e.g., short forward-looking trajectories) for the autonomous vehicle controller 130 to follow. In some embodiments, the intermediate trajectories provide a route for the autonomous vehicle controller 130 for the next period of time (e.g., 1 second, 5 seconds, etc.) and are calculated frequently. For example, the intermediate trajectories may be calculated prior to the vehicle 10 arriving at the end of the currently followed intermediate trajectory. In some embodiments, the intermediate trajectory may include a heading and a target speed for the forward motion. The go to green controller 140 is shown to include a green determiner 142, a route determiner 144, a location identifier 146, an image analyzer 148, path storage 150, and a location mapping table 160.

The go to green controller 140 and the autonomous vehicle controller 130 may be configured to work together (e.g., by way of the control coordinator 120). To cause the vehicle 10 to traverse from the vehicle current location 364 to the vehicle final location 366. The go to green controller 140 may continually calculate new trajectories for the autonomous vehicle controller 130 to follow, and the autonomous vehicle controller 130 generates control commands for the drive systems following those trajectories.

In some embodiments, the go to green controller 140 includes the green determiner 142 to determine the appropriate green 312 to which the vehicle 10 is to go. The green determiner 142 may, for example, perform the operation 1020 of the method 1000. The green determiner 142 may use one or more methodologies to determine the most appropriate green 312. The green determiner 142 may use sensor measurements from the cameras 72, the LiDAR sensors 74, and the radar sensors 76 to determine location information related to the golfers 360 associated with the vehicle 10. The green determiner 142 may additionally or alternatively use information from a user device 232 associated with a golfer 360 of the vehicle 10 and/or a key fob associated with the vehicle 10. The user device 232 and/or key fob may be carried by the golfer and used to determine the hole being played. The green determiner 142 may generate an identification of the appropriate green 312 and thus the green staging location 340 and the vehicle final location 366 to which the vehicle 10 should go after autonomous go to green mode is activated.

In some embodiments, the vehicle 10 receives a number for a green included with the trigger received in the operation 1010 of the method 1000. A wireless communication device (e.g., key fob, cell phone, etc.) may communicate the appropriate green 312 with the trigger. For example, a cell phone application may include a text entry field where the golfer 360 or other operator of the vehicle 10 can enter the green 312 to which they desire the vehicle 10 to go. Additionally or alternatively, a key fob associated with the vehicle 10 may have a button for each of the holes, allow for numerical entry of the number of the green 312, include a dial for the desired green 312, or include any other appropriate method for indicating a specific green 312 before triggering the vehicle 10 to go to the green 312. Additionally or alternatively, the vehicle 10 may be able to respond to text messages directed to the golf course 300 and the vehicle 10. In some embodiments, the vehicle 10 may respond to text in natural language. The text may be processed by a large language model (“LLM”) to determine the semantic meaning of the text prior to activating the go to green feature by way of the trigger in operation 1010. For example, the messages “go to hole 15,” “please go to the 15^{th} green,” and “15^{th} hole please,” may all be processed by the LLM, which may determine the appropriate response is to activate the autonomous go to green feature with the 15^{th} hole. In some embodiments, spoken commands are processed similar to text messages. The green determiner 142 may forward audio to a speech recognition system and/or the LLM of the remote systems 240 or connected to the remote systems 240 to determine if a command for the go to green feature was issued with an appropriate green number.

In some embodiments, the green determiner 142 is configured to track the holes that have been played in order to determine to which green 312 to go if a go to green trigger is received. The played holes may be tracked in a variety of ways, each maintaining an independent estimate of the last hole to be completed. When a go to green trigger is received, the green determiner 142 may consult the independent estimates and determine a particular green 312 based on a majority vote, super majority vote, or unanimous vote. If the voting procedure does not satisfy a vote threshold, the green determiner 142 may indicate that the go to green feature is not available or request clarification (e.g., request a specific hole number with the current location).

The green determiner 142 may determine the last hole played using several techniques. In some embodiments, the green determiner 142 uses cameras 72 on the vehicle 10 to determine the last played hole. For example, the cameras 72 may identify landmarks that are associated with a particular hole. Artificial intelligence models, for example, convolutional neural networks (“CNNs”), may process images from the cameras 72 and match them to the landmarks. In some embodiments, the vehicle 10 may recognize a sign near a tee box 310 and track the last hole recognized. A CNN and/or other optical character recognition technique may be used to identify the number associated with the tee box 310 and thus the hole being played. In some embodiments, an electronic score card (or other score keeping device) is used to track the last hole completed (e.g., the last hole for which a score is entered). The score card may be integrated into the operator interface 48 or may be part of an application on a mobile phone or other user device 232.

In some embodiments, the pin 350 for a particular hole can be identified by the green determiner 142 using images from the cameras 72 in order to determine the appropriate green 312. For example, a CNN may be used to recognize the hole number or other visual patterns or colors on the flag of the pin 350. Additionally or alternatively, the pin 350 itself may be marked with patterns and/or colors for hole identification. In some embodiments, as shown in FIG. 9, the pins 350 have integrated beacons, shown as pin beacons 352, that are configured to transmit information to the vehicle 10 (e.g., directly or over the communications network 210). The pin beacons 352 may transmit an electrical signal with unique characteristics. For example, the signal may include encoded data communications indicating the hole number or a particular frequency, for example, using any appropriate wireless communication technology (e.g., Bluetooth, Zigbee, etc.) or broadcast technology. The pin beacons 352 may include a solar panel to charge the transmitter and may eliminate a need for electrical wiring and/or replacing batteries.

In some embodiments, the green determiner 142 may combine a number of the techniques described herein to determine to which green 312 to go. The green determiner 142 may determine a level of confidence associated with the most likely green 312 for the go to green trigger. If the level of confidence is above a threshold, the green determiner 142 may allow downstream features to perform their operations and begin navigation towards the green. If the level of confidence associated with the most likely green 312 is below the threshold, the green determiner 142 may run a clarifying algorithm. For example, in some embodiments, the green determiner 142 can cause a reply to be sent via text or the speakers of the vehicle 10 to request a particular green 312.

After determining the appropriate green 312, the green determiner 142 may also determine a vehicle final location 366 within the green staging location 340 associated with the appropriate green 312. The vehicle final location 366 may be based on the pin location (e.g., by finding the location in the green staging location 340 closest to the pin 350) and may be updated as the pin location changes. The vehicle final location 366 may also be based on the number of vehicles 10 already parked in the green staging location 340. For example, additional vehicles 10 sent to the same green staging location 340 may form a line in the green staging location 340.

The route determiner 144 may be configured to determine a route from the vehicle current location 364 to the vehicle final location 366. The route determiner 144 may be configured to determine a route made from three sub-routes, for example, from the vehicle current location 364 to a location to enter the cart path 320, along the cart path 320, and from a location exiting the cart path 320 to the vehicle final location 366. The route determiner 144 may continually break up the sub-routes into intermediate forward-looking trajectories for the autonomous vehicle controller 130. By controlling the vehicle 10 to the intermediate trajectories calculated by the route determiner 144 the autonomous vehicle controller 130 may cause the vehicle 10 to traverse the route. The route determiner 144 in combination with the autonomous vehicle controller 130 may perform the operations 1020, 1040, and 1050 of the method 1000.

The location identifier 146 may be configured to determine a current location of the vehicle 10. Several techniques may be used to determine the vehicle location. One or more techniques may be performed independently or concurrently to find a best estimate of the vehicle current location 364 along the cart path 320. In some embodiments, the technique currently being used to locate the vehicle 10 changes based on conditions of the golf course 300. For example, GPS may be less accurate under trees or on days with significant cloud cover, and a secondary positioning system may be used at times when GPS is unreliable. In some embodiments, GPS is not used and/or other techniques for determining the vehicle current location 364 along the cart path 320 are primary. For example, the location identifier 146 may be configured to determine the vehicle current location 364 along the cart path 320.

In some embodiments, the techniques used by the location identifier 146 to identify the vehicle position along the cart path 320 and the techniques used to traverse the cart path 320 are interrelated. For example, if the location identifier 146 is configured to operate visually based on images from the cameras 72, the route determiner 144 may also break up route into intermediate trajectories based on images from the cameras 72.

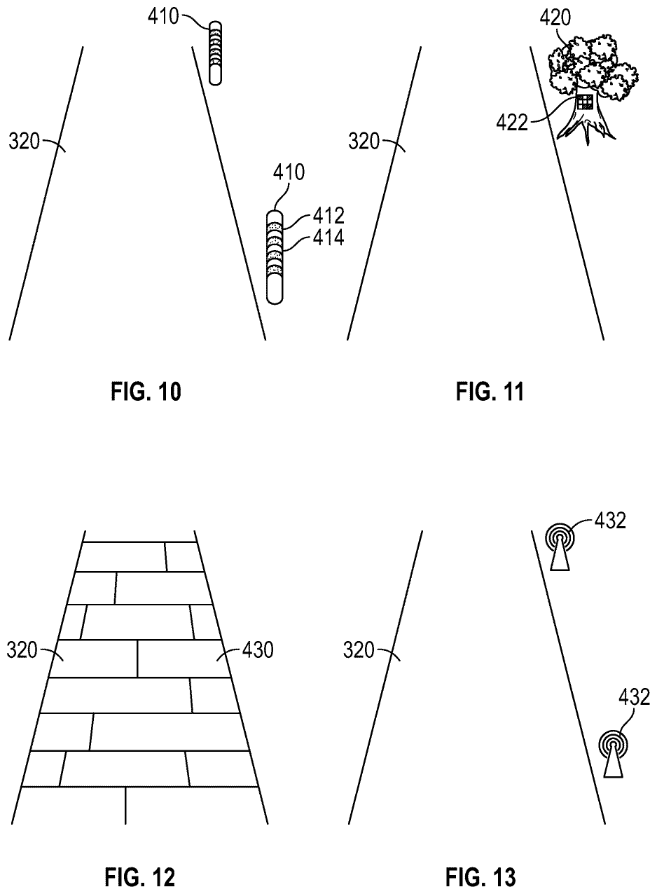

The location identifier 146 may use one or more techniques to determine the current location of the vehicle 10 along the cart path 320. In some embodiments, the cart path 320 is demarcated by objects along the cart path 320. As shown in FIG. 10, the cart path 320 may be demarcated by a number of path pylons 410. A path pylon 410 may be identified by the vehicle 10 using the images from the cameras 72. In some embodiments, the location identifier 146 may use image recognition to identify the path pylons 410 from other objects, markings, or indicators on the cart path 320. For example, a CNN may be used to identify the path pylons 410 along the cart path 320. In some embodiments, the path pylons 410 use one or more visual characteristics (e.g., colors, shapes, markings, etc.) so that the image recognition algorithm can more easily identify the path pylons 410.

The path pylons 410 may also include unique visual characteristics so that a specific path pylon 410 may be identified and related to a particular location. The path pylons 410 may use a number of dark pylon location indicators 412 and light pylon location indicators 414 shown as bands or stripes along the pylon to uniquely identify a pylon on the course. The number of dark pylon location indicators 412 and the light pylon location indicators 414 for each path pylon 410 may have a different pattern. For example, the length of the individual stripes could be used to indicate a pylon number similar to a universal product code (“UPC”). The identifier of the path pylon 410 may be stored associated with the respective location in the location mapping table 160 for retrieval by the location identifier 146

As shown in FIG. 11, the path may be demarcated by a number of landmarks 420. The landmarks 420 may be naturally occurring (e.g., trees, bushes, etc.) or the landmarks 420 may be manmade (e.g., buildings, water coolers, statues, signs, etc.). Each landmark 420 may be visually unique relative to other landmarks 420, allowing a particular landmark 420 to be associated with a position along the cart path 320. The location identifier 146 may use CNNs or other image processing algorithms to uniquely identify the landmark and thereby determine the vehicle current location 364 along the cart path 320.

In some embodiments, the landmarks 420 may include a landmark location indicator 422. The landmark location indicator 422 may be used to focus the image processing algorithm and/or to add unique visual characteristics to a respective landmark 420 that may be otherwise difficult to identify from other landmarks 420 of the same type. As shown in FIG. 11, the landmark location indicator 422 may use a pattern of light and dark areas to encode location information (e.g., a barcode, a QR code, etc.) and/or to provide a unique number for the landmark 420. In some embodiments, the landmark location indicator 422 may use human identifiable characteristics (e.g., text or numbers) to identify a specific landmark 420.

The route determiner 144 may be configured to determine intermediate trajectories using the path pylons 410 and/or the landmarks 420. In some embodiments, the markers (e.g., the path pylons 410 or the landmarks 420) are spaced such that the next marker is visible by the cameras 72 prior to passing a current marker. The route determiner 144 may generate new intermediate trajectories for the next maker prior to cessation of control to the current marker. The trajectory may be communicated from the go to green controller 140 to the autonomous vehicle controller 130 for autonomous control. By following the intermediate trajectories, the autonomous vehicle controller 130 may be configured to move from one marker to the next marker in a smooth fashion.

The forward-looking trajectory determined by the route determiner 144 from the vehicle current location 364 to a target marker along the cart path 320 may be continually calculated (e.g., periodically, aperiodically, after a certain distance has been travelled, as soon as the previous calculation completes, etc.) and provided to the route follower 134 for control. The route determiner 144 may generate the intermediate trajectory based on images from the cameras 72. For example, a trajectory may be generated that is expected to cause the marker (e.g., a path pylon 410 or a landmark 420) to appear in the field of view of one or more of the cameras 72 in a specific manner (e.g., size and location relative to the image). For example, the route determiner 144 may compare the current images from the cameras 72 to a target image (e.g., a reference image) of the target marker and determine a trajectory expected to cause the current images to be more similar to the target image. The route determiner 144 may determine a number of transformations of the current image that would cause the image to appear more similar to the target image (e.g., increase a similarity score). The transformations may be converted to a trajectory. For example, if scaling (e.g., magnifying, zooming, etc.) the current image causes an increase in similarity with the target image, a particular amount of forward travel in the trajectory may be calculated. If the current image is to be panned (e.g., translated, repositioned, etc.), the trajectory may turn by an amount. In some embodiments, CNNs are used by the route determiner 144 to calculate a similarity score and/or determine a trajectory that would increase a similarity score. The similarity score may be implicitly calculated in the CNN in determining the control trajectory.

In some embodiments, the trajectory is found based on a range and heading (e.g., direction) of the target marker. Range and heading may be calculated based on measurements from one or more sensors of the sensor system 70. The cameras 72, the LiDAR sensors 74, and/or the radar sensors 76 may work independently or in combination to generate a range and heading for the target marker. For example, cameras 72 may be used to detect a marker based on visual characteristics, determine a range based on a comparison between the size of the marker in the camera image and a known size, and determine a heading based on its current location (e.g., x-y coordinate in the camera image). Detection of specific markers (e.g., the path pylons 410 and/or the landmarks 420) may be performed by a CNN based on current images from the cameras 72.

The intermediate trajectory may be provided to the autonomous vehicle controller 130 for control. The route follower 134 may send commands to the steering system 66 of the vehicle 10 to control the vehicle 10 in accordance with the currently calculated trajectory. Continual calculation of a trajectory or a heading and adjustment by route path follower 134 may cause smooth operation to the next target marker along the cart path 320 during traversal of the second route 380.

In some embodiments, the forward-looking trajectory from the go to green controller 140 includes a target speed as well as a route. The target speed may be based on the surface the vehicle 10 is currently traversing, weather conditions, and/or traffic, obstacles, and/or persons nearby. The go to green controller 140 may be configured to provide a higher target speed over favorable driving surfaces (e.g., asphalt) and a lower target speed over less favorable conditions (e.g., cobblestone, gravel, grass, etc.). Additionally or alternatively, the go to green controller 140 may be configured to provide a lower target speed where operating the vehicle 10 may wear or damage the playing surface (e.g., over the fairway).

The speed controller 132 may be configured to send commands to the driveline 50 and/or the braking system 62 to control the vehicle 10 at the target speed. Speed control may be performed by a suitable control algorithm. For example, the speed controller 132 may use a proportional-integral (“PI”) or a proportional-integral-derivative (“PID”) feedback controller to adjust the driveline 50 and the braking system 62 inputs to cause speed measurements to match the target speed provided by the go to green controller 140.

As shown in FIG. 12, the cart path 320 is demarcated by a particular path surface material 430, in some embodiments. For example, the cart path 320 may be constructed from asphalt, cobblestone, brick, gravel, woodchips, or any other material that may set itself apart from the other surfaces of the golf course 300 (e.g., grass). The route determiner 144 may use input from the camera 72 to generate an intermediate trajectory that causes the vehicle 10 to remain on the cart path 320. Similar to navigation by the path pylons 410 and/or the landmarks 420, a CNN may be used in order to determine a trajectory (e.g., heading) to stay on the cart path 320. In some embodiments, other image processing algorithms may be used to identify the extent of the cart path 320 by way of the particular path surface material 430. For example, edge detection algorithms may be used to determine the boundary of the cart path 320 and determine trajectories that remain on the cart path 320.

Additionally or alternatively, buried wire may be placed along the cart path. Sensors of the sensor system 70 may be configured to identify (e.g., locate) the wire. The route follower 134 may adjust the direction of the vehicle 10 to obtain the strongest signal (e.g., by sending commands to the steering system 66), causing the vehicle 10 to follow the wire. Electrical signals may be generated along the wire. The electrical signals may be generated with a specific characteristic (e.g., a frequency) that is associated with a location or a section of the cart path 320. The vehicle 10 may be configured to detect the signal and the location identifier 146 may determine the vehicle current location 364 based on the signal characteristics.

The vehicles 10 visually following a physical path as shown in FIG. 12 or by buried wire may also include aspects of navigation by markings along the cart path 320. In some embodiments, the heading (e.g., an intermediate trajectory) is determined by the route determiner 144 based on the images from the cameras 72 depicting the path or the electrical sensor detecting the underground wire and the absolute location along the path is determined based on markers (e.g., the path pylons 410 and/or the landmarks 420). It is contemplated that by combining both a physical path that may be identified by the cameras 72 and image processing (or buried underground wire) with marker-based location identification, it may be possible to have the path markers further apart. Additionally or alternatively, visual paths demarcated by a surface material (or underground wire) can be used in locations where the path pylons 410 would disrupt the aesthetics of the golf course 300 and where visually distinct landmarks are not present.

As shown in FIG. 13, the cart path 320 may also be demarcated by electrical beacons, shown as path beacons 432. In some embodiments, the path beacons 432 may emit a signal that can be received by the antennas 78 on the vehicle 10. To navigate the cart path 320 using the path beacons 432, the route determiner 144 may determine a heading in the direction of maximum signal strength for the next of the path beacons 432.

In some embodiments, the path beacons 432 may transmit information to the vehicles 10, for example, using any appropriate wireless communication technology (e.g., Bluetooth, Zigbee, etc.) or broadcast technology. Each path beacon 432 may transmit a unique identifier. The location identifier 146 may find the identifier in the location mapping table 160 and determine the current location of the vehicle 10 based on the path beacons 432 nearby and associated signal strength or reception delay. Additionally or alternatively, the path beacons 432 may transmit their location (e.g., in geographical coordinates). In some embodiments, the path beacons 432 are configured to transmit additional information (e.g., in the form of digital communication to the vehicle 10). For example, the path beacons 432 may transmit directions to the next path beacon 432 in the form of a heading for the vehicle 10 to follow. The path beacons 432 may also be configured to transmit system information to the vehicle 10 to be transmitted to the remote systems 240 for monitoring purposes. In some embodiments, the path beacons 432 are not configured to communicate over the communications network 210 but may use the vehicle 10 to relay information back to the remote systems 240. For example, faults in the path beacons 432, battery conditions of the path beacons 432, or any additional information that may be monitored for system health may be communicated from the path beacons 432 to the vehicle 10 and relayed to the remote systems 240.

In some embodiments, the path beacons 432 are solar powered. The path beacons 432 may include a solar panel for generating electricity used to charge a battery in the path beacon 432. Energy stored in the battery may be discharged to power the path beacon 432 for a period of time after the sun has set or on cloudy days. In some embodiments, the solar panels may also be used as a light sensor. The path beacons 432 may be configured to automatically stop transmitting a certain time after the light drops below a brightness threshold. In some embodiments, the path beacons 432 are implemented using radio frequency identification (“RFID”) tags. RFID tags may be active, requiring a power source, or passive, powered and activated by the electromagnetic field of the reader (e.g., attached to vehicle 10).

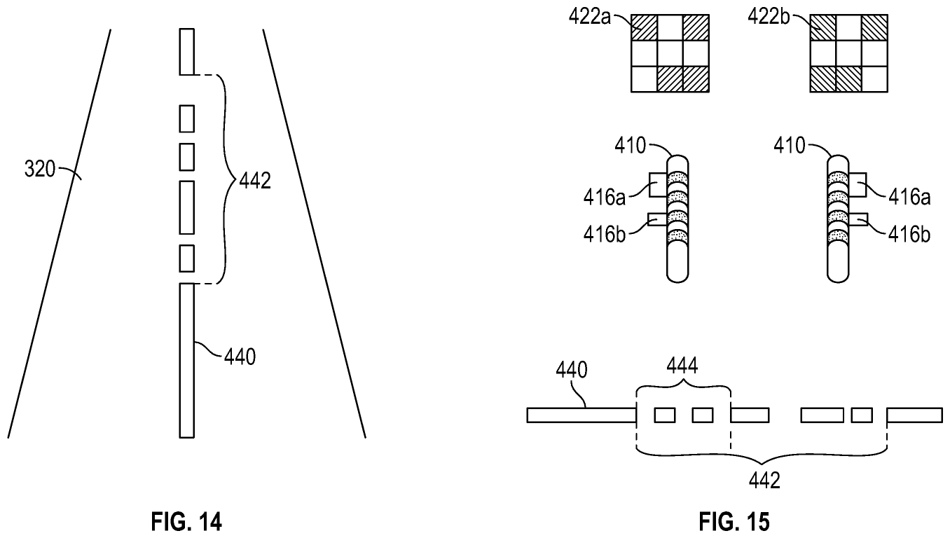

As shown in FIG. 14, the path may be demarcated by a path stripe 440 applied to the surface of the cart path 320. For example, the path stripe 440 may be painted on the cart path 320 or may be constructed using bricks, stone, or other surface materials of a different color from the cart path 320. The path stripe 440 may be centered on the cart path 320 (e.g., additionally used to indicate lanes) or the path stripe 440 may be on the edge of the cart path 320 (e.g., additionally used to indicate the boundaries of the cart path 320). At various locations along the cart path 320, the path stripe 440 may include a path stripe location indicator 442 to be associated with a position along the cart path 320. A path stripe location indicator 442 may be any markings on the stripe that can be used to uniquely identify a position visually. For example, the path stripe location indicator 442 may include dashes in the path stripe 440 of varying length. Images of the path stripe location indicator 442 may be captured by the cameras 72, interpreted by the location identifier 146, and found within the location mapping table 160 to determine a vehicle current location 364 on the cart path 320.

In some embodiments, controlling the vehicle 10 along the cart path 320 demarcated with a path stripe 440 as shown in FIG. 14 is performed by the route follower 134. The route determiner 144 may receive images from the cameras 72 and generate an intermediate trajectory along the path stripe 440. Alternatively, the route determiner 144 may determine a trajectory to one side of the path stripe 440 (e.g., if the path stripe 440 is in the center or at the boundary of the cart path 320). The route follower 134 may generate steering commands for the steering system 66 to adjust the heading of the vehicle 10 to follow the trajectory of the route determiner 144. Repeated calculation of the trajectory and steering commands may cause smooth control along the cart path 320.

The go to green controller 140 may also be configured to determine the direction the vehicle 10 is travelling along the cart path 320. In some embodiments, the vehicle 10 may capture images (e.g., by way of the cameras 72) of at least two position indicators along the cart path 320. The position indicators may be from the path pylons 410, a landmark location indicator 422, a path beacons 432, or any other technique for determining the position of the vehicle 10 on the cart path 320 described herein. The position indicators may be arranged along the cart path 320 such that two position indicators may be in view of the camera, allowing the location identifier 146 to identify a sequence of two positions along the cart path 320 and thereby determine the direction the vehicle 10 is traveling.

In some embodiments, more than one position indicator may not be visible from a location on the cart path 320. Traveling along the cart path 320 to determine another location on the cart path 320 may cause the vehicle 10 to reverse or turn around if the vehicle 10 begins to traverse the path in the opposite direction. As shown in FIG. 15, certain techniques for demarcating the cart path 320 may be used to indicate both direction and location along the cart path 320. The location identifier 146 may interpret images of these indications captured by the cameras 72 and determine the direction of the vehicle 10 as it determines the vehicle current location 364.

In some embodiments, the landmark location indicators 422 have different patterns of light and dark areas on each side of the landmark 420. Only one side of the landmark location indicator 422 may be visible from any one location. For example, if a first side of the landmark location indicator 422a is captured in an image from the cameras 72, the location identifier 146 may determine that the heading of the vehicle 10 is at least within 90° of the normal direction from the first side of the landmark location indicator 422a. In some embodiments, the location identifier 146 may be additionally able to interpret the camera perspective (e.g., by keystoning) of the landmark location indicator 422 to determine a specific heading relative to the normal direction from the first side of the landmark location indicator 422a. Similarly, if the cameras 72 capture an image of a second side of the landmark location indicator 422b, the location identifier 146 may determine that the vehicle 10 is traveling in the opposite direction.

In some embodiments, the path pylons 410 may use one or more asymmetric components (shown as pylon direction indicators 416a, b) to indicate direction along the cart path 320. Pylon direction indicators 416a, b appearing on the left side of the path pylons 410 (shown on the left of FIG. 15) in images captured by the cameras 72 may be indicative of a first direction of travel along the cart path 320. Pylon direction indicators 416a, b appearing on the right side of the path pylons 410 (shown on the right of FIG. 15) in images captured by the cameras 72 may be indicative of a second direction (opposite the first direction) of travel along the cart path 320. Not all asymmetric components (e.g., the pylon direction indicators 416a, b) are required to be on one side of the path pylons 410. The pylon direction indicators 416a, b may be configured in various manners to cause images from each side of the path pylons 410 to appear different (e.g., mirrored).

In some embodiments, the path stripe 440 includes path stripe direction indicator 444 as part of the path stripe location indicator 442. The path stripe direction indicator 444, for example, may be a specific sequence of dashes before each path stripe location indicator 442. The location identifier 146 may determine the direction of travel based on whether the path stripe direction indicator 444 is at the beginning of the path stripe location indicator 442 or at the end of the path stripe location indicator 442 as captured in images from the cameras 72.

In some embodiments, the direction (e.g., North-South, East-West, NE-SW, etc.) of the cart path 320 is known at each location along the cart path 320. For example, the direction of the cart path 320 may be stored as an additional entry in the location mapping table 160. The location identifier 146 may determine direction of the vehicle 10 along the cart path 320 by comparing a signal from a geomagnetic sensor (e.g., a compass) to the direction associated with the vehicle current location 364 on the cart path 320.

In some embodiments, the location identifier 146 determines the position of the vehicle 10 by triangulation using electromagnetic signals. GPS signals from a number of satellites may be received by the antennas 78 of the vehicle 10. The propagation time of multiple satellite signals and the location of the satellite may be used to determine a location of the vehicle 10. Propagation of GPS signals, however, may be affected by conditions at the golf course 300. For example, tree cover or cloud cover may cause the location determined by GPS to be less accurate. In some embodiments, the techniques described herein may be combined with GPS triangulation to improve the locations determined by the location identifier 146.

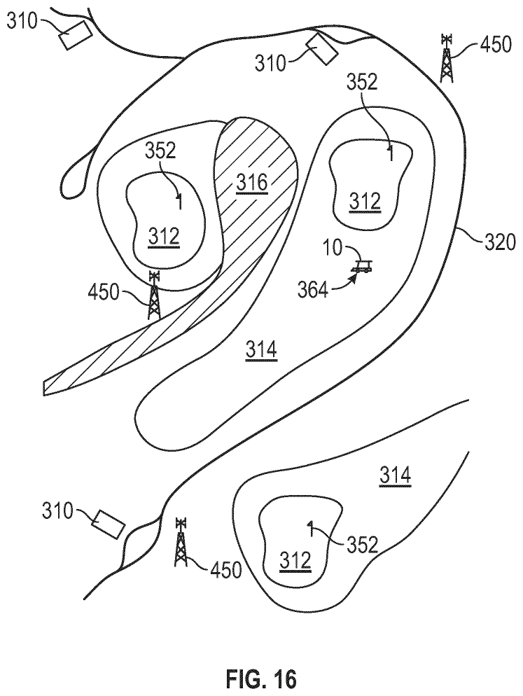

As shown in FIG. 16, terrestrial triangulation systems may also be used to determine a vehicle current location 364 on the golf course 300. The antennas 78 may transmit a signal from the vehicle 10 from which a direction to the signal can be determined by two or more direction finding towers 450. The location identifier 146 may determine the intersection of the direction found by the two or more direction finding towers 450 to determine a location of the vehicle 10. Accuracy may be increased by adding additional towers at the golf course 300.

Either triangulation scheme (e.g., GPS or terrestrial triangulation) may navigate the cart path 320 using only the triangulation scheme or in combination with any of the camera-based techniques described herein. For example, the GPS or terrestrial triangulation may be used for navigating the first route 370 to the cart path 320 and the third route 452 from the cart path to the green staging location 340 but may not have the accuracy required to remain on the cart path 320 or to park the vehicle 10 at the vehicle final location 366 without image processing. The camera-based navigation techniques may be used to navigate the second route 380 along the cart path 320. Further camera-based systems, the LiDAR sensors 74, and the radar sensors 76 may be used for safety features such as obstacle avoidance, collision detection, etc.

In some embodiments, the cart path 320 is navigated without any specific demarcation. For example, historical images (e.g., configuration images, path training images, etc.) may be captured from the cart path and associated with the particular location and direction of travel (e.g., during a path establishment mode). During navigation the location identifier 146 may generate a trajectory determined to cause a current image as captured by the cameras 72 to become more similar to a stored image in the location mapping table 160 associated with a target location. Similar to navigation by landmarks 420 or path pylons 410 along the cart path 320. The location identifier 146 may compare a current image to an image associated with a target location and determine a transformation on the image (e.g., scaling and/or translation) that causes an increase in a similarity score between the current image and the image from the target location. The transformations may be converted into a trajectory or a heading for following by the route follower 134. Path following (e.g., of the cart path 320) by historical images may be combined with a triangulation method (e.g., GPS or terrestrial triangulation by the direction finding towers 450). The triangulation may be used to navigate the vehicle 10 to the 320 where navigation by historical imagery may be more accurate and become the primary mode of path following.

The fleet monitoring and control system 200 with go to green functionality may be configured with a path establishment mode. The path establishment mode may be performed by the vehicle control system 100, using the remote systems 240, or by a combination of the two. In some embodiments, the remote systems 240 provides an overhead view of the golf course 300 on which the cart path 320 can be drawn. After a cart path 320 is entered in the remote systems 240 it can be communicated to the vehicles 10 to be stored in the path storage 150. For example, entering the cart path 320 by way of remote systems 240 may be advantageous when an electric triangulation system (e.g., GPS or using the direction finding towers 450) is used to navigate the vehicle 10 to the cart path 320 before camera-based navigation by way of landmarks 420 or path pylons 410 or other demarcations of the cart path 320 are used during traversal of the second route 380.

In some embodiments, the vehicle 10 may enter a path establishment mode (e.g., by way of the operator interface 48). In path establishment mode, the vehicle 10 may capture images from the cameras 72, a vehicle heading, and/or a vehicle location (e.g., geographic coordinates from a GPS and/or using the direction finding towers 450) and store the combination of these elements (e.g., a tuple) in the location mapping table 160. The locations of the vehicle 10 during path establishment mode may be added to the locations defining at the predefined path. The images acquired during path establishment mode may be used during navigation of the path (e.g., in the operation 1050 of the method 1000) and by the location identifier 146 to determine the vehicle current location 364 (e.g., in the operation 1040 of the method 1000). For example, the images acquired during path establishment may be used as the historical images used for navigation by imagery described herein.

In some embodiments, the image and data analyzer 148 is configured to analyze images from the cameras 72. The image and data analyzer 148 may be used by the route determiner 144 and/or the location identifier 146 to perform at three analyses described. In some embodiments, the image and data analyzer 148 is provided with an image of a path marker (e.g., the path pylons 410, the landmarks 420, or the path stripe 440) and decodes any location indicators on the path marker. For example, the image and data analyzer 148 may recognize the patterns, symbols, and/or colors that uniquely identify a path marker and can be related to a location with the location mapping table 160. In some embodiments, the image and data analyzer 148 identifies path marker within an image. For example, identifying where a path pylon 410 or a landmark 420 is within the image. Additionally or alternatively, the image and data analyzer 148 may be used to generate transformations of a current image that, when applied, cause the current image to have increased similarity with a previously captured image (e.g., from on the cart path 320). In some embodiments, the route determiner 144 is configured to convert the image transformations into a new trajectory for the route follower 134. The image and data analyzer 148 may perform analysis using one or more artificial intelligence approaches including non-limiting examples of edge detection and CNNs.

In some embodiments, the image and data analyzer 148 is configured to analyze additional data from the sensor system 70 to help navigate the vehicle 10 along a predetermined path (e.g., the cart path 320). The image and data analyzer 148 may be configured to generate short forward-looking trajectories (e.g., headings, etc.) for the route follower 134 to follow based on the additional sensor data. For example, the image and data analyzer 148 may analyze data from a sensor configured to detect a buried wire or path beacons 432 used to demarcate the cart path 320. The image and data analyzer 148 may generate a new heading that is in the direction of greatest increase in signal strength for the route follower 134, causing the vehicle 10 to navigate the cart path 320. In some embodiments, the image and data analyzer 148 uses data from other sensors to follow the path (e.g., by path beacons 432 or buried wire) and uses the images captured by the cameras 72 to determine the vehicle current location 364 on the cart path 320.

In some embodiments, the obstacle avoidance system 136 and the guardrails 138 provide additional features to the autonomous vehicle controller 130 and may be used to augment the speed controller 132 and the route follower 134 with additional situational awareness.

The obstacle avoidance system 136 may be configured to detect obstacles blocking any of the routes generated by the route determiner 144. The obstacle avoidance system 136 may detect objects on the route or the cart path 320 that would not normally disrupt the operation of the go to green controller 140, but could present an undesirable condition or threat of damage to the vehicle 10. For example, the obstacle avoidance system 136 may detect fallen branches, personal items, people, etc. that would not prevent navigation by camera or by electric triangulation. The location identifier 146 may process data received from the sensor system 70 (e.g., the cameras 72, LiDAR sensors 74, and/or radar sensors 76) to detect obstacles with which the vehicle 10 may collide. In some embodiments, the obstacle avoidance system 136 calculates a probability of collision and takes appropriate mitigating action to avoid the collision (e.g., stops, maneuvers around the object, etc.).

In some embodiments, the obstacle avoidance system 136 is configured to generate a route around an obstacle impeding the vehicle 10 on the selected route. The obstacle avoidance system 136 may temporarily override navigation along the route from the route determiner 144. The obstacle avoidance system 136 may generate a temporary route around the obstacle, for example, starting at the vehicle current location 364 and ending on the selected route beyond the obstacle. The vehicle 10 may continue typical navigation along the selected route after navigating the temporary route. The obstacle avoidance system 136 may use a combination of visual cues from the cameras 72 (e.g., tracking the point at which the temporary route ends on the selected route), a triangulation system (e.g., the GPS and/or the direction finding towers 450), the LiDAR sensors 74, and/or the radar sensors 76 to generate and navigate the temporary route around the obstacle.

The obstacle avoidance system 136 may be configured to determine transient obstacles and/or stationary obstacles. After detecting a transient obstacle (e.g., person, animal, another vehicle, etc.), the obstacle avoidance system 136 may decide to wait for the obstacle to pass before continuing, or the obstacle avoidance system 136 may determine a temporary route around the transient obstacle. In some embodiments, the temporary route accounts for a predicted trajectory of the transient obstacle. After detecting a stationary obstacle (e.g., tree branch, course debris, lost personal item, etc.), the vehicle 10 may determine a trajectory capable of maneuvering the vehicle 10 around the obstacle. Additionally, the obstacle avoidance system 136 may be configured to report the presence of a stationary obstacle to other vehicles 10 operating at the golf course. For example, the vehicle control system 100 may use peer to peer communication to report the obstacle to other vehicles 10. Knowledge of the obstacle may cause the other vehicles 10 to choose other routes that avoid the obstacle and do not require generation of a temporary route around the obstacle. Additionally or alternatively, the vehicle control system 100 may report the obstacle via the communications network 210 to the remote systems 240. The remote systems 240 may then report to the other vehicles 10, update the route determiner 144 logic, etc. The remote systems 240 may also generate a work order (e.g., maintenance ticket, etc.) for an operator and report back to the other vehicles 10 or re-update the route determiner 144 logic after the obstacle has been cleared by the operator.

In some embodiments, the guardrails 138 provide additional threat avoidance systems. The guardrails 138 may monitor the operation of the go to green controller 140 and the autonomous vehicle controller 130 to determine if any components of the system are at fault (e.g., hardware fault or software fault). The guardrails 138 may monitor data from the sensor system 70 and compare it to control operations to detect various faults. The guardrails 138 may, upon detection of a fault, cease autonomous vehicle motion. Additionally or alternatively, the guardrails 138 may alert an operator of the golf course (e.g., via the remote systems 240) of the fault so that another vehicle 10 can be provided. In some embodiments, a detected fault is communicated to the remote systems 240 and another vehicle 10 is automatically dispatched using the go to green functionality to meet the golfer 360 at the appropriate green 312. Nonlimiting examples of faults that the guardrails 138 may be configured to detect include: a sensor failure, software errors, failures of the drive components (e.g., the driveline 50, suspension system 60, braking system 62), loss of tire pressure, battery failures, environmental misinterpretation (e.g., driving towards an incorrect landmark 420, a hazard 316, onto a green 312, etc.). The guardrails 138 may also self-diagnose, preventing failures that could risk more severe consequences if another system failed subsequently.

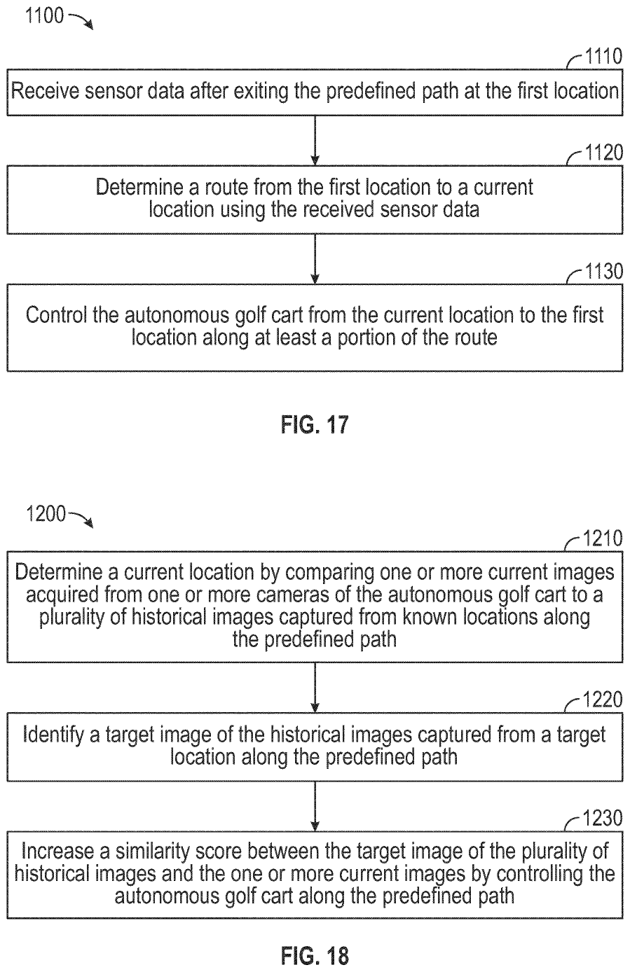

FIGS. 17-19 show additional methods that may be used to perform various operations of the method 1000.

FIG. 17 shows a method 1100 for saving a route from a position away from the predefined path (e.g., the cart path 320) to the predefined path and traversing the path backwards to arrive back at the predefined path, according to some embodiments. For example, the operation 1030 may include performing the method 1100. Advantageously, the method 1100 allows the vehicle 10 to reenter the predefined path without using GPS or direction finding towers 450, which may not be available.

The method 1100 may include receiving sensor data after exiting the predefined path at the first location in operation 1110. The IMU 80 may provide velocity, acceleration, and heading information to the vehicle control system 100. After the vehicle 10 leaves the predefined path (e.g., the cart path 320) the vehicle control system 100 may begin saving the IMU 80 information. At operation 1120, the method 1000 may determine a route from the first location to a current location using the received sensor data. The data from the IMU 80 contains acceleration information that can be integrated to obtain velocity and position data to determine the route from the first location (e.g., where the vehicle 10 exited the cart path 320). After the trigger is received, the to enter autonomous mode in the operation 1010, the method 1100 may include controlling the autonomous golf cart (e.g., the vehicle 10) from the current location to the first location along at least a portion of the route. For example, the vehicle 10 may turn around and follow the route stored during the operation 1120, or the vehicle 10 may traverse the route in reverse. In some embodiments, the vehicle control system 100 may generate commands for the steering system 66 and/or the driveline 50 to cause the reverse accelerations stored from the IMU 80 to occur causing the vehicle to traverse the route and arrive at the first location (e.g., where the vehicle exited the first location).

FIG. 18 shows a method 1200 for navigating a predefined path (e.g., the cart path 320) using images collected from the predefined path, according to some embodiments. The route determiner 144 may implement the method 1200 while traversing the second route 380 along the cart path 320 (e.g., during the operation 1050). The method 1200 may be used during navigation by camera based on stored images captured from along the cart path 320. The method 1200 may be used with or without the aid of additional demarcation of the predefined path (e.g., by path pylons 410, landmarks 420, a path stripe 440, path beacons 432, etc.).

The method 1200 may include determining a current location by comparing one or more current images acquired from one or more cameras of the autonomous golf cart to a plurality of historical images captured from known locations along the predefined path in operation 1210. For example, the image and data analyzer 148 may use a CNN to compare current images from the cameras 72 to images stored in the location mapping table 160. The location identifier 146 may identify the current location based on the image associated with the highest similarity score.

The method 1200 may include identifying a target image of the historical images captured from a target location along the predefined path. For example, based on the route, the route determiner 144 may determine a next image along the predetermined path to select as the target image. The method 1200 may also include increasing a similarity score between the target image of the plurality of historical images and the one or more current images by controlling the autonomous golf cart along the predefined path. After the target image is selected, the route determiner 144 and the route follower 134 may be configured to operate together to control the vehicle 10 to the target location associated with the target image. As described previously, the route determiner 144 may use the image and data analyzer 148 to determine an image transformation to increase the similarity score between current camera images and the target image. The route determiner 144 may convert the image transformation into a trajectory for the route follower 134 to follow. For example, scaling may be converted into forward motion and image panning (e.g., translation) may be converted into a new heading (e.g., steering commands for the steering system 66).

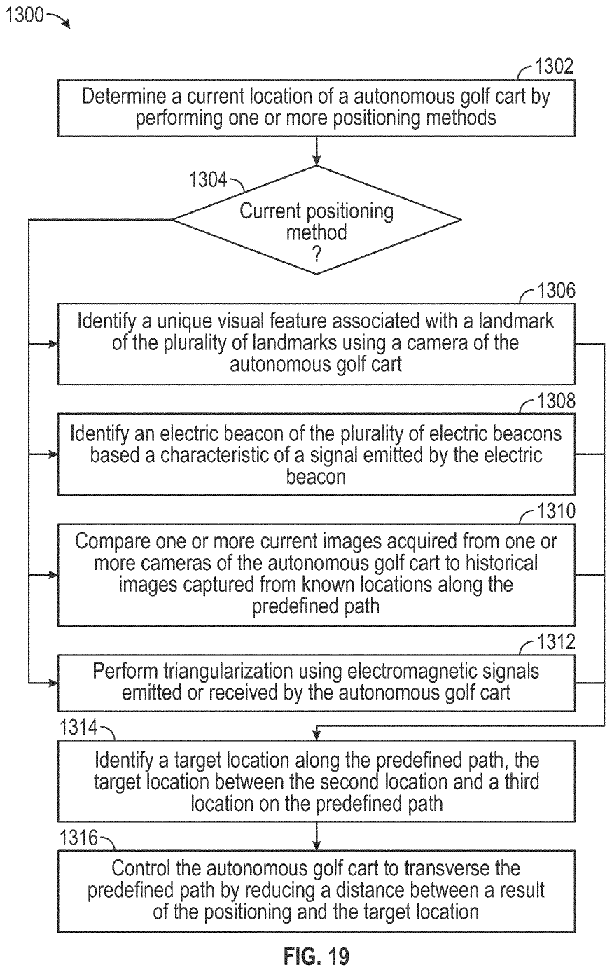

FIG. 19 shows a method 1300 for navigating a predefined path (e.g., the cart path 320), according to some embodiments. The method 1300 combines various methods for determining a location and controlling the vehicle 10 along the second route 380 on the cart path 320. For example, the technique used by the location identifier 146 and the route determiner 144 to identify a location and plot trajectories to a next location on the cart path 320 may change as the cart path 320 is traversed. For example, at some locations, landmarks 420 may be used while at other locations on the golf course 300, triangulation may be performed.

The method 1300 may include determining a current location of an autonomous golf cart (e.g., the vehicle 10) performing one or more positioning methods in the operation 1302. The operation 1302 may depend on one or more current positioning method (e.g., stored as a mode in the location identifier 146). The decision 1304 may determine a number of operations 1306-1312 to perform based on the positioning methods identified.

At operation 1306, the method 1300 may include identifying a unique visual feature associated with a landmark of the plurality of landmarks using a camera of the autonomous golf cart. For example, the path pylons 410 may include a number of dark pylon location indicators 412 and light pylon location indicators 414 composing a unique pattern that may be used by the location identifier 146 to identify a specific path pylon 410 associated with a location in the location mapping table 160. Similarly, landmarks 420 may include a landmark location indicator 422 with a unique visual pattern and path stripe 440 may include a path stripe location indicator 442 with a unique visual pattern. At operation 1308, the method 1300 may include identifying an electric beacon of the plurality of electric beacons (e.g., path beacons 432) based on a characteristic of a signal emitted by the electric beacon. For example, the electric beacons may transmit an encoded number or other identifier associated with the beacon that may be related to a location in the location mapping table 160. Additionally or alternatively, the electric beacon may transmit a signal at a particular frequency that may be used to identify the beacon and associate it with a location. At operation 1310, the method 1300 may include comparing one or more current images acquired from one or more cameras of the autonomous golf cart to historical images captured from known locations along the predefined path. For example, the historical image with the greatest similarity with the current images may be indicative of a vehicle current location 364. At operation 1312, the method 1300 may include performing triangulation using electromagnetic signals emitted or received by the autonomous golf cart.

The method 1300 may include identifying a target location along the predefined path, the target location being between the second location and a third location on the predefined path in operation 1314. The target location may be identified by the route determiner 144 and a trajectory can be created towards the target location. The method 1300 may include controlling the autonomous golf cart to traverse the predefined path by reducing a distance between a result of the positioning and the target location. For example, the route follower 134 may follow the trajectory by adjusting the heading of the vehicle 10 with by generating steering commands for the steering system 66 and driving forward, thus causing the next positioning calculation performed with the operations 1306-1312 to have a reduced distance to the target location. A new target location may be chosen and the operations 1314-1316 may be repeated to cause the vehicle to traverse the cart path 320 along the second route 380.

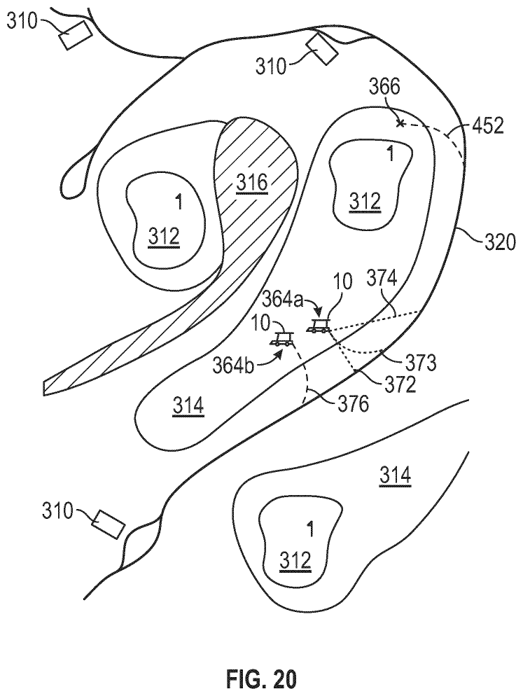

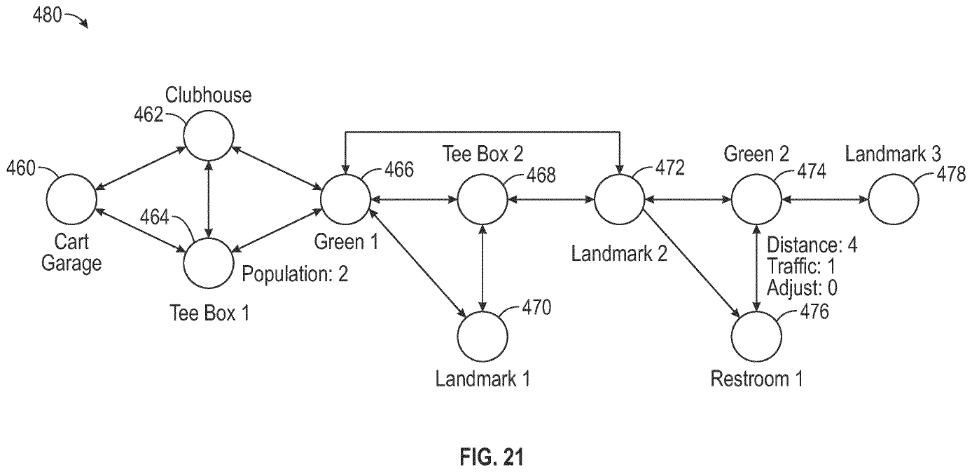

FIG. 20 shows various routes that may be traversed by the vehicle 10 from the vehicle current location 364 to the vehicle final location 366 within the green staging location 340. The route determiner 144 may be configured to determine a first route 370 from the vehicle current location 364 to a first location where the vehicle 10 is to enter the cart path 320, a second route 380 from the first location to a third location where the vehicle is to exit the cart path 320 and a third route 452 from the third location on the cart path 320 to the vehicle final location 366. The route determiner 144 can use methodologies to determine the routes.

In some embodiments, the route determiner 144 may choose a shortest first route 372 from an initial vehicle location (e.g., the vehicle current location 364 proximate to where the golfer 360 took their shot) to the cart path 320. For example, the route determiner 144 may determine a straight path that enters the cart path 320 at a right angle. Additionally or alternatively, the route determiner 144 may break the first route 370 into two components: a shortest path from the vehicle current location 364 to the fairway and then from the point the vehicle 10 exits the fairway, a shortest path to the cart path 320.

In some embodiments, the route determiner 144 is configured to optimize (e.g., minimize) an objective function of the route, r, given by:

$$J ( r ) = {w}_{g} {d}_{g} ( r ) + {w}_{p} {d}_{p} ( r ) ,$$

where d_{g}(r) is a term representing the distance traveled off of the cart path 320 (e.g., the sum of the distances of the first route 370 and the third route 452), dₚ(r) is a term representing the distance traveled on the cart path 320 (e.g., the distance of the first route 370), and w_{g} and wₚ are weighting factors for the distance traveled off of the cart path 320 and the distance traveled on the cart path 320 respectively. The shortest first route 372 illustrates a potential route when the weighting factor for the distance traveled off of the cart path 320, w_{g}, is significantly greater than (e.g., a factor of 10, etc.) the weighting factor for the distance traveled on the cart path 320, wₚ. Alternatively, a second straight optimized first route 374 shows the distance traveled off of the cart path 320 when it is less heavily weighted (e.g., w_{g} is two or three times wₚ).

In some embodiments, the route determiner 144 may optimize the objective function subject to one or more constraints. For example, geofencing may prevent the route determiner 144 from determining a route that enters a hazard 316 or the green 312. Additionally or alternatively, the route determiner 144 may constrain the total distance traveled off of the cart path 320 to be less than a certain percentage of the total distance traveled.

In some embodiments, the route determiner 144 may include regularization terms in the objective function to cause the vehicle to turn smoothly. For example, the maximum curvature of the route, r, may be included in the objective function. A curved optimized first route 373 shown in FIG. 20 is representative of a route found with a regularization term based on the maximum curvature. The curved optimized first route 373 may avoid high curvatures and associated substantial steering commands at the location the vehicle 10 enters the cart path 320 and may represent a more natural driving route.

In some embodiments, navigation to the cart path 320 is not available by GPS or other electronic triangulation methodology. The go to green controller 140 may be configured to back track (e.g., reverse) the route the driver took from the cart path 320 to the vehicle current location 364. For example, the vehicle 10 may execute the method 1100. As the vehicle exits the cart path 320 onto the fairway, the go to green controller 140 may begin storing data from the IMU 80. The route determiner 144 may be configured to create a route from the IMU 80 data, shown as a reversal route 376. When the trigger to enter autonomous mode is received, the route determiner 144 may generate trajectories along the reversal route 376 until the navigation may be performed using another method. For example, navigation may transition to following the path pylons 410, landmarks 420, particular path surface material 430, path stripe 440, or path beacons 432 after the vehicle 10 is in range (e.g., has a line of sight to or can receive signals from) the particular demarcation used for the cart path 320 at the current location. Similarly, the vehicle 10 may navigate the reversal route 376 until it is able to begin navigation by the images collected during path establishment (e.g., if no specific demarcation is used).

In some embodiments, the path storage 150 may store the cart path 320 as a graph for the purposes of optimization. As shown in FIG. 21, a cart path connectivity graph 480 includes various locations along the cart path 320 represented by nodes 460-478 and edges connecting the nodes representing the cart path 320 connecting the locations represented by a node on either side of the edge, according to some embodiments. The cart path may bifurcate allowing the vehicle 10 to follow different paths to the same location. For example, in the cart path connectivity graph 480, the vehicle 10 may traverse the cart path 320 from the cart garage (represented by the node 460) to the node 462 for the clubhouse or the node 464 for the first tee box. The vehicle 10 may continue either of these paths to the first green (represented by the node 466). The cart path connectivity graph 480 also includes landmarks represented by nodes 470, 472, and 478, a course restroom represented by node 476 and the second tee box by node 472 and the second green by node 474.

The path storage 150 may store the cart path connectivity graph 480 as a matrix (e.g., a sparse matrix) for which each node represents is associated with a row and a column. A specific element of the matrix may be used to indicate a connection from the node for the associated row to the node for the associated column. In some embodiments, additional data are associated with the nodes and/or edges of the cart path connectivity graph 480. Data that may be used to optimize the distance traverses the cart path 320 may be stored in the path storage 150 as part of the cart path connectivity graph 480. Edges may have static data elements that represent fixed features of the cart path 320. For example, the distance along the cart path 320 between any two locations represented by nodes may be a static element of the edge. Edges may also have dynamic data elements that change, for example, based on the conditions of the cart path 320. Edges of the cart path connectivity graph 480 are shown to include a traffic data element that is indicative of the number of vehicles that are on the represented section of the cart path 320 and an adjust data element that may be used (e.g., by an operator of the golf course 300) to cause vehicles to prefer or avoid the represented section of the cart path 320. In addition, the dynamic data elements may include weather related information, an indication that a particular section of the cart path is blocked (e.g., by a fallen tree, casual water, etc.) and cannot be traversed or any other information that may be used by the route determiner 144 to determine an optimized path from the vehicle current location 364 to the vehicle final location 366. Nodes may also have static and dynamic data elements associated with them. For example, the first tee box represented by node 464 is shown to have a current population (e.g., number of vehicles 10 in the staging area) of two. In some embodiments, some sections of the cart path 320 are one way as indicated by the single directional arrow between the node 472 and the node 476.

The cart path connectivity graph 480 may be illustrative only, and it is contemplated that in some embodiments the cart path connectivity graph 480 may be significantly more complex. For example, every location indicator (e.g., path pylons 410, landmark location indicator 422, path stripe location indicator 442) may be included as a node on the cart path connectivity graph 480. In addition, each lane of the cart path 320 may be individually included as an edge in the cart path connectivity graph 480.

In some embodiments, dynamic programming is used to find an optimized route between the two nodes in the cart path connectivity graph 480. The objective function may be any function of the data elements associated with the edges and nodes traversed by a given second route 380. For example, the objective function may be the sum of the distances of all edges traversed by a given second route 380. Additionally or alternatively, the objective function may include terms related to the dynamic data elements of the edges and nodes. For example, the traffic data element may increase the objective function by 1.5 for each additional golf cart traversing the associated edge. In some embodiments, the traffic data element is predictive and uses a traffic data element based on the expected traffic when the vehicle 10 would get to the edge.

In some embodiments, the dynamic programming algorithm for optimizing the second route 380 is combined with optimization of the first route 370 and the third route 452. For example, optimized routes can be found for second routes 380 between each of a first set of nodes near the vehicle current location 364 and each of a second set of nodes near the green staging location 340. When optimizing the overall route, the objective function for each of the optimized routes can be added to the objective function for an optimal first route 370 to the location associated with the node from the first set and an optimal third route 452 from the location associated with the node from the second set.

### Variation of Path to Minimize Turf Damage

According to an exemplary embodiment, the vehicles 10 are configured to determine (e.g., alter, adjust, modify, etc.) a route to minimize damage to a terrain of the golf course 300. For example, a vehicle 10 may determine a route (e.g., a first route 370, a second route 380) based at least on one or more parameters of the terrain. The vehicles 10 can dynamically adjust their operation based on the characteristics of the terrain, preventing issues such as excessive turf damage or instability on uneven or slippery surfaces. The vehicles 10 and the fleet monitoring and control system 200 can integrate terrain-awareness capabilities, enabling the vehicles 10 to operate effectively across diverse environments while minimizing environmental impact and ensuring stability.

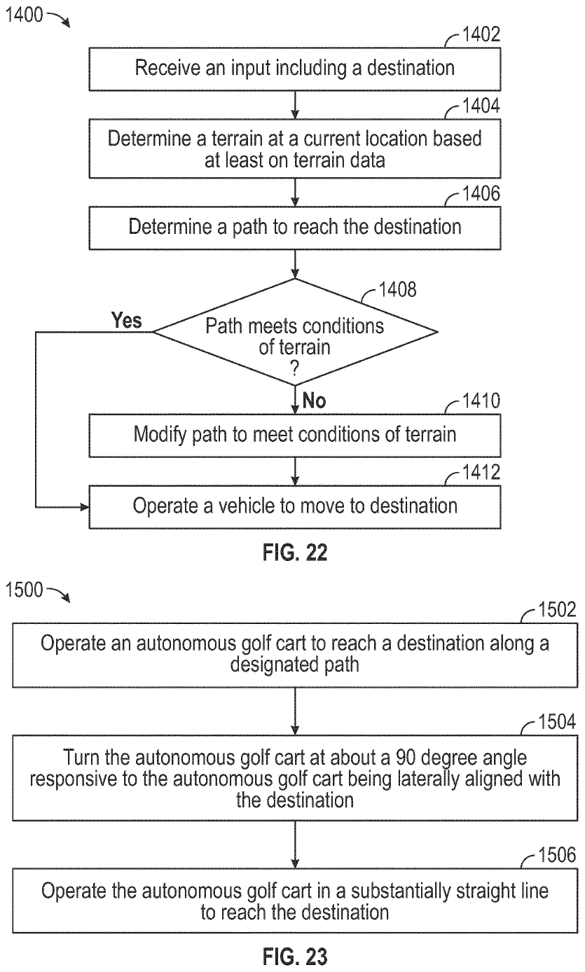

As shown in FIG. 22, a method 1400 is directed to a method for determining a route of a vehicle 10. At step 1402, one or more processing circuits (e.g., the vehicle control system 100, the remote systems 240, etc.) are configured to receive an input including a destination for a vehicle 10 to reach. The one or more processing circuits include at least one of a first processing circuit located on the vehicle 10 or a second processing circuit located remote from the vehicle 10. The input is received from at least one of the golfer 360 (e.g., via the user device 232), one or more other vehicles 10, or a remote server (e.g., via the remote systems 240). For example, the golfer 360 may provide instructions to the vehicle 10 to go to a green 312, where the vehicle 10 will proceed to autonomously operate to a location proximate the green 312 (e.g., near the green 312 on the fairway 314, near the green 312 on the cart path 320, within the green staging location 340, etc.).

In some embodiments, the destination may be a green location (e.g., the vehicle final location 366). In other embodiments, the destination may be a location of a ball responsive to a golf stroke (e.g., where the golfer 360 hits the ball). As described previously, by way of example, the golfer 360 may park the vehicle 10 (e.g., along the cart path 320, off the cart path 320) and exit the vehicle 10 to walk to a location (e.g., on the fairway 314, adjacent the fairway 314 in the rough, etc.) of their ball to hit their next shot. The one or more processing circuits may receive an input (e.g., from the golfer 360) providing instructions to the vehicle 10 to autonomously navigate to a location of the ball following a golf stroke (e.g., a ball location 502). In some embodiments, the ball location 502 is determined by the fleet monitoring and control system 200 based on position data (e.g., ball data) received from one or more sensors located about the golf course 300, of the sensor system 70, and/or on other vehicles 10 on the golf course 300. By way of example, the one or more user sensors 220 may acquire GPS data and/or RTK data used to determine the ball location 502. By way of another example, the ball may include one or more communication devices (e.g., embedded in the golf ball, disposed along an exterior surface of the golf ball, etc.), such as radio frequency identification device, a near field communication device, or a Bluetooth Low-Energy device. The ball location 502 may be determined based on communications (e.g., signal strength) between (i) the one or more communication devices of the ball, (ii) the antennas 78, (iii) one or more communication devices located on a golf course 300.

At step 1404, one or more processing circuits (e.g., the vehicle control system 100, the remote systems 240, etc.) are configured to determine a terrain between a current location of the vehicle 10 (e.g., on a golf course 300) and the destination. The current location of the vehicle 10 can be determined using a GPS system (e.g., via the antennas 78).

The one or more processing circuits are configured to determine the terrain based at least on one or more terrain parameters. The terrain parameters can include a surface type or a terrain moisture characteristic. Examples of surface types include grass (e.g., fairways, greens, or roughs), sand (e.g., bunkers), dirt (e.g., paths or off-course areas), asphalt or concrete (e.g., cart paths or paved areas), gravel, and turf. Terrain moisture characteristics can include dry areas with little to no moisture (e.g., maintained fairways during dry conditions), wet areas such as recently watered grass or regions with residual rainfall, saturated areas like waterlogged regions prone to slippage or turf damage, and frozen areas with hard surfaces due to sub-freezing temperatures. Combinations of the terrain parameters can also be determined, such as grass with high moisture levels (e.g., recently watered fairway), sand with medium dryness (e.g., partially compacted bunker), and asphalt with no moisture (e.g., dry cart path). The terrain parameters allow the vehicle 10 to adapt its operation dynamically based on the terrain.

According to some embodiments, the one or more processing circuits are configured to determine the one or more terrain parameters based at least on terrain data. The vehicle 10 includes sensors (e.g., the sensor system 70) configured to acquire terrain data. Terrain data can include moisture data, elevation data, surface roughness data, weather data (e.g., humidity, temperature, rainfall, etc.), and/or traction data. The vehicle sensors may include sensors or functionality from the sensor system 70 (e.g., the cameras 72, the LiDAR sensors 74, the radar sensors 76, antennas 78, etc.). The vehicle sensors can include a soil moisture sensor, an elevation sensor, a surface roughness sensor, and/or a traction sensor. The soil moisture sensor is configured to measure the water content in the terrain to identify areas that are dry, wet, or saturated. The soil moisture sensor is configured to analyze heat signatures and determine moisture levels (e.g., dry soil emits more heat than wet soil). The elevation sensor is configured to detect variations in a terrain height (e.g., slopes or uneven surfaces). The surface roughness sensor is configured to evaluate a texture of the terrain to differentiate between smooth and coarse surfaces. The traction sensor is configured to monitor wheel slippage or resistance to assess a current level of grip.

According to some embodiments, the one or more processing circuits are configured to acquire the terrain moisture characteristic from at least one of a weather service, the vehicle sensors (e.g., sensor system 70), or external sensors (e.g., on the golf course 300). For example, the one or more processing circuits are configured to retrieve real-time weather data, such as rainfall history or humidity levels, from a weather service (e.g., external weather service) to predict moisture conditions on a golf course. The vehicle sensors (e.g., soil moisture sensors or infrared sensors) are configured to provide localized, real-time measurements of the water content in the terrain, thereby enhancing terrain moisture assessment. The external sensors (e.g., distributed throughout the golf course), such as stationary moisture detectors or weather monitoring systems, can transmit (e.g., via the remote systems 240) data to the vehicle 10, enabling the one or more processing circuits to acquire the terrain moisture characteristics.

In some embodiments, the terrain parameter is determined at least partially based on one or more previous paths for one or more other vehicles 10 at or proximate the current location of the vehicle 10. The one or more processing circuits are configured to save one or more routes of the vehicles 10. For example, the fleet monitoring and control system 200 is configured to store (e.g., save) the one or more previous routes of a respective vehicle 10 (e.g., in a memory 104 of the vehicle 10, in a memory 254 of the off-site server 250, in a memory 264 of the on-site system 260, in a memory of the user device 232, etc.).

The terrain parameters (e.g., surface type) can be determined (e.g., detected) via the one or more processing circuits using machine learning models to classify images from cameras or patterns identified by LiDAR. For example, the one or more processing circuits may be configured to conduct color recognition via the one or more sensors to differentiate between green grass, brown dirt, or white sand. The one or more processing circuits may be configured to, via the terrain data acquired from the traction sensor, conduct traction analysis to detect slippage or wheel resistance for different surfaces (e.g., grass vs. sand). The one or more processing circuits may be configured to determine the terrain moisture characteristic via the soil moisture sensors that measure water content in the soil. The one or more processing circuits are configured to determine whether a terrain has been driven over substantially based at least on the terrain data.

At step 1406, one or more processing circuits are configured to determine a route (e.g., a first route 370) for the vehicle 10 to reach the destination. For example, the one or more processing circuits are configured to determine a route from a vehicle current location 364 to a vehicle final location 366 (within a green staging location 340). The route may be determined using various course rules, general rules-of-the-road that are followed on the cart path, wayfinding, and/or optimization algorithms.

At step 1408, one or more processing circuits are configured to determine whether the route meets the conditions of the terrain. The one or more processing circuits can determine whether the route meets the conditions of the terrain based at least on the terrain parameters (i.e. whether it is permitted and/or optimal for the vehicle 10 to operate along the route based on the terrain parameters). By way of example, this can be determined using one or more optimization algorithm). The optimization algorithm(s) may include one or more machine learning models (one or more neural networks, etc.). By way of another example, the fleet monitoring and control system 200 may include a threshold regarding the number of times a route can be taken by a vehicle 10 in a set amount of time. In other words, the one or more processing circuits can determine that the route does not meet the conditions of the terrain if a route has been taken by one or more vehicles 10 at least a threshold number of times in a set amount of time. The threshold(s) may be determined by an operator and/or determined by the fleet monitoring and control system 200 via the terrain data. The one or more processing circuits may be configured to conduct visual recognition via the one or more sensors to determine whether the terrain along a route is damaged (e.g., or at risk of damage). The threshold(s) may be varied or updated in real-time.

At step 1410, responsive to determining that the route does not meet the conditions of the terrain, the one or more processing circuits are configured to modify the route to satisfy the conditions of the terrain. The one or more processing circuits are configured to determine an alternate route from a vehicle current location 364 to a vehicle final location 366, hereby referred to as a modified route 550, based at least on the terrain.

According to some embodiments, the one or more processing circuits are configured to acquire environment data regarding one or more external objects of the golf course 300. For example, one or more sensors of the sensor system 70 can transmit environment data regarding one or more external objects in the environment. The one or more processing circuits are configured to identify the external objects and determine the terrain parameter at least partially based on the environment data. For example, the terrain parameter may include that an external object is on a surface of the terrain. The external objects can include, but are not limited to, other vehicles 10 and/or obstacles (e.g., boulders, trees, sandtraps, golfers, golf course staff, bodies of water, etc.). The vehicle sensors (e.g., the cameras 72) may be configured to capture visual data for obstacle detection through image processing or machine learning algorithms. The vehicle sensors (e.g., the LiDAR sensors 74) are configured to identify objects based on their shape and proximity to the vehicle 10. The one or more processing circuits can provide a modified route 550 at least partially based on the environment data.

In some embodiments, the modifying of the route includes adjusting the drive parameters of the vehicle 10. The drive parameters of the vehicle 10 are adjusted based at least on the terrain. The drive parameters can include, but are not limited to, a speed (e.g., of one or more motors 53), a torque output (e.g., of one or more of the motors 53), a turning radius (e.g., of the steering system 66), or an acceleration (e.g., of one or more of the motors 53). In some embodiments, the same route (e.g., a first route 370) may be maintained, and the drive parameters of the vehicle 10 may be adjusted to minimize a damage to a terrain. The modifying of the drive parameters ensures the vehicle 10 operates efficiently across varying terrain types, such as wet grass, turf, or cart paths, while maintaining stability and minimizing disruption or damage to sensitive surfaces. For example, if the one or more processing circuits determine that the vehicle 10 is on grass based at least on the current location of the vehicle 10 and/or the terrain parameters, the one or more processing circuits can reduce the speed and increase the turning radius of the vehicle 10 to prevent turf damage.

In some embodiments, the modified route 550 can be at least partially based on the one or more previous paths to substantially minimize repeated driving along at least a portion of the one or more previous paths. For example, the modified route 550 can be based on avoiding one or more previous routes of a respective vehicle 10 and/or one or more previous routes of one or more other vehicles 10. The one or more processing circuits can modify a route based on the one or more previous routes of the respective vehicle 10. For example, the one or more processing circuits may provide a modified route 550 to the respective vehicle 10 if the vehicle 10 has previously operated along a route, preventing the vehicle 10 from repeatedly running over the same route and damaging the terrain along the route.

In some embodiments, the one or more processing circuits are configured to provide a modified route 550 to the vehicle 10 responsive to determining that the respective vehicle 10 has operated along the route at least a threshold amount of times. The threshold amount can be inputted to the fleet monitoring and control system 200 (via the user device 232 and/or the remote systems) by an operator. The threshold amount can be determined by the fleet monitoring and control system 200 based at least on an optimization algorithm to minimize a damage to a terrain. For example, the threshold amount can include instructions to the vehicle 10 to prevent the vehicle 10 from running the same route too many times in a set amount of time (e.g., a route can only be run a certain number of times in an hour).

In some embodiments, the modified route 550 can be determined based on a combination of factors, such as terrain, external objects, previous vehicle routes, etc. The one or more processing circuits are configured to determine and analyze the terrain, external objects, previous vehicle routes, etc. to provide the modified route 550 to prevent damage to a terrain and/or avoid external objects. The modified route 550 can be adjusted in real-time by the one or more processing circuits based on terrain data, environment data, etc.

At step 1412, responsive to determining that the route (e.g., the first route 370, the modified route 550) does meet the conditions of the terrain, the one or more processing circuits are configured to provide instructions to the autonomous golf cart based on the designated path to autonomously drive along the designated path (e.g., the route) to the destination. The vehicle 10 may be configured to navigate along the route using various sensors of the sensor system 70. The vehicle control system 100 may be configured to maintain the vehicle 10 along the route and communicate commands to the driveline 50, the steering system 66, and the braking system 62.

In some embodiments, the vehicle 10 and/or fleet monitoring and control system 200 are configured to acquire real-time data regarding the terrain. For example, the vehicle 10 and/or fleet monitoring and control system 200 are configured to acquire one or more signals from one or more sensors (e.g., of the sensor system 70) regarding a terrain that the vehicle 10 is operating on and/or an environment surrounding the vehicle 10. The one or more processing circuits are configured to provide the modified route 550 at any point along a route based on the real-time data. For example, as the vehicle 10 is operating to reach a destination, if the vehicle 10 detects a hazard (e.g., wet area), the one or more processing circuits can provide the modified route 550 in real-time for the vehicle 10 to avoid operating on (e.g., over, through) the hazard.

Modifying a route based on the terrain along the route can be particularly advantageous when the vehicle 10 is operating on turf. Turf can be easily damaged by repeatedly running over the same portions of turf, such as operating the vehicles 10 along the same routes to reach a destination. Such damage may include killing the grass, causing discoloration of the grass, and creating ruts. By dynamically adjusting drive parameters based on real-time terrain data, the vehicles 10 and the fleet monitoring and control system 200 minimize damage to the turf by avoiding excessive use of the same routes.

As shown in FIG. 23, a method 1500 is directed to a method for operating a vehicle 10 to reach a destination. At step 1502, one or more processing circuits (e.g., the vehicle control system 100, the remote systems 240, etc.) are configured to operate a vehicle 10 to reach a destination. For example, one or more processing circuits are configured to operate the vehicle 10 to reach a destination (e.g., a vehicle final location 366) along a route (e.g., a first route 370, a modified route 550).

At step 1504, one or more processing circuits are configured to turn the vehicle 10 at about a 90-degree angle responsive to the vehicle 10 being laterally aligned with the destination. In some embodiments, the vehicles 10 are configured to turn at about a 90-degree angle off a cart path 320 and enter a fairway 314 when laterally aligned with the destination. In some embodiments, the vehicles 10 are configured to exit a fairway 314 and return to the cart path 320 at about a 90-degree angle responsive to reaching the destination.

At step 1506, one or more processing circuits are configured to operate the vehicle 10 in substantially a straight line to reach the destination. For example, the vehicle 10 may operate directly to reach the destination in an approximately straight line, ensuring that the vehicles 10 are operating along a similar direction within the fairway 314. This can help avoid vehicle collisions on the fairway 314.

While method 1400 and method 1500 have been described separately, it should be understood that method 1400 and method 1500 may be used in combination (i.e., modifying a route based on terrain parameters using the sensor system 70 of the vehicle 10 and turning a vehicle 10 to reach the destination at about a 90-degree angle).

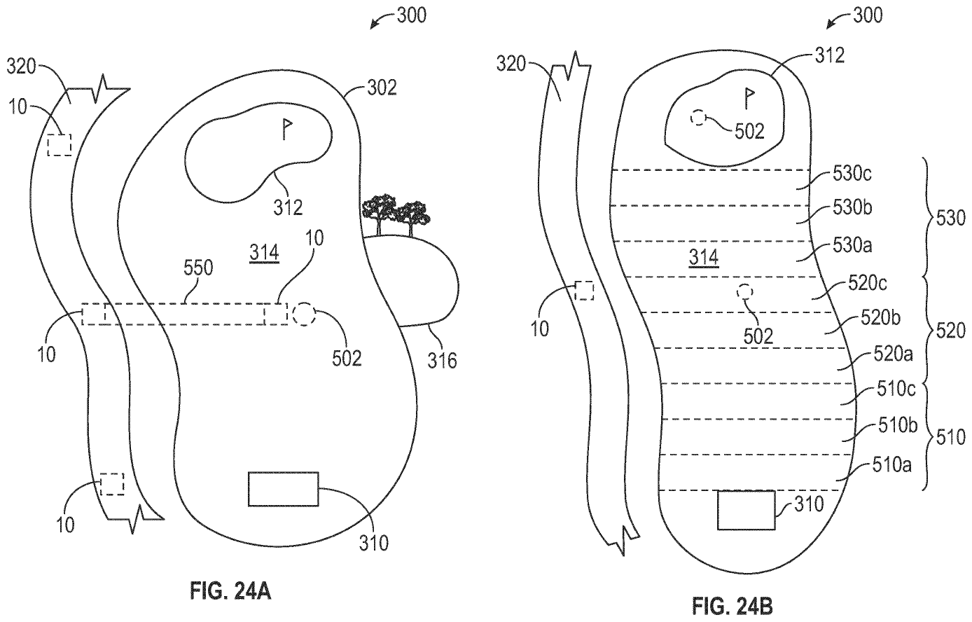

As shown in FIG. 24A, the vehicles 10 are configured to be enter and/or exit a fairway 314 at about a 90 degree angle relative to the cart path 320 of the golf course 300. Following the one or more processing circuits determining a route (e.g., a first route 370, a modified route 550) for the vehicle 10 to reach a destination, the one or more processing circuits can cause the vehicle 10 to be orientated at about a 90 degree angle relative to an entryway into the fairway 314 from the cart path 320 and/or relative to an exit from the fairway 314 to the cart path 320.

The vehicle 10 may receive an input for the vehicle 10 to autonomously operate (e.g., drive) from a current location on the cart path 320 (or the fairway 314) of a hole, shown as hole 302, to a parking location (e.g., a destination) proximate the green 312 of a hole that a golfer 360 associated with the vehicle 10 is playing on. The one or more processing circuits may provide instructions to the vehicle 10 to cause the vehicle 10 to drive a route from the current location to the parking location without the golfer 360 onboard. The one or more processing circuits may at least partially determine the modified route 550 at least based on one of (a) a terrain parameter or (b) one or more previous paths for one or more other vehicles 10. When following a route to enter the fairway 314, the one or more processing circuits may cause the vehicle 10 to enter the fairway 314 at about a 90-degree angle relative to the cart path 320 and operate (e.g., drive) directly to the parking location. When following a route to exit the fairway 314, the one or more processing circuits may cause the vehicle 10 to exit the fairway 314 at about a 90-degree angle relative to the cart path 320 and operate (e.g., drive) directly to the parking location. Operating the vehicles 10 in this manner (e.g., entering and exiting the fairway 314 at an approximate 90-degree angle), can prevent damage to the terrain (e.g., turf) and prevent the formation of ruts. It can also provide structure and order within the golf course 300 and prevent a collision of the vehicles 10.

By way of example, a golfer may hit a ball from the tee box 310 and walk to the ball location 502 (e.g., where the ball landed following the golf stroke, a destination). The golfer may provide an input to the vehicle 10 to meet the golfer at the ball location 502. The vehicle 10 may operate autonomously to reach the ball location 502. Specifically, the vehicle 10 may operate along the cart path 320 until the vehicle 10 reaches a position on the cart path 320 laterally aligned with the ball location 502. Then, the vehicle 10 may turn at about a 90-degree angle and enter the fairway 314 and operate in a substantially straight line along the modified route 550 to reach the ball location 502. By way of another example, the vehicle 10 may be operating on the fairway 314 and receive an input to reach a destination on the cart path 320. The vehicle 10 may operate autonomously to exit the fairway 314 in a substantially straight line along the modified route 550 until the vehicle 10 reaches the cart path 320. Responsive to the vehicle 10 reaching the cart path 320, the vehicle 10 may turn at a 90-degree angle to turn onto the cart path 320.

In some embodiments, the vehicles 10 are configured to modify these operations based on a variety of factors. The variety of factors may include a terrain, external objects, previous vehicle routes, etc. The one or more processing circuits may modify the operations of the vehicle 10 when turning onto or off the fairway 314 and/or the cart path 320 (i.e. such that the vehicle 10 does not turn at about 90 degrees) based on one or more signals from one or more sensors (e.g., located about the golf course 300, of the sensor system 70, and/or on other vehicles 10 on the golf course 300). Similarly, the one or more processing circuits may modify the operations of the vehicle 10 when operating in a substantially straight line to reach the destination based on the one or more signals from the one or more sensors. By way of example, the vehicle may turn onto the fairway 314 at a different angle and/or operate following a different route (e.g., one that is not a substantially straight line) based on a terrain, one or more other vehicles 10, obstacles, etc.

As shown in FIG. 24B, the vehicles 10 are configured to be operated on the golf course 300 divided into a plurality of regions. For example, a hole (e.g., a first hole 302) of the golf course 300 may be divided into three distinct regions: a first region 510 nearest the tee box 310, a second region 520 in the middle of the fairway 314, and a third region 530 nearest the green 312. While only shown as including three regions, it should be understood that the golf course 300 may include any number of regions (e.g., four regions, two regions, etc.). Each region can be further subdivided into subsections. For example, the first region 510 may include a first subsection, shown as subsection 510a (nearest the tee box 310), a second subsection, shown as subsection 510b (in the middle of the first region 510), and a third subsection, shown as subsection 510c (nearest the green 312). The second region 520 may include a first subsection, shown as subsection 520a (nearest the tee box 310), a second subsection, shown as subsection 520b (in the middle of the second region 520), and a third subsection, shown as subsection 520c (nearest the green 312). The third region 530 may include a first subsection, shown as subsection 530a (nearest the tee box 310), a second subsection, shown as subsection 530b (in the middle of the third region 530), and a third subsection, shown as subsection 530c (nearest the green 312). While only shown as each region including three subsections, it should be understood that the golf course 300 may include any number of subsections within a region and the number of subsections may not be the same for each region. The number of subsections and/or regions of a golf course 300 may be determined and optimized based on features (e.g., size, shape, number of vehicles operating on the course, etc.) of the golf course 300.

Each vehicle 10 can be assigned a subregion within a region via the one or more processing circuits. The one or more processing circuits can determine a route (e.g., a first route 370, a modified route 550) at least based on the assigned subregion.

In some embodiments, one or more processing circuits are configured to receive an input including a destination for the vehicle 10. The one or more processing circuits may assign the vehicle 10 a subregion within the region based on the destination. For example, the one or more processing circuits may determine a subregion of the region of the plurality of regions that the destination is located in. The golf course 300 can include one or more sensors (e.g., one or more communication devices, position sensors, or antennas) to capture or acquire data to facilitate determining the region that the destination is located in. By way of example, if the destination is a ball location 502, the region of the destination may be determined using a GPS system (e.g., via the antennas 78) to acquire a GPS position of the ball. By way of example, if the destination is a ball location 502, the region that the ball is located in may be determined based on communications (e.g., signal strength) between the one or more communication devices of the ball and one or more markers (e.g., communication devices, trackers, etc.) located in the region of the ball location 502.

The one or more processing circuits may determine a route (e.g., a first route 370, a modified route 550) at least partially within the subregion for the vehicle 10 to reach the destination. The subregion defines a location for the vehicle 10 to enter or exit a fairway of a hole. For example, the one or more processing circuits can determine a route including an entrance of the vehicle 10 to a fairway (and/or an exit of the vehicle 10 from the fairway) according to which subregion the vehicle 10 is assigned to.

Referring to FIG. 24B, the golfer 360 may hit a ball from the tee box 310 and may proceed to navigate (e.g., walk) to a ball location 502 (e.g., where the ball landed following the golf stroke). The golfer 360 may instruct the vehicle 10 to operate (e.g., drive) autonomously to reach the ball location 502. The one or more processing circuits may determine that the ball location 502 is in a second region 520 of the golf course 300. The one or more processing circuits can assign a subsection of the second region 520 (first subsection 520a, second subsection 520b, or third subsection 530c) in which the vehicle 10 can enter the fairway 314 to reach the ball location 502. The vehicle 10 can exit its assigned subsection responsive to entering the fairway 314 to reach the destination (e.g., the ball location 502). By way of example, a vehicle 10 may always be assigned a same subsection of a region, meaning if a vehicle 10 is to enter any region, the vehicle 10 may always be assigned to enter the region at the region closest to the tee box 310 (e.g., first subsection 510a, first subsection 520a, first subsection 530a). By way of another example, a vehicle 10 may be assigned a subsection of a region based on which subsection the destination is located in. For example, referring to FIG. 24B, since the ball location 502 is in subsection 520c, the vehicle 10 may be assigned second region 520 to enter the fairway 314, providing the vehicle 10 with the path of least resistance (e.g., the straightest path, the shortest path) to reach the ball location 502.

The one or more processing circuits can assign a vehicle 10 a subsection in which to enter or exit the fairway 314 based on a variety of factors. The variety of factors may include terrain, external objects, previous vehicle routes, etc. For example, if a vehicle 10 needs to reach a destination in second region 520, the one or more processing circuits may assign a subsection to the vehicle 10 to minimize a damage to the second region 520. The one or more processing circuits may consider factors such as avoiding an external object (e.g., another vehicle 10), avoiding a route taken previously by the vehicle 10, avoiding a wet surface, etc. Splitting a golf course into regions (and/or subsections) may be advantageous by optimizing the designated paths in which the vehicles 10 can enter into and/or travel out of the fairway 314. This can minimize the chance of a vehicle 10 driving into a path of another vehicle 10 and/or the chance of one or more vehicles 10 colliding.

While the systems as describing regarding FIG. 24A and FIG. 24B have been described separately, it should be understood that the systems described in FIG. 24A and FIG. 24B may be used in combination (i.e., assigning a route to a vehicle 10 based on a subsection of a golf course 300 and the vehicle 10 entering the fairway at about a 90-degree angle relative to the cart path 320).

### Activation

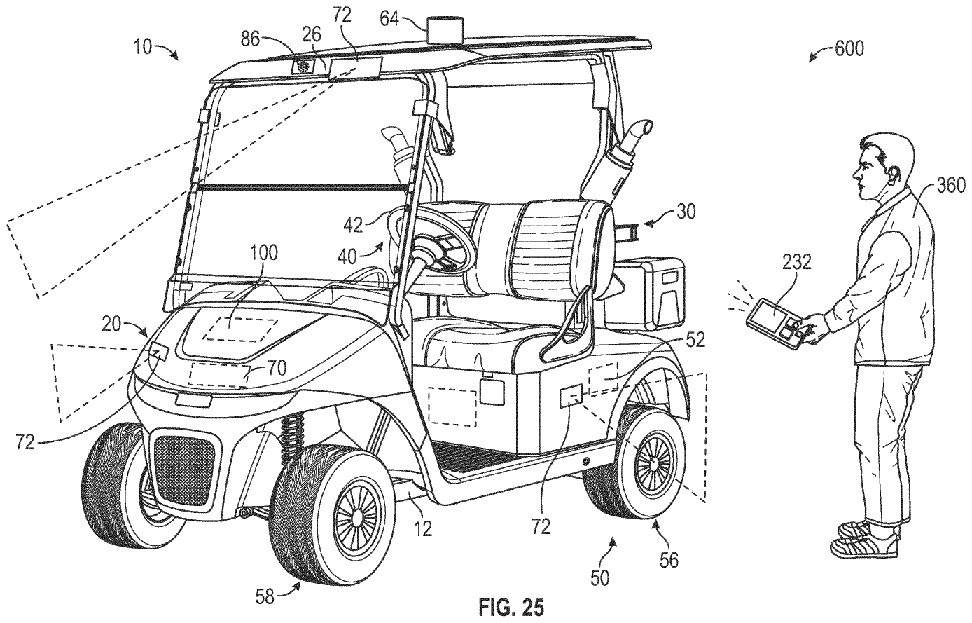

As shown in FIGS. 25-29 is the vehicle 10 includes an activation system 600. The activation system 600 is configured to activate, or cause, the vehicle 10 to operate in an autonomous mode of operation (e.g., an autonomous drive mode, etc.). For example, the vehicle 10 is configured to operate in a default manual mode of operation, and when activated by the activation system 600 (e.g., by an input provided by a user or operator, or by an input detected by the vehicle control system 100, etc.), the vehicle 10 is configured to operate in the autonomous mode of operation.

As shown in FIG. 25, the activation system 600 includes the user device 232. The vehicle 10 is communicably coupled to the user device 232. According to this embodiment, the user device 232 is configured to receive an input from the golfer 360, and after the input is received provide and activation signal to the vehicle control system 100 of the vehicle 10. The user device 232 is a remote activation system, such that the user device 232 may be positioned a distance away from the vehicle 10. In some embodiments, the user device 232 is removably coupled to the vehicle 10 such that the vehicle 10 can be either an on-board activation system or a remote activation system. For example, the user device 232 may be or include at least one of a fob, mobile controller, or a mobile device (e.g., smartphone, smartwatch, etc. ,) configured to couple to a dash of the vehicle 10 (e.g., for use while operating the vehicle 10 in the manual drive mode, for charging, etc.).

According to some embodiments, the user device 232 is a fob. The fob, as shown in FIG. 25, includes a plurality of buttons, that when engaged by the golfer 360, cause the user device 232 to provide an activation signal to the vehicle control system 100 of the vehicle 10. After the vehicle control system 100 receives the activation signal, the vehicle control system 100 is configured to control the operation of the vehicle 10 to operate in the autonomous drive mode.

In other embodiments, the user device 232, as shown in FIG. 25, is a mobile controller including a display (e.g., an LED display, a touch display, etc.). For example, the mobile controller is at least one of a tablet, or a removable display. The mobile controller is configured to receive an input, such as a touch input from the golfer 360. After, or in response to, the mobile controller receiving the touch input, the mobile controller is configured to provide the vehicle control system 100 of the vehicle 10 an activation signal. After the vehicle control system 100 receives the activation signal, the vehicle control system 100 is configured to control the operation of the vehicle 10 to operate in the autonomous drive mode. In some embodiments the mobile controller is a tablet that is communicable coupled to the vehicle control system 100 via at least one of Wi-Fi, Bluetooth, or radio.

In other embodiments, the mobile controller, as shown in FIG. 25, is a cellular device, or cellular phone communicably coupled to the vehicle control system 100 of the vehicle 10 via a cellular connection. For example, the cellular device is configured to provide the activation input via a text message to the vehicle control system 100. The cellular device is configured to receive, via a touch input or a keyboard input, a text message, and the cellular device is configured to provide the text message (e.g., as the activation signal, etc.) to the vehicle control system 100. The text message includes a string of characters, such as “Activate” or “Go,” to cause the vehicle control system 100 to operate the vehicle 10 in the autonomous drive mode. In other embodiments, the text message includes a picture image or a symbol, that when received by the vehicle control system 100, causes the vehicle control system 100 to operate the vehicle 10 in the autonomous drive mode.

In some embodiments, the cellular device, as shown in FIG. 25, is communicably coupled to the vehicle control system 100 via Wi-Fi, Bluetooth, or radio. According to this embodiment, the cellular device includes (e.g., stores, runs, etc.) an application, that is configured to receive an input from the golfer 360, and provide the input from the golfer 360 to the vehicle control system 100 (e.g., as the activation signal) to cause the vehicle 10 to operate in the autonomous drive mode. For example, the application includes an activation feature or activation button embedded in the application, that when pressed or engaged with by the golfer 360, causes the application to send the activation signal to the vehicle control system 100.

The user device 232, as shown in FIG. 25, is further configured to receive a voice input. For example, the user device 232 includes a microphone that is configured to receive a voice input form the golfer 360, and provide the voice input to the vehicle control system 100. For example, the voice input can be the word “Activate” or “Start Autonomous Mode.” In some embodiments, the user device 232 is configured to receive a first input from the golfer 360, such as engaging a fob button or providing a touch input to the mobile device, that indicates to the user device 232 that the golfer 360 is going to provide a voice input. For example, after, or in response to the first input, the user device 232 is configured to operate in a “listening mode.” The user device 232 is configured to receive a second input, being a voice input or audio input. The user device 232 is configured to provide the voice input or the audio input to the vehicle control system 100. The vehicle control system 100 is configured to operate the vehicle 10 in the autonomous drive mode based on the voice input or audio input.

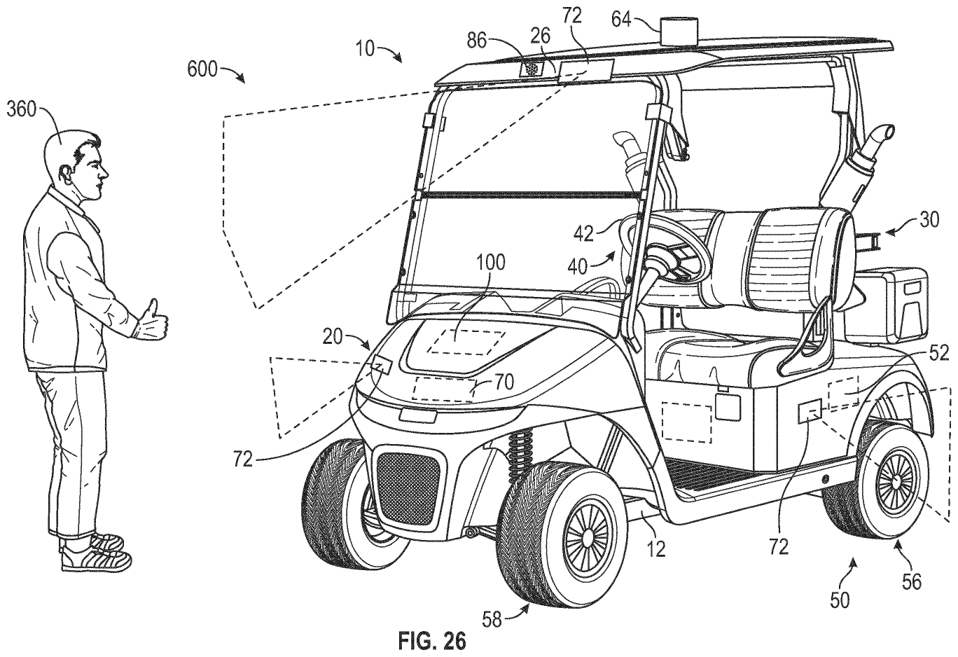

As shown in FIG. 26, the activation system 600 additionally or alternatively includes the cameras 72 positioned on the vehicle 10 (e.g., an on-board activation system). The cameras 72 are configured to detect or receive an input based on a gesture or movement made by the golfer 360. For example, the cameras 72 are configured to operate in a “standby mode” passively scanning or viewing the area around the vehicle 10. Once a movement or gesture is detected by the cameras 72, the cameras 72 are configured to provide a signal, input, or command to the vehicle control system 100 causing the vehicle control system 100 to operate the vehicle 10 in the autonomous vehicle mode.

As shown in FIG. 26, the gesture or movement may be a hand signal. The hand signal may include, but is not limited thereto, a thumbs up signal, a hand wave motion indicating to follow the golfer 360, or an arm movement in combination with a hand movement (e.g., raising an arm above the head and waving a hand, etc.). As shown in FIG. 26, the vehicle 10 includes a plurality of cameras 72 positioned on the front, side, and back of the vehicle 10. As such, the cameras 72 can detect a gesture from the golfer 360 when the golfer 360 is positioned near a front, side, or back of the vehicle 10.

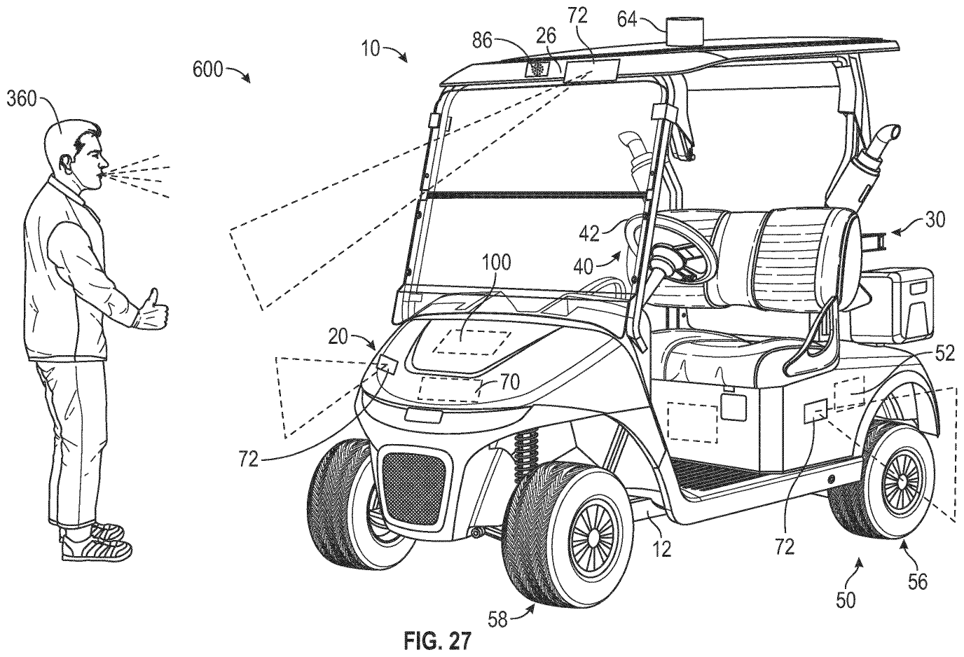

As shown in FIG. 27, the activation system 600 additionally or alternatively includes an audio receiving device, such as the microphone 86. According to this embodiment, the microphone 86 is positioned on the canopy 26 (e.g., an on-board activation system). In other embodiments, the microphone 86 is positioned on the dash of the vehicle 10, in a display of the operator controls 40, on the steering wheel 42, or otherwise suitably positioned. The microphone 86 is configured to receive or collect an audio input from the golfer 360 and provide the audio input, or a signal indicative of or associated with the audio input to the vehicle control system 100. The vehicle control system 100 is configured to control the vehicle 10 to operate in the autonomous drive mode after, or in response to, receiving the audio input or signal.

As shown in FIG. 27, in some embodiments, the activation system 600 includes a combination of the cameras 72 and the microphone 86 (e.g., an on-board activation system). For example, the cameras 72 may receive a visual input determining or detected a movement of a gesture of the golfer 360 and the microphone 86 may receive an audio input, or a voice command, simultaneously or at about the same time. The cameras 72 are configured to detect a body position of the golfer 360 (e.g., determine or detect that the user is looking at the vehicle 10 such that the golfer 360 is intending to communicate with the vehicle 10, etc.), and the microphone 86 is configured to receive, or collect/record, the voice input provided by the golfer 360. The combination of the visual input from the cameras 72 and the voice input from the microphone 86 is provided to the vehicle control system 100, and the vehicle control system 100 controls the operation of the vehicle 10 to operate in the autonomous vehicle mode. The combination of the visual input from the cameras 72 and the voice input from the microphone 86 increases the certainty of the activation system 600 that the golfer 360 is engaging with, and providing, the activation signal to microphone 86 (e.g., the activation system 600).

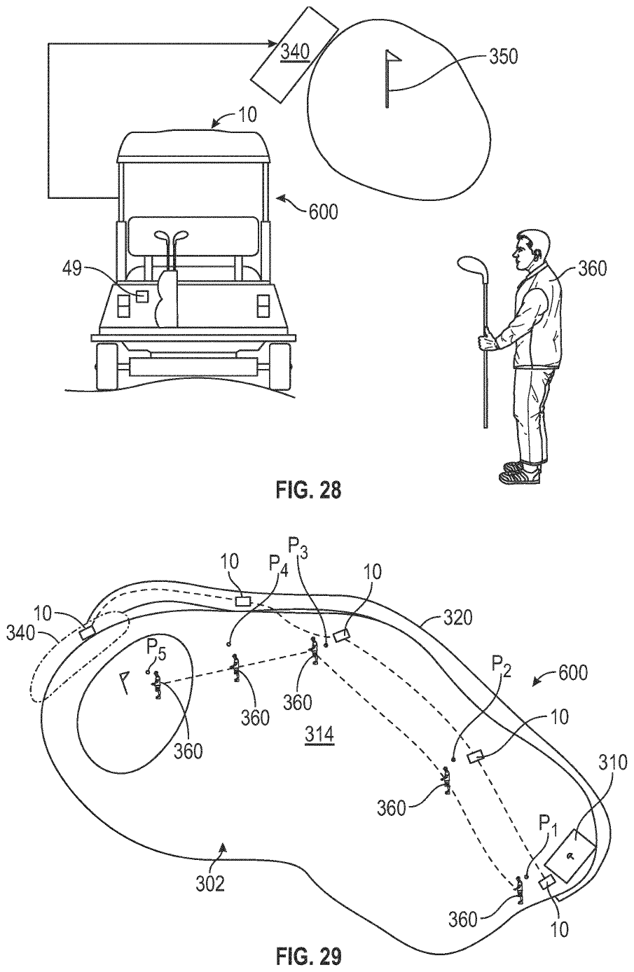

As shown in FIG. 28, the activation system 600 includes the activation button 49 on-board the vehicle 10 (e.g., an on-board activation system). As previously described, the activation button 49 is positioned at the rear of the vehicle 10, in or proximate the bagwell 30. In some embodiments, the activation button 49 is positioned on a rear side of the vehicle 10. In some embodiments, the activation button 49 is additionally or alternatively positioned within the occupant seating area 22. In some embodiments, the activation button 49 is additionally or alternatively provided as a graphical user interface (“GUI”) element via the display of the operator interface 48 (e.g., positioned on or near the dash, or positioned on a touch screen display on a rear side of the vehicle). In some embodiments, the activation button 49 is additionally or alternatively positioned along a side of the vehicle 10 (e.g., proximate where the golfer 360 exits the occupant seating area 22).

The activation button 49 is configured to, when engaged or pressed by the golfer 360, provide a command or signal to the vehicle control system 100 (e.g., via a wireless communication mode, or a wired connection, etc.). For example, the golfer 360 may grab a golf club from their bag positioned in the bagwell 30, and then engage or press the activation button 49 causing the vehicle control system 100 to operate the vehicle 10 in the autonomous drive mode. For example, after, or in response to, the golfer 360 pressing the activation button 49, the activation button 49 provides a signal or activation input/signal to the vehicle control system 100. The activation signal causes the vehicle control system 100 to operate the vehicle 10 in the autonomous vehicle mod, such that the vehicle 10 drives to the green (e.g., operates in an autonomous “Go to Green Mode”, etc.). It may be advantageous to position the activation button 49 in the bagwell 30 so that the golfer 360 is positioned behind the vehicle 10 and the vehicle control system 100 can operate the vehicle 10 to drive forward away from the golfer 360.

As shown in FIG. 29, the activation system 600 is configured to provide the activation signal to the vehicle control system 100 causing the vehicle control system 100 to operate the vehicle 10 in the autonomous drive mode. As shown in FIG. 29, the golfer 360 and the vehicle 10 are positioned at P₁ near or adjacent to the tee box 310. The golfer 360 tees off, or hits a golf ball a first time, from the tee box 310, and then returns to the vehicle 10 to manually drive or control the vehicle 10 (e.g. operate the vehicle 10 in the manual drive mode, etc.). As shown in FIG. 29, the golfer 360 drives the vehicle 10 to a second position P₂ where the ball landed or is positioned after the golfer 360 hit the golf ball the first time (e.g., where the golf ball landed after a drive from the tee box 310, etc.). At P₂, the golfer 360 exits the vehicle 10 and hits the golf ball a second time to a third position or location P₃. Similarly, at P₃ the golfer 360 exits the vehicle 10 and hits the golf ball a third time. After hitting the golf ball the third time, the golfer 360 begins walking towards a fourth position P₄ where the golf ball landed after being hit the third time. The activation system 600 of the vehicle 10 is configured to receive an input from the golfer 360, and in response to, or after receiving the input, provide the activation signal to the vehicle control system 100. As shown in FIG. 29, the input received at P₃ is a visual input receiving by, for example, the cameras 72. For example, the golfer 360 walking away from the vehicle 10 is detected or sensed by the cameras 72 (e.g., the activation system 600), and the cameras 72 provide the activation signal to the vehicle control system 100 causing the vehicle 10 to operate in the autonomous drive mode.

According to this embodiment, the vehicle control system 100 is configured to receive the activation signal from the activation system 600, and operate the vehicle 10 in the autonomous drive mode based each of the activation signal (e.g., receiving the activation signal, based on the input associated with the activation signal, etc.) and the location of the user and the vehicle 10 with respect to the green or the pin 350. For example, the cameras 72 are configured to track or detect the movement of the golfer 360 (or the sensor system 70 includes motion sensors configured to detect and/or track the movement of the golfer 360) and provide a signal or input to the vehicle control system 100 to control the steering (e.g., via the steering system 66) and the speed of the driveline 50 such that the vehicle 10 drives either alongside, or adjacent to, the golfer 360 or drive to the green 312 (e.g., the green staging location 340 adjacent to the green 312, etc.). Further, the vehicle control system 100 is configured to determine a location of the golfer 360 and the vehicle 10 with respect to the green 312 or the pin 350 via at least one of visual inputs provided by the cameras 72, GPS location, or signals provided or received by a sensor positioned on the pin 350, and control the operation of the vehicle 10 based on each of the activation signal and the location with respect to the green 312 and/or the pin 350. For example, the activation system 600 is configured to receive an input (e.g., a gesture, a hand signal, etc.) from the golfer 360, and in response to receiving the input, provide the activation signal to the vehicle control system 100. Based on a location of the golfer 360 and the vehicle 10 relative to the green 312, the activation signal causes the vehicle 10 to operate in the autonomous drive mode causing the driveline 50 and the steering system 66 to drive the vehicle 10 away from the golfer 360 to the green staging location 340. For example, at P₄ the activation system 600 determines that the golfer 360 is moving towards the green 312 is within a threshold distance of the green 312, and provides the activation signal to the vehicle control system 100 causing the vehicle 10 to drive away from the golfer 360 to the green staging location 340. After, or in response to, determining that the golfer 360 is within the threshold distance of the green 312 and/or the pin 350, the vehicle control system 100 is configured to control the operation of the vehicle 10 to drive the vehicle 10 to the cart path 320 and to the green staging location 340 to wait for the user to finish playing the golf hole (e.g., to finish putting on the green 312). As shown in FIG. 29, the golfer 360 moves from the fourth position P₄ to a fifth position P₅ on the green 312 while the vehicle 10 drives along the cart path 320 to the green staging location 340 and waits for the golfer 360 at the green staging location 340.

In other embodiments, the activation system 600 is at least one of the activation button 49, the user device 232 (e.g., fob, mobile device, etc.), the cameras 72, or the microphone 86. The input (e.g., at P₃, at P₄, at a position between P₃ and P₄, etc.) provided by the golfer 360, is at least one of pressing a button, engaging with a fob or mobile device, or providing a gesture or voice command. After receiving the input, the activation system 600 is configured to provide the activation signal to the vehicle control system 100 causing the vehicle 10 to operate in the autonomous drive mode. For example, the activation signal causes the vehicle control system 100 to drive the vehicle 10 to the green staging location 340.

### Come Back Feature

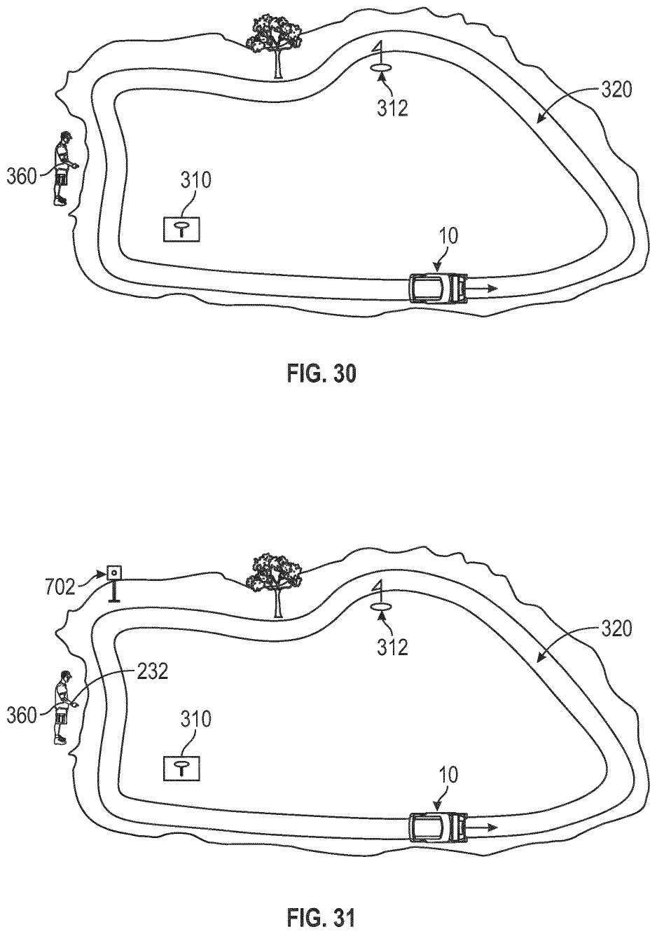

As shown in FIGS. 30-32, an environment for operating the vehicle 10 is depicted. The fleet monitoring and control system 200 (e.g., the vehicle control system 100, the remote systems 240) is configured to receive a command to navigate back (e.g., a come back command) to a golfer 360 and then proceed to the user location. The come back command can be referred to as a summon command. The fleet monitoring and control system 200 is configured to receive the summon command through various input mechanisms, such as an audible command detected by the microphone 86 onboard the vehicle 10 or a microphone on a user device (e.g., user device 232 and/user sensor 220), an automatic signal generated by a predefined system or schedule, a manual input by pressing a physical button on the vehicle 10 or a remote device, or an electronic signal transmitted via a mobile application or remote controller.

In some embodiments, the vehicle 10 is configured to operate (e.g., operate exclusively) on the cart path 320 to comply with golf course rules. The cart path 320 is configured to include segments that loop around features such as obstacles or trees to ensure unobstructed navigation. The vehicle control system 100 is configured to utilize sensor data from onboard systems to detect and follow the cart path 320. For example, the vehicle 10 may navigate between the tee box 310 and the green 312 autonomously. In response to receiving the summon command, the fleet monitoring and control system 200 may determine the location of the golfer 360 and calculates an optimal route along the cart path 320 to navigate back to a user location.

In some embodiments, the sensor system 70 is configured to detect boundaries of the cart path 320 and generate a signal to the vehicle control system 100 to maintain the vehicle 10 on the cart path 320. The sensor system 70 is configured to survey an area around the vehicle 10. The sensor system 70 is configured to identify visual markers, physical edges, or digital geofencing data corresponding to the cart path 320, as described in greater detail herein. The vehicle control system 100 is configured to process the detected boundary data and adjust the trajectory of the vehicle 10 to prevent deviation from the cart path 320. In some embodiments, when the sensor system 70 detects an approaching boundary, the vehicle control system 100 is configured to initiate corrective actions, such as steering adjustments, braking, or speed modifications, to ensure the vehicle 10 remains within a permitted area. The sensor system 70 may continuously monitor the path boundaries in real-time, allowing the vehicle 10 to navigate safely while adhering to golf course regulations.

In some embodiments, the fleet monitoring and control system 200 is configured to dynamically update the optimal route based on real-time data from the sensor system 70. The real-time data can include detected obstacles, such as other golf carts, pedestrians, or fallen branches, which may temporarily block a portion of the cart path 320. If an obstacle is detected, fleet monitoring and control system 200 can adjust the route by selecting an alternative path to navigate around the obstruction while remaining within permitted cart paths 320. Additionally, the vehicle control system 100 can detect changes in terrain conditions, such as wet or uneven surfaces, and reroute to a more stable route. In some cases, the fleet monitoring and control system 200 adjusts the optimal route based on user movement. For example, if the golfer 360 begins walking toward a different location after issuing a summon command, the fleet monitoring and control system 200 may recalculate the route in real time to ensure that the vehicle 10 arrives at the updated position of the golfer 360 efficiently.

The vehicle 10 is configured to receive audible signals as a summon command through the sensor system 70 and/or the microphone 86. The microphone 86 is configured to detect sound signals, including voice commands, issued by a user. Upon detecting an audible signal, the microphone 86 transmits the detected audio data to the vehicle control system 100. The vehicle control system 100 is configured to process the audio data using audio signal processing algorithms to recognize specific keywords or phrases that correspond to the summon command. For example, the vehicle control system 100 may utilize natural language processing techniques to identify commands such as “come back” or “return to me.”

In some embodiments, the vehicle control system 100 is configured to receive the summon command via a microphone integrated into the user device 232 (e.g., a smartphone, a smartwatch, etc.). When a user device microphone is used, the user device 232 is configured to transmit audio data to the fleet monitoring and control system 200 via a wireless communication protocol, such as Bluetooth, Wi-Fi, or cellular network (e.g., directly to the vehicle control system 100, to the remote systems 240). The fleet monitoring and control system 200 (e.g., the vehicle control system 100, the remote systems 240) is configured to analyze the audio data to identify the summon command. The user device 232 is configured to transmit location data to or the fleet monitoring and control system 200 is configured to track the location of the user device 232.

In some embodiments, the vehicle control system 100 is configured to use directional audio analysis to estimate a relative direction of the golfer 360 based on the detected sound signal. The directional audio analysis is configured to enable the vehicle control system 100 to determine the location of the golfer 360. In some embodiments, the vehicle control system 100 is configured to cross-reference the audio data with additional data, such as location data from the user device 232 or global positioning system (GPS) data, to verify the user location. In some embodiments, the vehicle control system 100 is configured to determine the location of the user by performing wireless signal triangulation between the vehicle 10 and the user device 232, using signal strength and transmission time data from multiple communication points to calculate the user's precise position.

In some embodiments, the fleet monitoring and control system 200 is configured to receive the summon command via a remote controller. The remote controller can include a key fob configured to wirelessly transmit the summon command directly to the vehicle control system 100 via short-range communication protocols such as radio frequency (“RF”) signals. The remote controller can include a user device, such as a smartphone or tablet, through which the summon command can be transmitted to the vehicle control system 100 via wireless communication technologies like Bluetooth or Wi-Fi. In some embodiments, the remote controller can also include fixed buttons 702 positioned at locations along the golf course 300, such as near tee boxes or greens, allowing a golfer 360 to summon the vehicle 10 by pressing the fixed button 702 (and providing an identifier associated with the golfer 360 or the vehicle 10). The fixed button 702 can be securely mounted on a post, wall, or other structures, and can be configured to wirelessly communicate with the fleet monitoring and control system 200. The remote controller can transmit location data to the fleet monitoring and control system 200. The fleet monitoring and control system 200 is configured to determine the location of the user by utilizing GPS data of the remote controller at the time the summon command is transmitted.

In some embodiments, the vehicle control system 100 is configured to receive a summon command based on calling gestures such as hand gestures performed by the golfer 360 or movements of a wearable device (e.g., user device 232 and/or user sensors 220). The sensor system 70 of the vehicle 10 is configured to detect and recognize predefined hand gestures made by the golfer 360. For example, the golfer 360 may wave their hand or perform a gesture, such as raising and lowering their arm in a predefined motion. The camera 72 may captures visual data, which is analyzed by the vehicle control system 100 using image processing and gesture recognition algorithms to identify the summon command. In some embodiments, the summon command can also be transmitted through the movement of the user device 232, equipped with motion sensors. The user device 232 is configured to detect predefined motion patterns, such as shaking the wrist or performing a circular motion. The detected motion is transmitted to the fleet monitoring and control system 200 via wireless communication protocols, such as Bluetooth, Wi-Fi, cellular, etc.

In an exemplary embodiment, the summon command can be configured to instruct the vehicle 10 to return to a previously occupied location instead of navigating directly to the golfer 360. For example, the summon command can be configured to instruct vehicle 10 to return to the location where it was parked prior to its most recent departure, such as a tee box 310 or a parking zone along the cart path 320. The vehicle control system 100 is configured to retrieve and reference stored location data representing the prior position of the vehicle 10.

The vehicle control system 100 is configured to control the prime mover 52 and the steering system 66 to perform various maneuvers, to allow the vehicle 10 to navigate to the user location. A reversing maneuver is configured to enable the vehicle 10 to reverse along a path to reach the location of the user. The vehicle control system 100 may be configured to generate an audible noise during the reversing maneuver, which may serve as an alert for nearby individuals or other vehicles. The audible noise can be emitted by an onboard speaker or external sound system integrated into the vehicle 10, ensuring that the reversing action is indicated to anyone in the vicinity. The vehicle control system 100 is configured to perform a forward driving maneuver. The forward driving maneuver may include driving forward and executing at least one turnaround before proceeding to the user location. The turnaround is performed in a predetermined area, such as a designated section of the golf course 300 with sufficient space to ensure execution of the turnaround. The predetermined areas are mapped and stored within the fleeting monitoring and control system 200, allowing the vehicle 10 to identify the predetermined area. The vehicle control system 100 is configured to determine the availability of predetermined areas to perform at least one turnaround. The predetermined areas are mapped locations along the cart path 320 where the vehicle 10 can execute a turnaround maneuver without obstructing other vehicles or violating course guidelines. The vehicle control system 100 is configured to use real-time data from the sensor system 70, including cameras, LiDAR, or radar, to assess whether the predetermined area is clear of obstacles, such as other vehicles, stationary objects, or individuals.

The vehicle control system 100 may use a combination of sensor data, including GPS, LiDAR, and camera inputs, to create detailed maps of the golf course 300. In some embodiments, the vehicle control system 100 is configured with preloaded digital maps of the golf course 300, including the cart paths 320 on which the vehicle 10 is permitted to operate. The vehicle control system 100 is configured to identify multiple routes from a current position of the vehicle 10 to the location of the golfer 360.

In some embodiments, the fleet monitoring and control system 200 is configured to apply route-planning algorithms (e.g., A* search algorithm) to identify multiple routes from a current position of the vehicle 10 to the user location. The fleet monitoring and control system 200 may include preloaded digital maps of the golf course, which define the cart paths 320 and restricted areas where the vehicle 10 is permitted to operate or not operate in. Using preloaded digital maps, the fleet monitoring and control system 200 constructs a representation of the golf course 300, such as a graph or grid structure, where nodes represent possible positions and edges represent connections between those positions. The fleet monitoring and control system 200 is configured to include real-time sensor data (e.g., to detect obstacles) to identify multiple routes. The fleet monitoring and control system 200 is configured to dynamically adjust identified routes by redrawing trajectories to avoid obstacles.

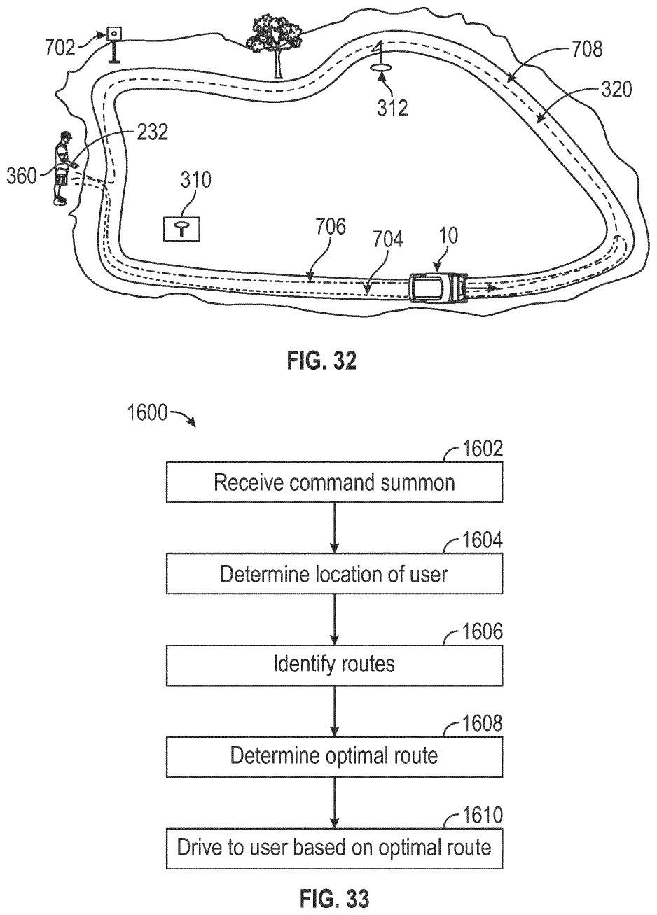

As shown in FIG. 32, the fleet monitoring and control system 200 is configured to identify multiple routes (e.g., multiple paths) along the cart path 320 for the vehicle 10 to reach the user location, each involving different maneuvering strategies. A first route 704 may include a reversing maneuver where the vehicle 10 travels in reverse, along the cart path 320, from the current location of the vehicle 10 to the user location. A second route 706 may include a forward motion and a turnaround maneuver. The second route 706 may include driving forward from the current location of the vehicle 10 to a predetermined area where a turnaround can be executed, and then proceeding forward to the user location. The fleet monitoring and control system 200 may be configured with a mapping and/or identify route that may include one or more predetermined areas where the vehicle 10 can perform a turnaround maneuver. A third route 708 may include maintaining forward motion, along the cart path 320, around the portions of the golf course 300 that permit the vehicle 10 to return to the user location without reversing or turning around.

In some embodiments, the fleet monitoring and control system 200 (e.g., the remote systems 240, the vehicle control system 100, etc.)is configured to determine an optimal route from multiple identified routes (e.g., the first route 704, the second route 706, the third route 708) using a cost function. The fleet monitoring and control system 200 is configured to determine an optimal route using a cost function that can be a function of travel time and/or the type of maneuver (e.g., reversing maneuver, forward driving maneuver, turnaround maneuver, etc.). The fleet monitoring and control system 200 is configured to assign different weights or values to the types of maneuvers to calculate an overall cost for each route. Reversing maneuvers may be assigned a higher cost due to their increased complexity (e.g., noise, low speed, etc.). Forward driving maneuvers, which are simpler and more predictable, may be assigned a lower cost. Travel time for each route is factored into the cost function, with shorter travel times contributing to a lower cost. For example, the second route 706, which includes a turnaround maneuver in a predetermined area and a moderate travel time, may be considered the optimal route due to its balance between efficiency and simplicity. The first route 704, which involves a reversing maneuver with a slightly shorter travel time, may be assigned a higher cost due to the complexity associated with reversing (e.g., the vehicle control system 100 is configured to generate an audible noise during the reversing maneuver, may move at a slower speed, etc.). The third route 708, which involves a forward motion along the cart path 320 with no reversing or turnarounds but has the longest travel distance, may be assigned the higher cost due to its inefficiency. The optimal route is the route with the lowest cost.

In an exemplary embodiment, the cost function is configured to consider the distance to a nearest predetermined area when selecting between a reversing maneuver and a forward driving maneuver. If a forward driving maneuver requires traveling a significant distance to reach a predetermined area for a turnaround, the cost function may assign a higher cost to that route, making a reversing maneuver more favorable if it leads to a shorter travel distance. When a predetermined turnaround area is nearby, the cost function may prioritize a forward driving maneuver.

When the optimal route is determined based on the cost function, the fleet monitoring and control system 200 is configured to command the vehicle 10 to traverse the optimal route. The vehicle 10 is configured to execute the necessary maneuvers, whether reversing, driving forward, or performing a turnaround in a predetermined area, to navigate along the optimal route. By following the optimal route, the vehicle 10 ensures efficient travel to the user location while adhering to course rules and minimizing unnecessary complexity or travel time.

As shown in FIG. 33, a method 1600 for navigating the vehicle 10 to a user location in response to a summon command is depicted. In some embodiments, the method 1600 is performed by the vehicle control system 100 and/or the remote systems 240. The method 1600 may be performed to determine and execute an optimal route to the user location based on parameters (e.g., predefined parameters) and real-time data, as described with reference to FIGS. 30-32.

At step 1602, one or more processing circuits receive a summon command. The summon command may be transmitted through various mechanisms, such as an audible command, a button interface on a user device, a signal from a remote controller, and/or hand gestures. Upon receiving the summon command, the one or more processing circuits proceed to step 1604, and determine the user location. The user location can be based on GPS data from the user device, wireless signal triangulation, position of stationary button, or an analysis of other sensor inputs.

At step 1606, the one or more processing circuits identify multiple routes from a current position of the vehicle 10 to the user location. The multiple routes may include various maneuvering strategies, such as reversing, forward driving, or performing a turnaround in a predetermined area, as previously described. At step 1608, the one or more processing circuits determine the optimal route from the identified routes. The determination of the optimal route may include a cost function that can consider factors such as travel time, distance, and the complexity of the required maneuvers.

At step 1610, the one or more processing circuits command the vehicle 10 to drive to the user location based on the optimal route. The vehicle 10 is configured to execute the required maneuvers, adhere to golf course regulations (e.g., remaining on cart paths), and generate an audible noise during reversing maneuvers. Passing

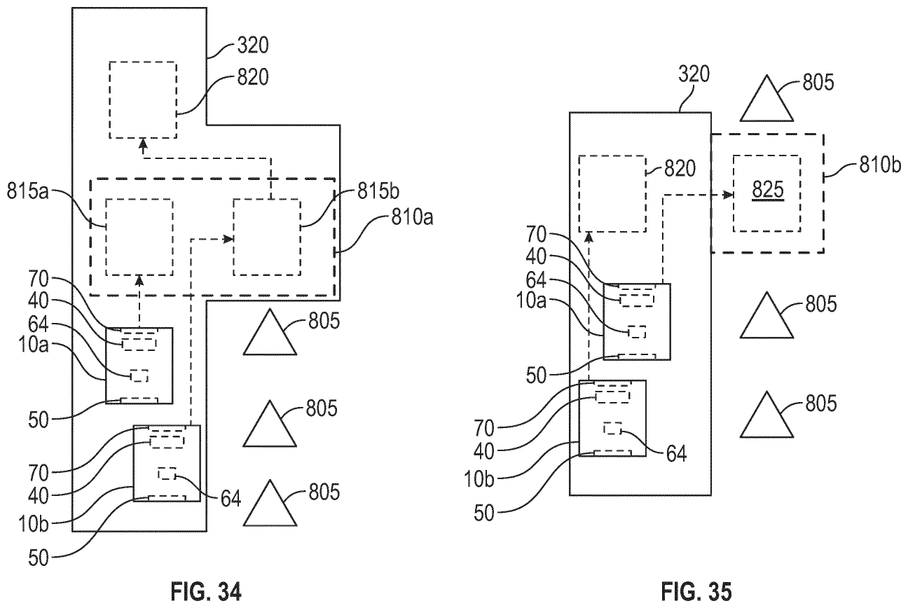

According to the exemplary embodiment shown in FIG. 34, the vehicles 10 travel along the cart path 320 towards a destination. The cart path 320 may be any surface that the vehicles 10 can travel on towards destinations. By way of example, the cart path 320 may be a paved road. By way of another example, the cart path 320 may be a gravel path. By way of yet another example, the cart path 320 may be a grass path that is mowed to facilitate vehicle traffic. The width of the cart path 320 may vary in different sections (e.g., parts, lengths) of the cart path 320. In narrow sections of the cart path 320, the cart path 320 may be wide enough to facilitate (e.g., hold, contain) a single vehicle 10. By way of example, if a vehicle 10a and a vehicle 10b are adjacent (e.g., next) to each other on a narrow section of the cart path 320, at least one of the vehicle 10a and the vehicle 10b may not be entirely on the surface of the cart path 320. In wide sections of the cart path 320, the cart path 320 may be wide enough to facilitate (e.g., hold, contain) multiple vehicles 10. By way of example, if the vehicle 10a and the vehicle 10b are adjacent (e.g., next) to each other on a wide section of the cart path 320, both the vehicle 10a and the vehicle 10b may be entirely positioned on the surface of the cart path 320.

The width of the cart path 320 may be based on one or more obstacles 805 disposed on the golf course 300. By way of example, a building adjacent to the cart path 320 may cause the width of the cart path 320 to become narrower. By way of another example, a natural feature, such as trees, rocks, water, or other features of the golf course 300 may impact the width of the cart path 320 at certain sections. By way of yet another example, moveable obstacles 805, such as other vehicles 10 (e.g., stationary vehicles 10, oncoming vehicles 10, etc.), people, animals, or other non-fixed obstacles 805 may impact the width of the cart path 320.

In wide sections of the cart path 320 that can facilitate multiple vehicles 10, there may be an on-path passing zone 810a where the vehicles 10 can pass other vehicles 10. By way of example, the vehicle 10b may pass the vehicle 10a in the on-path passing zone 810a. In some embodiments, the on-path passing zone 810a is a predetermined section of the cart path 320. By way of example, the vehicle 10a and the vehicle 10b may store an indicator (e.g., GPS coordinates, other location indicator) of the on-path passing zone 810a. In some embodiments, the on-path passing zone 810a is determined (e.g., detected) in real-time by the vehicles 10 (e.g., via the sensor system 70). By way of example, the vehicle 10a and/or the vehicle 10b can determine (e.g., via cameras, sensors, etc.) that the cart path 320 is wide enough for passing at a location, and identify the location as an on-path passing zone 810a.

The vehicle 10b may initiate a passing operation by transmitting a request for passing to the vehicle 10a. The vehicle 10a may accept the request and indicate to the vehicle 10b that the request has been accepted. In some embodiments, if the vehicle 10a does not accept the request, the vehicle 10a and the vehicle 10b maintain operation (e.g., continue along cart path 320) without passing. If the vehicle 10a accepts the request, once the vehicle 10a reaches (e.g., enters) the on-path passing zone 810a, the vehicle 10a may reduce its speed (e.g., slows, stops) in a first section 815a of the on-path passing zone 810a, and the vehicle 10b may enter at a second section 815b of the on-path passing zone 810a. In some embodiments, the vehicle 10b reduces its speed (e.g., slows) when entering the on-path passing zone 810a. In some embodiments, the first section 815a and the second section 815b are adjacent to each other. The distance between the first section 815a and the second section 815b of the on-path passing zone 810a may be at a distance that ensures that the vehicle 10a and the vehicle 10b do not physically interact (e.g., touch, collide). Once the vehicle 10a and the vehicle 10b enter the on-path passing zone 810a, the vehicle 10b may move to a leading location 820 that is located ahead of (e.g., in front of) the vehicle 10a. After the vehicle 10b moves ahead of the vehicle 10a to the leading location 820, the vehicle 10a and the vehicle 10b may resume normal operation (e.g., movement) along the cart path 320 toward their respective destinations.

According to the exemplary embodiment shown in FIG. 35, in narrow sections of the cart path 320 that only facilitate a single vehicle 10, there is an off-path passing zone 810b where vehicles 10 can pass (e.g., move ahead of) other vehicles 10. The off-path passing zone 810b may be a location off of (e.g., adjacent to) the cart path 320 where a vehicle 10 can safely exit the cart path 320 without causing damage to the vehicle 10, the environment external of the cart path 320, and/or the obstacles 805. By way of example, the vehicle 10b may pass the vehicle 10a after the vehicle 10a moves into (e.g., enters) the off-path passing zone 810b. In some embodiments, the off-path passing zone 810b is a predetermined section adjacent to the cart path 320. By way of example, the vehicle 10a and the vehicle 10b can store an indicator (e.g., GPS coordinates, other location indicator) of the off-path passing zone 810b. In some embodiments, the off-path passing zone 810b is determined (e.g., detected) in real-time by the vehicles 10. By way of example, the vehicle 10a can determine (e.g., via cameras, sensors, etc.) that the vehicle 10a can safely exit the cart path 320 at a location adjacent to the cart path 320, and identify the location as an off-path passing zone 810b.

The vehicle 10b may initiate a passing operation by transmitting a request for passing to the vehicle 10a. The vehicle 10a may accept the request and indicate to the vehicle 10b that the request has been accepted. In some embodiments, if the vehicle 10a does not accept the request, the vehicle 10a and the vehicle 10b maintain operation (e.g., continue movement on the cart path 320) without passing. Once the vehicle 10a reaches (e.g., enters) the off-path passing zone 810b, the vehicle 10a may reduce its speed (e.g., slow, stop) in an off-path location 825, allowing the vehicle 10b to move ahead of the vehicle 10a at the leading location 820 (e.g., by operating prime mover 52 and the steering system 66). In some embodiments, the vehicle 10b reduces its speed (e.g., slows) when passing the vehicle 10a. In some embodiments, the off-path location 825 and the leading location 820 are approximately adjacent. The distance between the off-path location 825 and the leading location 820 may be at a distance that ensures that the vehicle 10a and the vehicle 10b do not physically interact (e.g., touch, collide). After the vehicle 10b moves ahead of the vehicle 10a to the leading location 820, the vehicle 10a and the vehicle 10b may resume normal operation (e.g., movement) on the cart path 320 toward their respective destinations. By way of example, the vehicle 10b may adjust its speed (e.g., increase speed) and continue moving along the cart path 320. By way of another example, the vehicle 10a may re-enter the cart path 320 and continue moving along the cart path 320 behind the vehicle 10b.

As shown in FIGS. 2, 34, and 35, the vehicle 10a and the vehicle 10b may be communicatively coupled to facilitate passing operations on the cart path 320. In some embodiments, the vehicle 10a is autonomous (e.g., in an autonomous driving mode) and the vehicle 10b is manual (e.g., in a manual driving mode). In some embodiments, the vehicle 10a is manual and the vehicle 10b is autonomous. In some embodiments, the vehicle 10a is autonomous and the vehicle 10b is autonomous. Regardless of whether the vehicle 10a and the vehicle 10b are autonomous or manual, the vehicle 10a and the vehicle 10b may have the same components and/or be able to perform the same operations. By way of example, both an autonomous vehicle 10 and a manual vehicle 10 may have some/all components of the fleet monitoring and control system 200, such as the sensor system 70, the operator controls 40, the beacon 64, and/or the driveline 50, among other features.

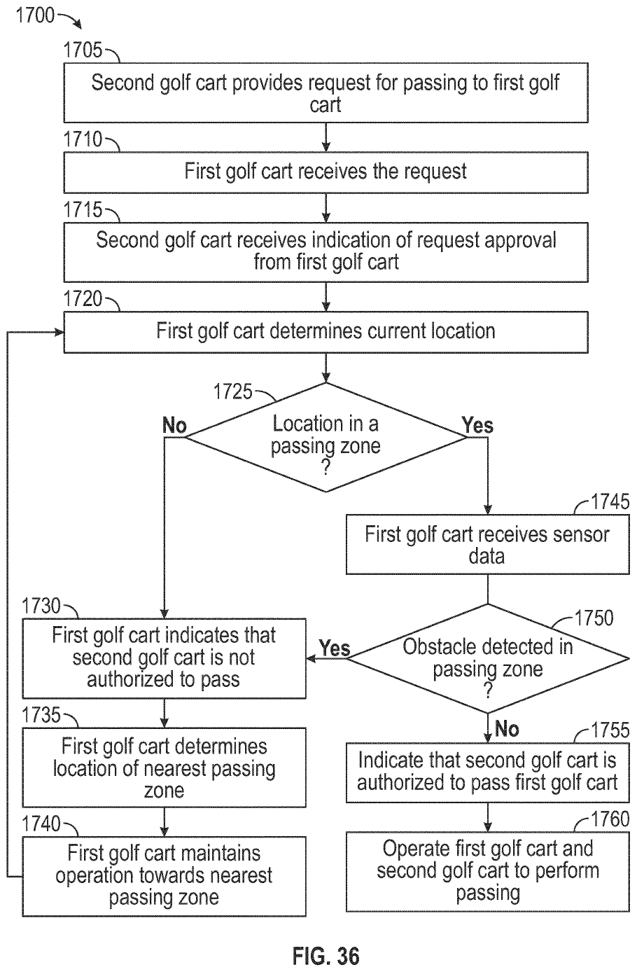

FIG. 36 shows a method 1700 for performing a passing operation for the vehicle 10a and the vehicle 10b. The method 1700 may be performed by one or more processing circuits of the vehicle control system 100 of the vehicle 10a, the vehicle control system 100 of the vehicle 10b, and/or the remote systems 240. At step 1705, the vehicle 10b provides (e.g., sends, transmits, indicates, etc.) a request for passing to the vehicle 10a. The request may vary based on whether the vehicle 10a and the vehicle 10b are autonomous (e.g., in the autonomous driving mode) or manual (e.g., in the manual driving mode). In some embodiments, the vehicle 10b determines the driving mode of the vehicle 10a prior to providing the request to the vehicle 10a. By way of example, the vehicle 10b may determine the driving mode of the vehicle 10a based on a light color, light pattern, or other indicator of the beacon 64 of the vehicle 10a.

In some embodiments, the vehicle 10a is autonomous and the vehicle 10b is manual. The request may be provided from the vehicle 10b to the vehicle 10a responsive an operator (e.g., golfer 360) of the vehicle 10b interacting with the operator interface 48. By way of example, the operator (e.g., golfer 360) of the vehicle 10b may interact with a switch, button, screen, or other element of the operator interface 48, and in response the request may be transmitted to the vehicle 10a. By way of another example, the operator of the vehicle 10b can enable the beacon 64 to indicate the request (e.g., via sound, light pattern, light color, etc), and the vehicle 10a can detect the beacon 64 (e.g., via sensors, cameras, etc.) The request may be provided from the vehicle 10b to the vehicle 10a responsive to the vehicle 10b being within a threshold distance of the vehicle 10a for a predetermined time period. By way of example, the threshold distance may be a distance between the vehicle 10a and the vehicle 10b such that the vehicle 10a can detect the presence of the vehicle 10b (e.g., via sensors, cameras, etc.). By way of another example, the predetermined time period may be any period of time long enough to indicate that the vehicle 10b desires (e.g., intends) to pass the vehicle 10a, and that the vehicle 10b did not mistakenly (e.g., accidentally, inadvertently, unintentionally) enter the threshold distance.

In some embodiments, the vehicle 10a is manual and the vehicle 10b is autonomous. The request may be provided from the vehicle 10b to the vehicle 10a responsive to the vehicle 10b transmitting a message for display on the operator interface 48 of the vehicle 10a. By way of example, the message may be human readable media indicating that the vehicle 10b is requesting to pass. By way of another example, the message may be an indicator light displayed on the operator interface 48. The request may be provided from the vehicle 10b to the vehicle 10a responsive to the vehicle 10b providing an indicator that the operator of the vehicle 10a can detect (e.g., visually, using sensors, etc.). By way of example, the request may be indicated by the beacon 64 of the vehicle 10b flashing a light pattern and/or showing a specific color at the headlights of the beacon 64.

In some embodiments, the vehicle 10a is autonomous and the vehicle 10b is autonomous. The request may be provided from the vehicle 10b to the vehicle 10a responsive to the vehicle 10b transmitting a radio frequency (“RF”) communication (e.g., signal) to the vehicle 10a. By way of example, the vehicle 10a can process the RF communication and determine that the vehicle 10b is requesting to pass. The request may be provided from the vehicle 10b to the vehicle 10a responsive to the vehicle 10b engaging the beacon 64 to display a specific light color, light pattern, and/or sound. By way of example, the vehicle 10a may detect the light color and/or pattern using a rear-facing camera 72 disposed on a rear (e.g., tail) surface of the vehicle 10a. The request may be provided from the vehicle 10b to the vehicle 10a responsive to the vehicle 10b reducing a distance between the vehicle 10a and the vehicle 10b by a predetermined amount over a period of time. By way of example, the vehicle 10a may detect a diminishing (e.g., shrinking) distance from the vehicle 10b and determine that the vehicle 10b is moving at a faster speed than the vehicle 10a, and that the vehicle 10a should allow the vehicle 10b to pass to avoid physical interaction (e.g., collision).

At step 1710, the vehicle 10a receives the request from the vehicle 10b. The vehicle 10a can decide whether to approve (e.g., accept) the request or deny (e.g., reject, ignore) the request. As described herein, approving the request may indicate that the vehicle 10a allows the vehicle 10b to pass, at a present time or at a future time. It should be understood that approval of the request does not in any way limit a time and/or location where passing takes place. If the vehicle 10a does not approve the request, the vehicle 10a and the vehicle 10b may continue moving along the cart path towards their respective destinations, without any passing taking place. By way of example, the vehicle 10b may follow the vehicle 10a along the cart path 320 until the vehicle 10a reaches its destination, and/or the operator of the vehicle 10a moves a predetermined distance away from the vehicle 10a. In some embodiments, if the vehicle 10a does not approve the request, the vehicle 10a places a limit on the speed of the vehicle 10b, such that the vehicle 10b does not perform any unauthorized passing operations, and/or reduce a distance between the vehicle 10a and the vehicle 10b beyond a threshold distance. By way of example, the vehicle 10a may limit the speed of the vehicle 10b to be the same speed as the vehicle 10a.

At step 1715, the vehicle 10b may receive an indication of request approval from the vehicle 10a. The procedure for the vehicle 10b receiving the indication of request approval may vary based on whether the vehicle 10b is autonomous or manual. In some embodiments, if the vehicle 10b is manual, the indication is a message displayed on the operator interface 48 of the vehicle 10b. By way of example, the message may indicate that the request has been approved, and that the vehicle 10b should maintain operation until a passing indicator is displayed. By way of another example, the message may be an indicator light of the operator interface 48. In some embodiments, the indication is a light color, light pattern, and/or sound of the beacon 64 of the vehicle 10a. By way of example, if the vehicle 10b is manual, the operator (e.g., golfer 360) of the vehicle 10b may be able to see (e.g., view) the beacon 64 and determine that the request has been approved. By way of another example, if the vehicle 10b is autonomous, the vehicle 10b may detect the light color, light pattern, and/or sound of the beacon 64 using sensors and/or cameras 72 of the sensor system 70.

At step 1720, the vehicle 10a may determine a current location of the vehicle 10a. In some embodiments, the vehicle 10a determines its location by receiving GPS data (e.g., coordinates) at the antennas 78 (e.g., from the remote systems 240). In some embodiments, the vehicle 10a stores (e.g., in memory 104 of vehicle control system 100) other otherwise be able to retrieve a map of the cart path 320 (e.g., from remote systems 240). The vehicle 10a may reference the GPS data to the map to determine a location on the cart path 320 that the vehicle 10a is located. By way of example, the map may include GPS coordinates, and the vehicle 10a may search the map for the received GPS coordinates. In some embodiments, the map includes GPS coordinates for on-path passing zones 810a, off-path passing zones 810b, obstacles 805, and/or predetermined zones where passing is prohibited.

At step 1725, the vehicle 10a may determine whether it is located in a passing zone. The passing zone may correspond to a location of the cart path 320 where either the vehicle 10b can move around a side of the vehicle 10a while being contained on a surface of the cart path 320, or the prime mover 52 and steering system 66 of the vehicle 10a can move the vehicle 10a from the path while the vehicle 10b moves in front of the vehicle 10a on the cart path 320. By way of example, the passing zone may be an on-path passing zone 810a and/or an off-path passing zone 810b. In some embodiments, the vehicle 10a compares its location (e.g., GPS coordinates) to locations of known passing zones. By way of example, the vehicle 10a may search the map for the GPS coordinates and determine whether the GPS coordinates are in an on-path passing zone 810a, or are within a threshold distance of an off-path passing zone 810b. In some embodiments, the vehicle 10a receives sensor data acquired by the various sensors of the sensor system 70 (e.g., cameras 72, LiDAR sensors 74, radar sensors 76, etc.) and actively determine whether the vehicle 10a is located in a passing zone. By way of example, the vehicle 10a may receive sensor data associated with an area surrounding to the cart path 320, and determine whether the vehicle 10a can safely exit the cart path 320.

At step 1730, if the vehicle 10a is not located in a passing zone, the vehicle 10a may indicate to the vehicle 10b that the vehicle 10b is not authorized to pass the vehicle 10a at that time. The indication that the vehicle 10b is not authorized to pass may vary based on whether the vehicle 10b is autonomous or manual. By way of example, if the vehicle 10b is autonomous, the indication may be an RF transmission from the vehicle 10a to the vehicle 10b indicating that the vehicle 10b is not authorized to pass. By way of another example, if the vehicle 10b is manual, the indication may be transmitting a message for display on the operator interface of the vehicle 10b. By way of another example, the indication may be a light color, light pattern, and/or sound from the beacon 64 of the vehicle 10a, that can be seen by the operator (e.g., golfer 360) of the vehicle 10b and/or be detected by the sensor system 70 of the vehicle 10b.

At step 1735, the vehicle 10a may determine the location of the nearing passing zone (e.g., on-path passing zone 810a, off-path passing zone 810b) in the direction of the destination of the vehicle 10a. By way of example, the vehicle 10a searches the map for GPS coordinates of the nearest passing zone. By way of another example, the vehicle 10a receives indication from the remote systems 240 of the nearest passing zone. In some embodiments, the vehicle 10a provides an indication to the vehicle 10b regarding the determination of the nearest passing zone. By way of example, the vehicle 10a may transmit a message for display on the operator interface 48 indicating the location of the nearest passing zone.

At step 1740, the vehicle 10a maintains operation toward the nearest passing zone. By way of example, the vehicle 10a maintains a speed of the prime mover 52 and a route of the steering system 66 (e.g., by adjusting steering wheel 42) as it moves towards the nearest passing zone. By way of another example, the vehicle 10a maintains its initial route towards the destination along the cart path 320. In some embodiments, the vehicle 10b has an option to adjust (e.g., by operating the steering wheel 42) the route of the vehicle 10b towards its destination, such that the vehicle 10b no longer follows the vehicle 10a. By way of example, the cart path 320 may have a second path diverging from the cart path 320 that the vehicle 10b can enter, and move towards its destination. As the vehicle 10a moves on the cart path 320 towards the nearest passing zone, the vehicle 10a may actively scan (e.g., detect, sense) the surrounding environment for a passing zone. Any/all of the steps 1720-1740, as described above, may be repeated until the vehicle 10a is within an on-path passing zone 810a or within the threshold distance adjacent to an off-path passing zone 810b.

At step 1745, responsive to the vehicle 10a being in an on-path passing zone 810a or adjacent to an off-path passing zone 810b, the vehicle 10a may receive sensor data acquired by the sensor system 70 (e.g., cameras 72, LiDAR sensors 74, radar sensors 76, etc.) regarding an environment surrounding the vehicle 10a. The size of the environment surrounding the vehicle may be based on the width of the path, the speed of the vehicle 10a (e.g., speed of the prime mover 52), the type of passing zone (e.g., on-path passing zone 810a, off-path passing zone 810b), and/or limitations of the sensor system 70. By way of example, if the passing zone is an on-path passing zone 810a, the environment surrounding the vehicle 10a may include a width of the cart path 320, and be configured to include the leading location 820. By way of another example, if the passing zone is an off-path passing zone 810b, the environment surrounding the vehicle may include a width of the cart path 320 and the off-path passing zone, and be configured to include the leading location. By allowing the sensor system 70 to acquire sensor data on the cart path 320, in the passing zone, and in the leading location 820, the vehicle 10a can detect obstacles 805 both in the passing zone and in the leading location 820 where the vehicle 10b will be after the passing operation.

At step 1750, the vehicle 10a determines whether there is an obstacle 805 located inside of the passing zone. By way of example, there may be obstacles 805 within the passing zone, such as people, animals, objects, and/or other features of the golf course 300, that do not allow a passing operation to be completed. In some embodiments, the vehicle 10a determines whether there are obstacles 805 in the environment surrounding the vehicle 10a. By way of example, the obstacles 805 may include oncoming vehicles 10 (e.g., vehicles 10 on the cart path 320 moving in the opposite direction) that restrict the vehicle 10b from safely passing the vehicle 10a. In some embodiments, the vehicle 10a analyzes the sensor data (e.g., via the vehicle control system 100), to determine whether there is an obstacle 805 in the passing zone. By way of example, the vehicle control system 100 of the vehicle 10a may analyze image data captured by the cameras 72 to determine the presence of an obstacle within the passing zone. By way of another example, the vehicle control system 100 of the vehicle 10a may analyze sensor data from the LiDAR sensors 74 and/or the radar sensors 76 to detect obstacles within the passing zone.

In some embodiments, if an obstacle is detected in the passing zone, the vehicle 10a indicates that the vehicle 10b is not authorized to pass (as described in step 1730). The vehicle 10a may then determine a location of the nearest passing zone (as described in step 1735), and maintain operation towards the nearest passing zone (as described in step 1740). The vehicle 10a may then determine its current location (as described in step 1720) and determine whether the vehicle 10a is in a passing zone (as described in step 1725). If the vehicle 10a is in a passing zone, the vehicle 10a may determine whether there is an obstacle in the passing zone and/or the surrounding environment. This may be repeated until (a) the vehicle 10a has arrived at its destination, (b) the vehicle 10b has initiated an alternate route towards its destination, or (c) the vehicle 10a is in a passing zone (e.g., or adjacent to a passing zone) without any detected obstacles.

At step 1755, responsive to no obstacles being detected in the passing zone and/or no obstacles being detected in the environment surrounding the vehicle 10a, the vehicle 10a (e.g., via the vehicle control system 100) may indicate that the vehicle 10b is authorized to pass (e.g., move ahead of) the vehicle 10a. The indication that the vehicle 10b is authorized to pass may vary based on whether the vehicle 10a and the vehicle 10b are autonomous (e.g., in the autonomous driving mode) or manual (e.g., in the manual driving mode).

In some embodiments, the vehicle 10a is autonomous and the vehicle 10b is manual. The vehicle 10a may indicate that the vehicle 10b is authorized to pass by reducing the speed of the vehicle 10a (e.g., of the prime mover 52). By way of example, if the passing zone is an on-path passing zone 810a, the vehicle 10a may slow or stop on the cart path 320 to indicate that the vehicle 10b can safely pass. The vehicle 10a may indicate that the vehicle 10b is authorized to pass by engaging (e.g., activating, turning on) the beacon 64 of the vehicle 10a. By way of example, the light pattern, light color, and/or sound of the beacon 64 may indicate to the operator (e.g., golfer 360) of the vehicle 10b that it is safe to pass. The vehicle 10a may indicate that the vehicle 10b is authorized to pass by exiting the cart path 320. By way of example, the vehicle 10a may exit the cart path 320 into an off-path passing zone 810b, thereby allowing the vehicle 10b to pass. The vehicle 10a may indicate that the vehicle 10b is authorized to pass by transmitting a message for display on the operator interface 48 of the vehicle 10b. By way of example, the message may be a human-readable message that the operator (e.g., golfer 360) can view.

In some embodiments, the vehicle 10a is manual and the vehicle 10b is autonomous. The vehicle 10a may indicate that the vehicle 10b is authorized to pass by reducing the speed of the vehicle 10a (e.g., of the prime mover 52). By way of example, if the passing zone is an on-path passing zone 810a, the vehicle 10a may slow or stop on the cart path 320 to indicate that the vehicle 10b can safely pass. The vehicle 10a may indicate that the vehicle 10b is authorized to pass by the operator (e.g., golfer 360) engaging (e.g., activating, turning on) the beacon 64 of the vehicle 10a. By way of example, the light pattern, light color, and/or sound of the beacon 64 may be detected by a camera 72 of the vehicle 10b. The vehicle 10a may indicate that the vehicle 10b is authorized to pass by exiting the cart path 320. By way of example, the vehicle 10a may exit the cart path 320 into an off-path passing zone 810b, allowing the vehicle 10b to pass. The vehicle 10a may indicate that the vehicle 10b is authorized to pass by transmitting an RF signal to the vehicle 10. By way of example, the operator (e.g., golfer 360) of the vehicle 10a can interact with the operator interface 48 (e.g., a selectable element of the operator interface 48) to transmit the signal.

In some embodiments, the vehicle 10a is autonomous and the vehicle 10b is autonomous. The vehicle 10a may indicate that the vehicle 10b is authorized to pass by reducing the speed of the vehicle 10a (e.g., of the prime mover 52). By way of example, if the passing zone is an on-path passing zone 810a, the vehicle 10a may slow or stop on the cart path 320 to indicate that the vehicle 10b can safely pass. The vehicle 10a may indicate that the vehicle 10b is authorized to pass responsive to the vehicle control system 100 automatically engaging (e.g., activating, turning on) the beacon 64 disposed on the outer surface of the vehicle 10a. By way of example, the light pattern, light color, and/or sound of the beacon 64 may be detected by a camera 72 of the vehicle 10b. The vehicle 10a may indicate that the vehicle 10b is authorized to pass by exiting the cart path 320. By way of example, the vehicle 10a may exit the cart path 320 into an off-path passing zone 810b, allowing the vehicle 10b to pass. The vehicle 10a may indicate that the vehicle 10b is authorized to pass by transmitting an RF signal to the vehicle 10.

At step 1760, the vehicle 10b may be operated (e.g., autonomously or manually) to pass the vehicle 10a. The vehicle 10a may slow or come to a complete stop in the passing zone (e.g., by operating the prime mover 52 and/or the steering system 66). In some embodiments, the vehicle 10b reduces a speed of the prime mover 52, such that the pass can be completed in a more controlled (e.g., safer) manner. The vehicle 10b may operate (e.g., adjust) the steering system 66 (e.g., steering wheel 42) to alter the route of the vehicle 10b, and move past a side portion of the vehicle 10a. In some embodiments, the vehicle 10b activates (e.g., engage, turn on) the beacon 64 to indicate to other vehicles 10 and/or people that the vehicle 10b is passing. In some embodiments, after the vehicle 10b moves ahead of the vehicle 10a, the vehicle 10a restores previous functionality (e.g., continue moving on the cart path 320 towards its respective destination).

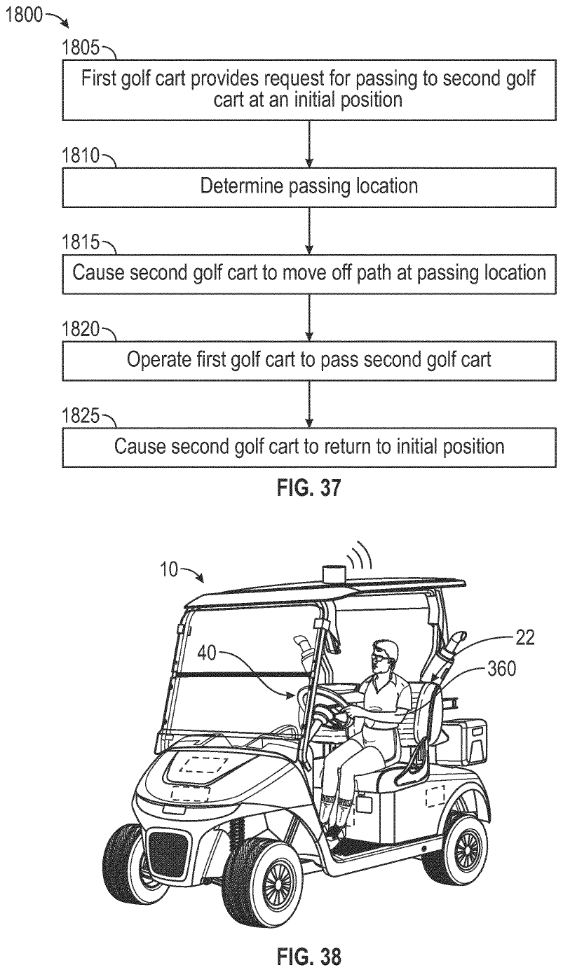

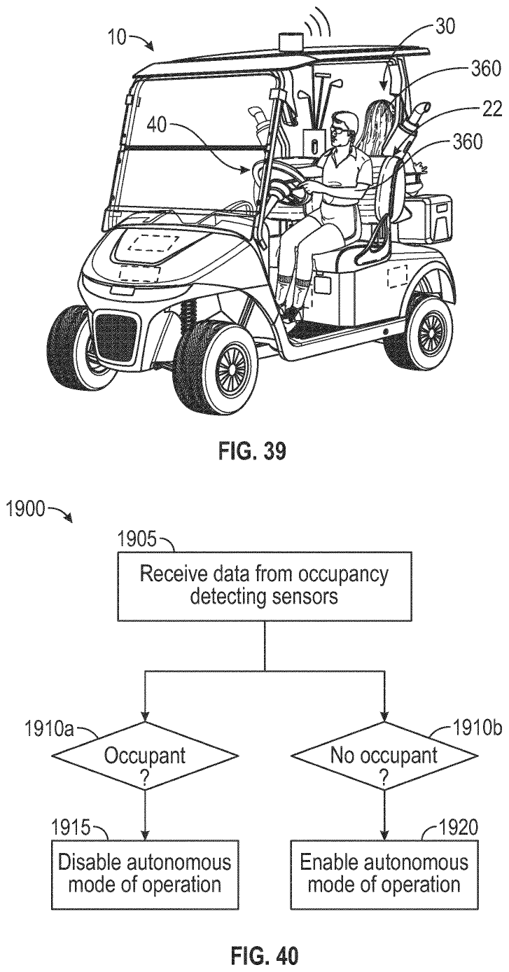

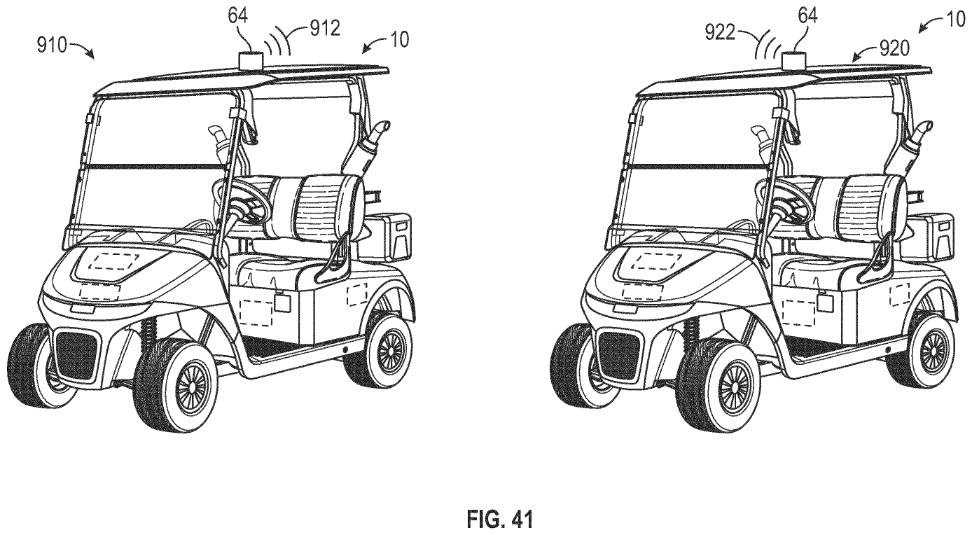

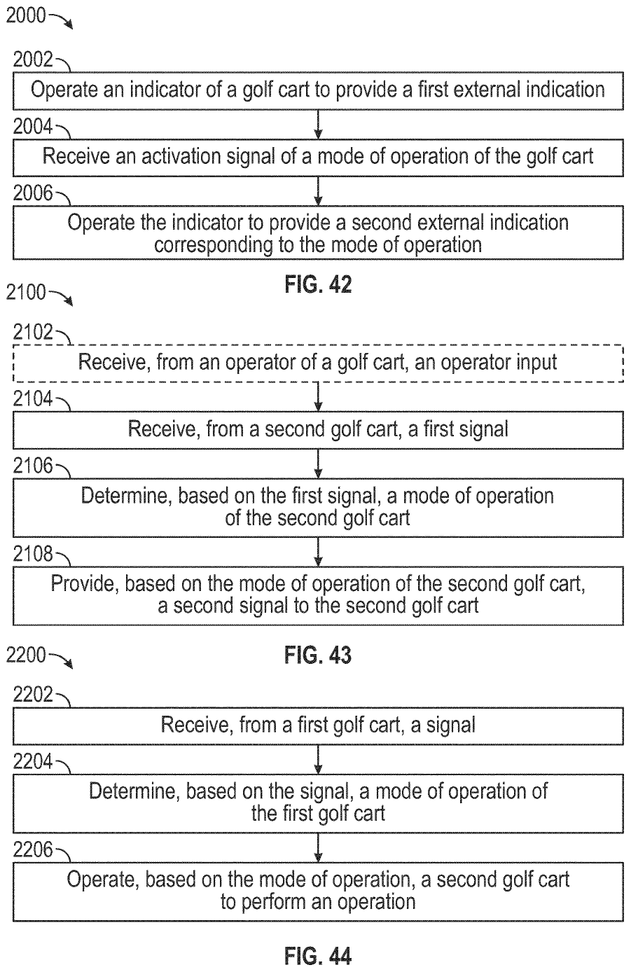

As shown in FIG. 37, depicted is a method 1800 for performing a passing operation between a vehicle 10c in the autonomous driving mode, and a stationary (e.g., non-moving) vehicle 10d capable of enabling the autonomous driving mode. The method 1800 may be performed by one or more processing circuits of the vehicle control system 100 of the vehicle 10c, the vehicle control system 100 of the vehicle 10d, and/or the remote systems 240. In some embodiments, the vehicle 10d is stationary at a location of the cart path 320 that cannot facilitate passing (e.g., due to a narrow section, obstacles 805 adjacent to cart path 320, etc.). At step 1805, the vehicle 10c provides a request for passing to the vehicle 10d. The request may be an RF transmission from the vehicle 10c to the vehicle 10d, and/or an indication via the beacon of the vehicle 10c. By way of example, the vehicle 10c may engage the beacon 64 to display a specific light pattern, light color, and/or sound that can be detected by the vehicle 10d (e.g., via cameras 72, microphone 86, or other sensor of the sensor system 70). The vehicle 10c may determine whether the vehicle 10d is occupied (e.g., by the golfer 360), to ensure that the vehicle 10d does not move autonomously while occupied without consent of the operator.

At step 1810, the vehicle 10c and/or the vehicle 10d determine a location for passing. In some embodiments, the location for passing is a nearest passing zone to the vehicle 10d. By way of example, the vehicle 10c or the vehicle 10d can determine the location of the vehicle 10d on the cart path 320 (e.g., via GPS coordinates received at the antennas 78), and reference a map stored in memory 104 to determine the nearest off-path passing zone 810b to the vehicle 10d. At step 1815, the vehicle 10c may cause the vehicle 10d to move off of the cart path 320 at the passing location. By way of example, the vehicle 10c may transmit an RF signal to the vehicle 10d causing activation of the autonomous driving mode, and instruct the vehicle 10d to operate the prime mover 52 and the steering system 66 (e.g., steering wheel 42) to exit the cart path 320 at the passing location.

At step 1820, the vehicle 10c may be operated to pass the vehicle 10d at the passing location. In some embodiments, after the vehicle 10c passes the vehicle 10d, the vehicle 10c provides an indicator to the vehicle 10d that the pass has been completed, and the indicator may be detected (e.g., sensed) by the vehicle 10d. At step 1825, the vehicle 10d may autonomously return to its initial position on the cart path (e.g., stationary position on the cart path 320). By returning the vehicle 10d to its initial position, the operator (e.g., golfer 360) of the vehicle 10d can locate the vehicle 10d upon returning.

### Deactivation/Occupant Sensing

As shown in FIGS. 38 and 39, one or more golfers 360 may occupy the vehicle 10. For example, the golfer 360 may be seated in the occupant seating area 22, as shown in FIGS. 38 and 39. In some instances, as shown in FIG. 38, the golfer 360 is entering or exiting the vehicle 10. Additionally or alternatively, as shown in FIG. 39, the golfer 360 may occupy (e.g., stand, sit, etc.) the bagwell 30.

As described above, the sensor system 70 includes one or more occupant detection sensors configured to facilitate detecting occupancy within or on the vehicle 10. That is, the occupant detection sensors acquire data that is used to provide a signal regarding the occupancy of the vehicle 10 to a control system (e.g., the vehicle control system 100). In this way, the occupant detection sensors are configured to facilitate detecting the presence of the golfer 360 within the occupant seating area 22 and/or within the bagwell 30, as shown in FIGS. 38 and 39. In turn, the vehicle control system 100 is configured to manipulate the autonomous mode of operation of the vehicle 10 in response to the signal indicating that the golfer 360 is within or on the vehicle 10.

In some instances, the vehicle control system 100 may manipulate the autonomous mode of operation by controlling at least one of steering, speed, acceleration, or braking of the vehicle 10 (e.g., via the steering system 66, the braking system 62, the prime mover 52, etc.) in response to the signal indicating that the golfer 360 is within or on the vehicle 10. For example, the vehicle control system 100 may detect (e.g., based on data acquired by the occupant detection sensors) that the golfer 360 got onto the vehicle 10 while the vehicle 10 is in motion using the autonomous mode of operation. In response to detecting that the golfer 360 got onto the vehicle, the vehicle control system 100 may control the steering, speed, acceleration, and/or braking of the vehicle 10 in order to stop the motion of the vehicle 10. Then, the vehicle control system 100 may disable the autonomous mode of operation of the vehicle 10.

For instance, in response to receiving a signal from the occupant detection sensors indicating that the golfer 360 is within the occupant seating area 22, as shown in FIG. 38, the vehicle control system 100 may be configured to disable the autonomous mode of operation of the vehicle 10 and enable a manual mode of operation. The manual mode of operation refers to a mode of operation in which the golfer 360 operates the vehicle 10 using the operator controls 40, as described above. Then, if the vehicle control system 100 receives a signal from the occupant detection sensors indicating that the golfer 360 has left the vehicle 10 (e.g., the occupant seating area 22), the vehicle control system 100 may enable the autonomous mode of operation in response.

Additionally or alternatively, in response to receiving a signal from the occupant detection sensors indicating that the golfer 360 is within the bagwell 30, as shown in FIG. 39, the vehicle control system 100 may be configured to disable the autonomous mode of operation and the manual mode of operation until the vehicle control system 100 receives an indication from the occupant detection sensors that the golfer 360 is no longer detected in the bagwell 30.

In some embodiments, the occupant detection sensors include the cameras 72 positioned variously about the vehicle 10. As described above, the cameras 72 may include one or more interior cameras positioned to facilitate monitoring the occupant seating area 22 and/or the bagwell 30. In this way, the cameras 72 may capture visual data showing the golfer 360 within or on the vehicle 10. Then, based on the visual data indicating that the golfer 360 is within or on the vehicle 10, the vehicle control system 100 may manipulate the autonomous control of the vehicle 10. For instance, if the cameras 72 provide visual data indicating that the golfer 360 is within the occupant seating area 22, the vehicle control system 100 may be configured to disable the autonomous mode of operation of the vehicle 10. As another example, if the cameras 72 provide visual data indicating that the golfer 360 is within the bagwell 30, the vehicle control system 100 may be configured to disable the autonomous mode of operation and the manual mode of operation of the vehicle 10. Similarly, if the cameras 72 provide visual data indicating that the golfer 360 is not within or on the vehicle 10, the vehicle control system 100 may be configured to enable the autonomous mode of operation of the vehicle.

The occupant detection sensors may also and/or otherwise include the IMU 80, the seat switch 82, and/or the floor sensor 84. For instance, the IMU 80, the seat switch 82, and/or the floor sensor 84 are configured to detect a weight or force applied to the vehicle 10 (e.g., a weight applied to the seating 24, a weight applied to the floorboard 28, a force applied from the golfer entering the occupant seating area 22 or jumping onto a portion of the vehicle 10, etc.). Therefore, the vehicle control system 100 may acquire a signal from the IMU 80, the seat switch 82, and/or the floor sensor 84 regarding the weight or force applied to the vehicle 10, and determine that there is an occupant (e.g., the golfer 360) within or on the vehicle 10 based on the detected weight or force applied to the vehicle 10. Additionally or alternatively, the IMU 80, the seat switch 82, and/or the floor sensor 84 may be configured to determine that the golfer 360 is within or on the vehicle 10 based on the detected weight or force applied to the vehicle 10. Then, the vehicle control system 100 may receive a signal indicating the determination of the occupancy within or on the vehicle 10 therefrom. Similarly, the data obtained by the IMU 80, the seat switch 82, and/or the floor sensor 84 may be used to determine that an occupant (e.g., the golfer 360) has left the vehicle 10. In some instances, data acquired by the IMU 80, the seat switch 82, and/or the floor sensor 84 may indicate that the golfer 360 is getting in or on the vehicle 10. In such instances, the vehicle control system 100 may be configured to disable the autonomous control of the vehicle 10 in response to the indication that the golfer 360 got into or on the vehicle 10.

Additionally or alternatively, the occupant detection sensors may include the one or more driveline sensors (e.g., motor sensor 92, motor controller sensor 94, BMS sensor 96, etc.). As described above, the one or more driveline sensors may be configured to facilitate detecting loaded or unloaded operation of the vehicle 10 based on driveline loads. For instance, in response to the driveline sensors indicating that the golfer 360 is within or on the vehicle 10 (e.g., based on the driveline loads indicating a loaded operation of the vehicle 10), the vehicle control system 100 may be configured to disable the autonomous mode of operation of the vehicle 10. Similarly, in response to the driveline sensors indicating that the golfer 360 is not within or on the vehicle 10 (e.g., based on the driveline loads indicating an unloaded operation of the vehicle 10), the vehicle control system 100 may be configured to enable the autonomous mode of operation of the vehicle 10. By way of example, the prime mover 52 may be required to provide a greater output when the loading on the vehicle 10 is greater than when the loading on the vehicle 10 is less to maintain a certain speed. Therefore, if the required output increases suddenly, it may be inferred that the golfer 360 got into or onto the vehicle 10.

In some embodiments, the occupant detection sensors include the microphone 86. As described above, the microphone 86 is configured to detect sound within or proximate to the vehicle 10. In this way, the microphone 86 may be used to facilitate detecting the voices of occupants (e.g., the golfer 360) within the vehicle 10 (e.g., within the occupant seating area 22, in the bagwell 30, etc.). Therefore, in response to the microphone 86 indicating that the golfer 360 is within or proximate to the vehicle 10 (e.g., based on detecting the voice of the golfer 360 within or proximate to the vehicle), the vehicle control system 100 may be configured to disable the autonomous mode of operation of the vehicle 10.

The occupant detection sensors may also and/or otherwise include the steering sensor 88 and/or the pedal sensor 90. As described above, the steering sensor 88 is configured to facilitate detecting an operator input (e.g., by the golfer 360) to the steering wheel 42. The pedal sensor 90 is configured to facilitate detecting an operator input (e.g., by the golfer 360) to the accelerator 44 and/or the brake 46. Therefore, in response to the steering sensor 88 and/or the pedal sensor 90 detecting operator input to the operator controls 40 (e.g., the steering wheel 42, the accelerator 44, the brake 46, etc.), and thereby providing an indication of occupancy within the vehicle 10, the vehicle control system 100 may be configured to disable the autonomous mode of operation of the vehicle 10.

Furthermore, the occupant detection sensors may include one or more of the antennas 78. As described above, the one or more of the antennas 78 are configured to facilitate detecting a key fob or device (e.g., user sensor 220, user device 232, etc.) carried by an operator of the vehicle 10 (e.g., the golfer 360). In this way, the one or more of the antennas 78 may provide an indication of the golfer 360 being within or proximate to the vehicle 10 when the key fob or device is detected or when the signal strength is above a threshold signal strength. Then, in response to the one or more of the antennas 78 indicating that the golfer 360 is within or proximate to the vehicle 10 (e.g., based on detecting that the key fob or device carried by the golfer 360 is within or proximate to the vehicle 10), the vehicle control system 100 may be configured to disable the autonomous mode of operation of the vehicle 10.

As shown in FIG. 40, a method 1900 for manipulating an autonomous mode of operation in response to a detected occupancy of the vehicle 10 is shown. In some embodiments, the method 500 is performed by the vehicle control system 100. The method 1900 may be performed to determine whether the autonomous mode of operation of the vehicle 10 should be disable based on a detected occupancy within the vehicle 10, as described above with reference to FIGS. 38 and 39.

At step 1905, data from one or more occupancy detecting sensors is received. For instance, the data may be received from any of the cameras 72, the IMU 80, the seat switch 82, the floor sensor 84, the microphone 86, the steering sensor 88, the pedal sensor 90, the one or more antennas 78, and/or the driveline sensors (e.g., the motor sensor 92, the motor controller sensor 94, the BMS sensor 96, etc.), as described above.

The method 1900 includes, in response to the detected occupancy of the vehicle 10 received at step 1905, determining the presence of an occupant at step 1910a or determining no occupants at step 1910b. In some embodiments, the occupancy detecting sensors determine the presence of the occupant at step 1910a or the no occupants at step 1910b. Additionally or alternatively, the vehicle control system 100 may be configured to determine the presence of the occupant at step 1910a or the no occupants at step 1910b based on the data received from the occupancy sensors. Determining the presence of the occupant at step 1910 may include determining that one or more golfers 360 are within the occupant seating area 22 and/or the bagwell 30. Similarly, determining that there is no occupant at step 1910b may include determining that no golfers 360 are within the occupant seating area 22 and/or the bagwell 30.

In response to determining the presence of the occupant at step 1910a, the method 1900 includes disabling the autonomous mode of operation of the vehicle 10 at step 1915. More specifically, the vehicle control system 100 may be configured to disable the autonomous mode of operation of the vehicle 10 in response to the indication of occupancy determined at step 1910a. The occupants may include golfers 360 detected in the occupant seating area 22 (e.g., as shown in FIG. 38) and/or in the bagwell 30 (e.g., as shown in FIG. 39). In some embodiments, disabling the autonomous mode of operation at step 1915 may include enabling the manual mode of operation (e.g., operation of the vehicle 10 by the golfer 360 using the operator controls 40).

Furthermore, in response to determining no occupants at step 1910b, the method 1900 includes enabling the autonomous mode of operation at step 1920. More specifically, the vehicle control system 100 may be configured to enable the autonomous mode of operation of the vehicle 10 in response to the indication of no occupants determined at step 1910b. That is, with no occupants detected in the occupant seating area 22, the bagwell 30, or otherwise within or on the vehicle 10, the vehicle control system 100 may operate according to the autonomous mode of operation until there is a detection of occupancy and/or until the vehicle control system 100 receives another indication to disable the autonomous mode of operation (e.g., reaching a destination, reaching the green staging location 340, etc.).

In some embodiments, the autonomous mode of operation may be enabled in response to detecting that the occupants (e.g., golfers 360) of the vehicle 10 are properly seated in the occupant seating area 22, and that there are no occupants detected in the bagwell 30 or otherwise standing or hanging on/off the vehicle 10. That is, the one or more occupant detections sensors (e.g., included in the sensor system 70, as described above) are configured to detect the presence of the golfer 360 in the occupant seating area 22. Furthermore, the occupant detections sensors are configured to detect that the occupant seating area 22 is properly occupied by one or more golfers 360. As an example, if the occupant seating area 22 properly seats two golfers 360 (e.g., each of the two golfers 360 occupying a separate seat), the occupant seating area 22 is determined to be properly occupied when two golfers 360 are seated in the occupant seating area 22. Similarly, the occupant detections sensors are configured to detect that the bagwell 30 is not occupied by one or more golfers 360. Therefore, in response to determining that the occupant seating area 22 is properly occupied and that the bagwell 30 is not occupied, the vehicle control system 100 may be configured to enable to autonomous mode of operation (e.g., as described above with reference to step 1920 of the method 1900) with occupants onboard.

### External Indication Sensing of Proximate Vehicles

As shown in FIG. 41, two or more of the vehicles 10 that are proximate (e.g., within a range, within a line of sight, within a wireless communication range, within a distance threshold, within a sound attenuation distance, within a geofence bubble, proximate golf carts, etc.), shown as first vehicle 910 and second vehicle 920, are configured to communicate via one or more communication protocols (e.g., audio signals, visual signals, wireless signals, etc.). Such communications between the vehicles 10 may be utilized for real time control of the vehicles 10 (e.g., by the vehicle control system 100, by the fleet monitoring and control system 200, etc.) and/or to notify operators of the vehicles 10 regarding information associated with other proximate vehicles 10. By way of example, such communications between vehicles 10 may allow for communication of modes of operation and/or locations of the vehicles 10 with other of the vehicles 10.

The first vehicle 910 and the second vehicle 920 may communicate regarding modes of operation associated with the first vehicle 910 and the second vehicle 920. By way of example, when the first vehicle 910 is a manually operated vehicle (e.g., a vehicle operated by an operator, etc.) and the second vehicle 920 is an autonomous vehicle (e.g., a semi-autonomous vehicle, etc.) operating in an autonomous mode of operation (e.g., a first mode, etc.), the first vehicle 910 may communicate to the second vehicle 920 that the first vehicle 910 is in a manual mode of operation (e.g., a second mode, etc.) and the second vehicle 920 may communicate to the first vehicle 910 that the second vehicle 920 is in an autonomous mode of operation. By way of another example, when the first vehicle 910 is an autonomous golf vehicle that is operating in an autonomous green mode of operation that causes the first vehicle 910 to autonomously navigate to a green location proximate a green of a golf course, the first vehicle 910 may communicate to the second vehicle 920 that the first vehicle is in the autonomous green mode of operation. In some embodiments, the first vehicle 910 and the second vehicle 920 may be simultaneously operating in more than one of the modes of operation. By way of example, the first vehicle 910 may be simultaneously operating in a manual mode of operation and a passing mode of operation associated with passing the second vehicle 920. By way of another example, the second vehicle 920 may be simultaneously operating in an autonomous mode of operation and a limited performance mode of operation associated with limiting performance of the second vehicle 920.

As shown in FIG. 41, the first vehicle 910 and the second vehicle 920 are configured to generate and provide output signals, shown as first signal 912 for the first vehicle 910 and second signal 922 for the second vehicle 920, corresponding to at least one mode of operation of the first vehicle 910 and the second vehicle 920. By way of example, when the first vehicle 910 is operating in a manual mode of operation, the vehicle control system 100 of the first vehicle 910 may generate the first signal 912 corresponding to the manual mode of operation of the first vehicle 910. By way of another example, when the second vehicle 920 is being operated in a passing mode of operation associated with the second vehicle 920 passing the first vehicle 910, the vehicle control system 100 of the second vehicle 920 may generate the second signal 922 corresponding to the passing mode of operation of the second vehicle 920.

According to the exemplary embodiment shown in FIG. 41, the beacons 64 of the vehicles 10 are configured to provide signals to other of the vehicles 10. As shown in FIG. 41, the beacon 64 (e.g., an indicator, a first indicator, etc.) of the first vehicle 910 is configured to provide the first signal 912 to the second vehicle 920 and the beacon 64 (e.g., an indicator, a second indicator, etc.) of the second vehicle 920 is configured to provide the second signal 922 to the first vehicle 910. By way of example, when the beacon 64 of the first vehicle 910 includes one or more lights (e.g., the beacon 64 is a visual indicator, etc.), the vehicle control system 100 of the first vehicle 910 may operate the beacon 64 to emit various colors and/or light patterns (e.g., visual outputs, etc.) indicating the mode of operation of the first vehicle 910 to emit the first signal 912 corresponding to the mode of operation of the first vehicle 910. The beacon 64 of the first vehicle 910 may provide the first signal 912 corresponding to the mode of operation of the first vehicle 910 to the second vehicle 920. By way of another example, when the beacon 64 of the second vehicle 920 includes a speaker (e.g., the beacon is an audible indicator, etc.), the vehicle control system 100 of the second vehicle 920 may operate the beacon 64 to emit one or more tones or sounds (e.g., audio outputs, etc.) indicating the mode of operation of the second vehicle 920 to emit the second signal 922 corresponding to the mode of operation of the second vehicle 920. The beacon 64 of the second vehicle 920 may provide the second signal 922 corresponding to the mode of operation of the second vehicle 920 to the first vehicle 910. The one or more tones or sounds indicating the mode of operation emitted by the beacons 64 may be within a specific range of frequencies. By way of example, the one or more tones or sounds indicating the mode of operation emitted by the beacons 64 may be within a range of frequencies that are within a human hearing range such that pedestrians proximate the beacons 64 and/or operators of the vehicles 10 proximate the beacons 64 can hear the one or more tones or sounds. By way of another example, the one or more tones or sounds indicating the mode of operation emitted by the beacons 64 may be outside of a range of frequencies that are within human hearing range such that the one or more tones or sounds may be received by the vehicles 10 without disturbing (e.g., annoying, etc.) pedestrians proximate the beacons 64 and/or operators the vehicles 10 proximate the beacons 64.

When the beacons 64 of the vehicles 10 are configured to provide signals corresponding to the modes of operation of the vehicles 10, the sensor system 70 of the vehicles 10 may acquire the signals provided by other of the vehicles 10. By way of example, when the beacon 64 of the first vehicle 910 include one or more lights and is operated by the vehicle control system 100 of the first vehicle 910 to provide the first signal 912 by emitting various colors and/or light patterns indicating the mode of operation of the first vehicle 910, the cameras 72 of the second vehicle 920 may acquire image data corresponding to the various colors and/or light patterns emitted by the beacon 64 of the first vehicle 910. The vehicle control system 100 of the second vehicle 920 may acquire the image data from the cameras 72 of the second vehicle 920 and determine the mode of operation of the first vehicle 910 based on the image data. The beacons 64 of the vehicles 10 may provide the signals corresponding to the modes of operation of the vehicles 10 as various light colors and/or light patterns to the cameras 72 of other of the vehicles 10 when the vehicles 10 are within a line of sight of each other. By way of another example, when the beacon 64 of the second vehicle 920 includes the speaker and is operated by the vehicle control system 100 of the second vehicle 920 to provide the second signal 922 by emitting tones or sounds indicating the mode of operation of the second vehicle 920, the microphone 86 of the first vehicle 910 may acquire sound data corresponding to the tones or sounds emitted by the beacon 64 of the second vehicle 920. The vehicle control system 100 of the first vehicle 910 may acquire the sound data from the microphone 86 of the first vehicle 910 and determine the mode of operation of the second vehicle 920 based on the sound data. The beacons 64 of the vehicles 10 may provide the signals corresponding to the modes of operation of the vehicles 10 as various tones or sounds to the microphones 86 of other of the vehicles 10 when the vehicles 10 are within a sound range of each other.

In some embodiments, components of the vehicles 10 other than the beacons 64 (e.g., sensors of the sensor system 70, etc.) are configured to provide signals to other of the vehicles 10 and/or receive signals from the other of the vehicles 10. By way of example, the cameras 72 of the vehicles 10 may be infrared cameras configured to emit and/or receive infrared light. The cameras 72 of the first vehicle 910 may be operated by the vehicle control system 100 of the first vehicle 910 to provide the first signal 912 by emitting various infrared light patterns indicating the mode of operation of the first vehicle 910. The cameras 72 of the second vehicle 920 may acquire infrared image date corresponding to the various infrared light patterns emitted by the cameras 72 of the first vehicle 910. The vehicle control system 100 of the second vehicle 920 may acquire the infrared image data from the cameras 72 of the second vehicle 920 and determine the mode of operation of the first vehicle 910 based on the infrared image data. The cameras 72 of the vehicles 10 may provide the infrared signals corresponding to the modes of operation of the vehicles 10 as various infrared light patterns to the cameras 72 of other of the vehicles 10 when the vehicles 10 are within a line of sight of each other.

In some embodiments, the vehicles 10 are configured to provide signals to other of the vehicles 10 via the communications network 210 (e.g., through the communications interface 106, etc.). By way of example, the vehicles 10 may provide signals corresponding to the modes of operation of the vehicles 10 to other of the vehicles via the one or more communications protocols (e.g., Bluetooth, Wi-Fi, cellular, radio, through the Internet, etc.) through the communications network 210 using the communications interfaces 106 of the vehicles 10. The first vehicle 910 and the second vehicle 920 are configured to provide the first signal 912 and the second signal 922 respectively via the communications network 210. By way of example, the vehicle control system 100 of the first vehicle 910 may generate the first signal 912 corresponding to the mode of operation of the first vehicle 910 and provide the first signal 912 to the remote systems 240 via the communications network 210. The remote systems 240 may determine that the second vehicle 920 is proximate the first vehicle 910 (e.g., based on relative locations of the first vehicle 910 and the second vehicle 920, based on the second vehicle 920 being within a geofence bubble associated with the first vehicle 910, based on the first vehicle 910 being within a geofence bubble associated with the second vehicle 920, etc.) and provide the first signal 912 to the second vehicle 920 via the communications network 210. By way of another example, the vehicle control system 100 of the second vehicle 920 may generate the second signal 922 corresponding to the mode of operation of the second vehicle 920 and provide the second signal 922 directly to the first vehicle 910 via the communications network 210. The second vehicle 920 may directly provide the second signal 922 to the first vehicle 910 via the communications network 210 based on a distance between the first vehicle 910 and the second vehicle 920 being less than a distance threshold (e.g., the first vehicle 910 is in range of the second vehicle 920, the communications network 210 broadcasted by the second vehicle 920 is able to reach the first vehicle 910, etc.).

In some embodiments, the vehicles 10 and the user devices 232 that are proximate the vehicles 10 (e.g., within a range, within a line of sight, within a wireless communication range, within a distance threshold, etc.) are configured to communicate via one or more communication protocols (e.g., audio signals, visual signals, wireless signals, via the communications network 210, through a proximity beacon, via the sensor system 70 of the vehicles 10, etc.). Such communications between the vehicles 10 and the user devices 232 may be utilized for real time control of the vehicles 10 (e.g., by the vehicle control system 100, by the fleet monitoring and control system 200, etc.) and/or to notify users of the user devices 232 regarding information associated with proximate vehicles 10. By way of example, such communications between the vehicles 10 and the user devices 232 may allow for communication of modes of operation and/or locations of the vehicles 10 to the user devices 232 and/or communication of locations of the user devices 232 to the vehicles 10. In some embodiments, the vehicles 10 and the user sensors 220 that are proximate the vehicles 10 are configured to communicate via one or more communication protocols (e.g., audio signals, visual signals, wireless signals, via the communications network 210, through a proximity beacon, via the sensor system 70 of the vehicles 10, etc.). Such communications between the vehicles 10 and the user sensors 220 may be utilized for real time control of the vehicles 10 (e.g., by the vehicle control system 100, by the fleet monitoring and control system 200, etc.).

The vehicles 10 may communicate with the user devices 232 regarding modes of operation associated with the vehicles 10. By way of example, when one of the vehicles 10 is operating in an autonomous mode of operation, the vehicle 10 may communicate to one of the user devices 232 that the vehicle 10 is operating in the autonomous mode of operation such that the user device 232 may provide an indication (e.g., a notification on the user device 232, by vibrating the user device 232, etc.) to a user of the user device 232 that the vehicle 10 is operating in the autonomous mode of operation. In some embodiments, the vehicles 10 communicates with the user devices 232 regarding the modes of operation associated with the vehicles 10 when a distance between the vehicles 10 and the user devices 232 is less than a distance threshold. By way of example, the fleet monitoring and control system 200 may facilitate communication of a mode of operation of one of the vehicles 10 with one of the user devices 232 when a location of the vehicle 10 is within a geofence bubble associated with the user device 232. In some embodiments, the user devices 232 provide an indication to the users of the user devices 232 when one of the vehicles 10 is within a distance range of the user devices 232 and the vehicle 10 is operating in an autonomous mode of operation.

The user devices 232 may communicate with the vehicles 10 regarding locations of users associated with the user devices 232. By way of example, one of the user devices 232 may communicate a location of the user device 232 to one of the vehicles 10. The vehicle control system 100 of the vehicle 10 may operate the vehicle 10 in a limited performance mode of operation based on the location of the user device 232 being within a geofence bubble associated with vehicle 10 such that a speed of the vehicle 10 is limited when the vehicle 10 is proximate the user associated with the user device 232. In some embodiments, the user sensors 220 may communicate with the vehicles 10 regarding locations of users associated with the user sensors 220. By way of example, the sensor system 70 of one of the vehicles 10 may facilitate communication from the user sensors 220 to the vehicle control system 100 of the vehicle 10 corresponding to a location of a user associated with the user sensors 220 when the location of the user is proximate the vehicle 10. The vehicle control system 100 of the vehicle 10 may operate the vehicle 10 based on the location of the user being proximate the vehicle 10 (e.g., change a mode of operation of the vehicle 10, etc.).

As shown in FIG. 42, a method 2000 for operating an indicator of a golf cart includes steps 2002-2006. In some embodiments, the method 2000 is for operating an indicator of an autonomous golf cart. The method 2000 may be executed by, for example, the vehicle control system 100 or the fleet monitoring and control system 200. Further, any computing device described herein can be configured to perform at least a portion of the method 2000 (e.g., the vehicle control system 100, the user device 232, the off-site server 250, the on-site system 260, etc.). According to an exemplary embodiment, the method 2000 is for operating the beacon 64 of one of the vehicles 10 based on a mode of operation of the vehicle 10 to notify pedestrians, other of the vehicles 10 proximate the one of the vehicles 10, and/or operators of the other of the vehicles 10 proximate the one of the vehicles 10 of the mode of operation of the one of the vehicles 10. By way of example, the method 2000 may be for operating the beacons 64 of the vehicles 10 to provide a first external indication (e.g., a first alert, etc.) when the vehicles 10 are operating in a manual mode of operation and to provide a second external indication (e.g., a second alert, etc.) when the vehicles 10 are operating in an autonomous mode of operation such that the mode of operation of the vehicles 10 may be identified.

As shown in FIG. 42, the method 2000 begins with operating an indicator of a golf cart to provide a first external indication at step 2002. In some embodiments, the first external indication corresponds with a first mode of operation of the golf cart. By way of example, the first external indication may correspond with a manual mode of operation of the golf cart (e.g., a mode of operation of the golf cart where an operator of the golf cart is controlling the golf cart, etc.). The golf cart may be the vehicle 10, the first vehicle 910, and/or the second vehicle 920, as described herein. The indicator may be the beacon 64 of the vehicle 10, a component of the sensor system 70 of the vehicle 10 (e.g., the camera 72 as an infrared camera, etc.), and/or the communications interface 106 of the vehicle 10, as described herein. The first external indication may be a first signal profile of a signal provided by the vehicle 10, a first signal profile of the first signal 912 provided by the first vehicle 910, and/or a first signal profile of the second signal 922 provided by the second vehicle 920, as described herein. By way of example, when the beacon 64 includes a light, the vehicle control system 100 may operate the beacon 64 to emit the first external indication including a first light color and/or a first light pattern. By way of another example, when the beacon 64 includes a speaker, the vehicle control system 100 may operate the beacon 64 to emit the first external indication including a first sound frequency and/or a first sound pattern. By way of yet another example, when the camera 72 is an infrared camera, the vehicle control system 100 may operate the camera 72 to emit the first external indication including a first infrared light pattern. By way of another example, the vehicle control system 100 may operate the communications interface 106 to provide the first external indication including a first signal profile to the communications network 210.

As shown in FIG. 42, the method 2000 includes receiving an activation signal for a mode of operation of the golf cart at step 2004. In some embodiments, the activation signal is for an autonomous mode of operation of the golf cart (e.g., a go to green mode of operation, a passing mode of operation, etc.). In other embodiments, the activation signal is for another mode of operation of the golf cart (e.g., a manual mode of operation, a manual passing mode of operation, a limited performance mode of operation, etc.). In some embodiments, the activation signal for the mode of operation is received by the vehicle control system 100 of the vehicles 10. In other embodiments, the activation signal for the mode of operation is received by the remote systems 240 of the fleet monitoring and control system 200.

In some embodiments, the activation signal for the mode of operation of the golf cart at step 2004 is a manual activation signal for the mode of operation that is received from an operator of the golf car. By way of example, the operator of the vehicle 10 may generate an activation signal for an autonomous mode of operation of the vehicle 10 by pressing the activation button 49. The autonomous mode of operation of the vehicle 10 may include the vehicle control system 100 autonomously controlling vehicle 10 (e.g., to drive the vehicle 10 to the green staging location 340 proximate the green 312 of the golf course 300, to drive the vehicle 10 along the cart path 320 of the golf course 300, to drive the vehicle 10 to the tee staging location 330 of the golf course 300, etc.) by controlling at least one of steering, speed, acceleration, or braking of the vehicle 10 (e.g., via the steering system 66, the braking system 62, the prime mover 52, etc.). By way of another example, the operator of the vehicle 10 may generate an activation signal for a manual passing mode of operation of the vehicle 10 by providing an input to the operator interface 48 that corresponds to the manual passing mode of operation of the vehicle 10. The manual passing mode of operation of the vehicle 10 may correspond with the operator of the vehicle 10 attempting to pass another of the vehicles 10. The operator may provide the input to the operator interface 48 that corresponds to the manual passing mode of operation of the vehicle 10 when the operator desires to pass another of the vehicles 10 positioned in front of the vehicle 10 (e.g., in front of the vehicle 10 along the cart path 320 of the golf course 300, etc.). By way of yet another example, the operator of the vehicle 10 may generate an activation signal for a manual move request mode of operation of the vehicle 10 by providing an input to the operator interface 48 that corresponds to the manual move request mode of operation of the vehicle 10. The operator may provide the input to the operator interface 48 that corresponds to the manual move request mode of operation of the vehicle 10 when another of the vehicles 10 is positioned in the way of the vehicle 10 (e.g., in a position on the cart path 320 that is blocking the cart path 320, etc.).

In some embodiments, the activation signal for the mode of operation of the golf cart at step 2004 is an autonomous activation of the mode of operation that is associated with autonomous operation of the golf cart. The vehicle control system 100 of the vehicle 10 may autonomously activate a mode of operation of the vehicle 10 as part of the vehicle control system 100 autonomously controlling the vehicle 10. By way of example, the vehicle control system 100 of the vehicle 10 may autonomously activate an autonomous passing mode of operation of the vehicle 10. The autonomous passing mode of operation of the vehicle 10 may correspond with the vehicle control system 100 autonomously controlling the vehicle 10 (e.g., via the steering system 66, the braking system 62, the prime mover 52, etc.) to pass another of the vehicles 10 positioned in front of the vehicle 10. By way of another example, the vehicle control system 100 of the vehicle 10 may autonomously activate an autonomous move request mode of operation of the vehicle 10. The autonomous move request mode of operation of the vehicle 10 may correspond with the vehicle control system 100 autonomously controlling the vehicle 10 to drive past another of the vehicles 10 positioned in the way of the vehicle 10. By way of yet another example, the vehicle control system 100 of the vehicle 10 may autonomously activate a line up mode of operation of the vehicle 10. The line up mode of operation of the vehicle 10 may correspond with the vehicle control system 100 autonomously controlling the vehicle 10 to form a train with another of the vehicles 10 in order to drive together with the other of the vehicles 10 to a destination (e.g., in a line, in a train, etc.). By way of another example, the vehicle control system 100 may autonomously activate a performance limiting mode of operation of the vehicle 10. The performance limiting mode of operation may limit performance levels of components of the vehicle 10 (e.g., the driveline 50, the prime mover 52, etc.) to limit driving capabilities (e.g., speeds, turning radii, etc.) of the vehicle 10. The vehicle control system 100 may activate the performance limiting mode of operation of the vehicle 10 in response to determining an object (e.g., an obstacle, a pedestrian, another of the vehicles 10, etc.) is positioned proximate the vehicle 10 (e.g., based on sensor data from the sensor system 70, etc.) and/or in response to receiving a passing request from another of the vehicles 10 such that the other of the vehicles 10 may pass the vehicle 10.

As shown in FIG. 42, the method 2000 includes operating the indicator to provide a second external indication corresponding to the mode of operation. By providing the second external indication corresponding to the mode of operation, the indicator of the golf cart may provide an indication (e.g., to pedestrians, to other golf carts, to operators of other golf carts, etc.) that the golf cart is operating in the mode of operation. In some embodiments, the second external indication corresponds with a second mode of operation of the golf cart. By way of example, when the first external indication corresponds with the manual mode of operation of the golf cart, the second external indication may correspond with an autonomous mode of operation of the golf cart. The second external indication may be a second signal profile of the signal provided by the vehicle 10, a second signal profile of the first signal 912 provided by the first vehicle 910, and/or a second signal provide of the second signal 922 provided by the second vehicle 920, as described herein. By way of example, when the beacon 64 includes the light, the vehicle control system 100 may operate the beacon 64 to emit the second external indication including a second light color and/or a second light pattern that are different from the first light color and/or the first light pattern of the first external indication. By way of another example, when the beacon 64 includes the speaker, the vehicle control system 100 may operate the beacon 64 to emit the second external indication including a second sound frequency and/or a second sound pattern that are different from the first sound frequency and/or the second sound pattern of the first external indication. By way of yet another example, when the camera 72 is the infrared camera, the vehicle control system 100 may operate the camera 72 to emit the second external indication including a second infrared light pattern that is different from the first infrared light pattern of the first external indication. By way of another example, the vehicle control system 100 may operate the communications interface 106 to provide the second external indication including a second signal profile to the communications network 210 that is different from the first signal profile of the first external indication.

In some embodiments, one of the first external indication or the second external indication is the indicator being on and the other of the first external indication or the second external indication is the indicator being off. By way of example, the vehicle control system 100 may operate the beacon 64 to be on (e.g., to emit a light, to emit a sound, etc.) as one of the first external indication or the second external indication and the beacon 64 to be off (e.g., to not emit a light, to not emit a sound, etc.) as the other of the first external indication or the second external indication. By way of another example, the vehicle control system 100 may operate the beacon 64 to be off when the mode of operation of the vehicle 10 is the manual mode of operation of the vehicle 10 and operate the beacon 64 to be on when the mode of operation of the vehicle 10 is the autonomous mode of operation of the vehicle 10, or the vehicle control system 100 may operate the beacon 64 to be on when the mode of operation of the vehicle 10 is the autonomous mode of operation of the vehicle 10 and operate the beacon 64 to be off when the mode of operation of the vehicle 10 is the manual mode of operation of the vehicle 10.

In some embodiments, the method 2000 includes receiving a deactivation signal for a mode of operation of the golf cart. The deactivation signal may be received similarly to the activation for the mode of operation of the golf cart. In some embodiments, the deactivation signal is for the autonomous mode of operation of the golf cart. In other embodiments, the deactivation signal is for another mode of operation of the golf cart.

In some embodiments, the method 2000 includes operating the indicator to provide the first external indication based on receiving the deactivation for the mode of operation of the golf cart. By way of example, when the deactivation signal is for the autonomous mode of operation of the golf cart, the deactivation signal may cause the autonomous mode of operation of the golf cart to be deactivated and the golf cart to return to a manual mode of operation. The first external indication may correspond to the manual mode of operation. By providing the first external indication corresponding to the manual mode of operation, the indicator of the golf cart may provide an indication that the golf cart is operating in the manual mode of operation.

As shown in FIG. 43, a method 2100 for facilitating communication between a plurality of golf carts includes steps 2102-2108. The method 2100 may be executed by, for example, the vehicle control system 100 or the fleet monitoring and control system 200. Further, any computing device described herein can be configured to perform at least a portion of the method 2100 (e.g., the vehicle control system 100, the user device 232, the off-site server 250, the on-site system 260, etc.). According to an exemplary embodiment, the method 2100 is for operating the beacon 64 of one of the vehicles 10 based on a mode of operation of another of the vehicles 10 to provide a signal to the other of the vehicles 10. By way of example, the method 2100 may be for operating the beacon 64 of the second vehicle 920 to provide the second signal 922 to the first vehicle 910 based on a mode of operation of the first vehicle 910 such that first vehicle 910 may receive operating information from the second vehicle 920 to influence operations of the first vehicle 910.

According to the exemplary embodiment shown in FIG. 43, the method 2100 begins with receiving, from an operator of a first golf cart, an operator input at step 2102. The first golf cart may be the first vehicle 910, as described herein. The operator input may be received via the operator interface 48 of the first vehicle 910. In some embodiments, the operator input is received from an operator of an autonomous golf cart. In some embodiments, the operator input is associated with a mode of operation of the first golf cart. By way of example, the operator input may be associated with an activation of an autonomous mode of operation of the first golf cart, an activation of a manual passing mode of operation of the first golf cart, or a manual move request mode of operation of the first golf cart.

As shown in FIG. 43, the method 2100 includes receiving, from a second golf cart, a first signal at step 2104. The first signal may correspond with a mode of operation of the second golf cart. The second golf cart may be the second vehicle 920 and the first signal may be the second signal 922, as described herein. The first vehicle 910 may receive the second signal 922 from the second vehicle 920. By way of example, the first vehicle 910 may receive the second signal 922 emitted by the beacon 64 of the second vehicle 920. By way of another example, the first vehicle 910 may receive the second signal 922 from the second vehicle 920 via the communications network 210.

As shown in FIG. 43, the method 2100 includes determining, based on the first signal, a mode of operation of the second golf cart at step 2106. In some embodiments, the mode of operation of the second golf cart is determined by matching a first signal profile of the first signal with a known signal profile corresponding to a mode of operation of golf carts. By way of example, the vehicle control system 100 of the first vehicle 910 may acquire data corresponding to the second signal 922 of the second vehicle 920 from the sensor system 70 of the first vehicle 910. The vehicle control system 100 of the first vehicle 910 may utilize the data to compare a signal profile of the second signal 922 to known signal profiles stored in the memory 104 of the vehicle control system 100 that correspond with modes of operation of the vehicles 10 to determine the mode of operation of the second vehicle 920. By way of another example, the vehicle control system 100 of the first vehicle 910 may receive data corresponding to the second signal 922 of the second vehicle 920 and determine that the second vehicle 920 is in a passing mode of operation based on the data corresponding to the second signal 922.

As shown in FIG. 43, the method 2100 includes providing, based on the operating mode of the second golf cart, a second signal to the second golf cart at step 2108. The second signal may include information and/or instructions associated with the operating mode of the second golf cart. By way of example, when the operating mode of the second vehicle 920 is a passing mode of operation that indicates that the second vehicle 920 is attempting to pass the first vehicle 910, the first signal 912 may include an acceptance or a rejection of the second vehicle 920 attempting to pass the first vehicle 910. The first vehicle 910 may reject the second vehicle 920 attempting to pass the first vehicle 910 based on the first vehicle 910 being located in a no passing zone (e.g., a no passing zone of the cart path 320 of the golf course 300, a no passing zone of the golf course 300, etc.) and/or the first vehicle 910 driving in a no passing scenario. By way of another example, when the operating mode of the second vehicle 920 is a move request mode of operation that indicates that the second vehicle 920 is requesting that the first vehicle 910 moves out of the way of the second vehicle 920, the first signal 912 may include an acceptance or a rejection of the second vehicle 920 requesting for the first vehicle 910 to move out of the way of the second vehicle 920. In some embodiments, the second signal is provided to the second golf cart by an indicator of the first golf cart. By way of example, the second signal may be the first signal 912 provided to the second vehicle 920 by the beacon 64 of the first vehicle 910.

In some embodiments, the second signal provided to the second golf cart at step 2108 corresponds to the operator input received from the operator of the first golf cart at step 2102. By way of example, when the operator input received at step 2102 corresponds to a manual passing mode of operation, the second signal provided to the second golf cart may correspond with a passing request for the first golf cart to pass the second golf cart. By way of another example, when the operator input received at step 2102 corresponds to a manual move request mode of operation, the second signal provided to the second golf cart may correspond with a move request for the second golf cart to move out of the way of the first golf cart. By way of yet another example, when the operator input received at step 2102 corresponds to an autonomous mode of operation and the operating mode of the second golf cart corresponds to a go to green mode of operation, the second signal provided to the second golf cart may correspond with a train request for the first golf cart to form a train with the second golf cart as the second golf cart drives to a green location proximate a green of golf course.

In some embodiments, the second signal provided to the second golf cart at step 2108 corresponds to an operator input received from the operator after determining the mode of operation of the second golf cart at step 206. By way of example, when the vehicle control system 100 of the first vehicle 910 determines that the mode of operation of the second vehicle 920 is a passing request mode of operation, the vehicle control system 100 of the first vehicle 910 may operate the operator interface 48 of the first vehicle 910 to provide the operator of the first vehicle 910 with a passing request indicating that the second vehicle 920 is attempting to pass the first vehicle 910. In response to the operator of the first vehicle 910 approving the passing request, the first signal 912 may include an acceptance of the second vehicle 920 attempting to pass the first vehicle 910 such that the second vehicle 920 and/or an operator of the second vehicle 920 is notified of the acceptance. In response to the operator of the first vehicle 910 denying the passing request, the first signal 912 may include a denial of the second vehicle 920 attempting to pass the first vehicle 910 such that the second vehicle 920 and/or the operator of the second vehicle 920 is notified of the denial.

As shown in FIG. 44, a method 2200 for operating a golf cart includes steps 2202-2206. The method 2200 may be executed by, for example, the vehicle control system 100 or the fleet monitoring and control system 200. Further, any computing device described herein can be configured to perform at least a portion of the method 2200 (e.g., the vehicle control system 100, the user device 232, the off-site server 250, the on-site system 260, etc.). According to an exemplary embodiment, the method 2200 is for operating a golf cart based on a mode of operation of another golf cart. By way of example, the method 2000 may be for operating the second vehicle 920 based on a mode of operation of the first vehicle 910. The second vehicle 920 may determine the mode of operation of the first vehicle 910 based on the first signal 912 received from the first vehicle 910.

As shown in FIG. 44, the method 2200 begins with receiving, from a first golf cart, a signal at step 2202. The signal may correspond with a mode of operation of the first golf cart. The first golf cart may be the first vehicle 910 and the signal may be the first signal 912, as described herein. The second vehicle 920 may receive the first signal 912 from the first vehicle 910. By way of example, the second vehicle 920 may receive the first signal 912 emitted by the beacon 64 of the first vehicle 910. By way of another example, the second vehicle 920 may receive the first signal 912 from the first vehicle 910 via the communications network 210.

As shown in FIG. 44, the method 2200 includes determining, based on the signal, a mode of operation of the first golf cart at step 2204. In some embodiments, the mode of operation of the first golf cart is determined by matching a signal profile of the signal with a known signal profile corresponding to a mode of operation of golf carts. By way of example, the vehicle control system 100 of the second vehicle 920 may receive data corresponding to the first signal 912 of the first vehicle 910 (e.g., from the sensor system 70 of the second vehicle 920, etc.) and determine that the first vehicle 910 is in an autonomous mode of operation based on data corresponding to the first signal 912.

As shown in FIG. 44, the method 2200 includes operating, based on the mode of operation, a second golf cart to perform an operation at step 2206. In some embodiments, the vehicle control system 100 of the vehicle 10 may operate the vehicle 10 based on the mode of operation of another of the vehicles 10. By way of example, the vehicle control system 100 of the second vehicle 920 may operate the second vehicle 920 based on the mode of operation of the first vehicle 910. The method 2200 may include operating the second golf cart based on an autonomous mode of operation of the first golf cart (e.g., an autonomous driving mode of operation, an autonomous passing mode of operation, an autonomous move request mode of operation, etc.) and/or a manual mode of operation of the first golf cart (e.g., a manual driving mode of operation, a manual passing mode of operation, a manual move request mode of operation, etc.).

In some embodiments, the method 2200 includes autonomously operating the second golf cart to drive the second golf cart based on the mode of operation of the first golf cart. By way of example, the vehicle control system 100 may autonomously operate the second vehicle 920 to drive toward a side of the cart path 320 based on the first vehicle 910 being operated in a passing mode of operation such that the first vehicle 910 may pass the second vehicle 920. By way of another example, the vehicle control system 100 of the second vehicle 920 may autonomously operate the second vehicle 920 to drive out of a path of the first vehicle 910 based on the first vehicle 910 being operated in a move request mode of operation such that the second vehicle 920 is moved out of the path of the first vehicle 910. By way of yet another example, the vehicle control system 100 of the second vehicle 920 may autonomously operate the second vehicle 920 to form a train with the first vehicle 910 based on the first vehicle 910 being operated in a go to green mode of operation such that the second vehicle 920 follows the first vehicle 910 to a green site proximate a green of a golf course.

In some embodiments, the method 2200 includes operating the second golf cart to provide an indicator to an operator of the second golf cart based on the mode of operation of the first golf cart. By way of example, the vehicle control system 100 of the second vehicle 920 may operate the operator interface 48 of the second vehicle 920 to provide an indication (e.g., an element on a display, etc.) indicating that the first vehicle 910 is in a passing mode of operation based on the first vehicle 910 being in the passing mode of operation such that the operator of the second vehicle 920 may manually operate the second vehicle 920 to allow for the first vehicle 910 to pass the second vehicle 920. By way of another example, the vehicle control system 100 of the second vehicle 920 may operate the operator interface 48 of the second vehicle 920 to provide an indication indicating that the first vehicle 910 is in a move request mode of operation based on the first vehicle 910 being in the move request mode of operation such that the operator of the second vehicle 920 may manually operate the second vehicle 920 to move the second vehicle 920 out of the way of the first vehicle 910. By way of yet another example, the vehicle control system 100 of the second vehicle 920 may operate the user device 232 of a user associated with the second vehicle 920 (e.g., an operator of the second vehicle 920, etc.) to provide an indication (e.g., a notification on the user device 232, by vibrating the user device 232, etc.) indicating that the first vehicle 910 is in an autonomous mode of operation based on the first vehicle 910 being in the autonomous mode of operation such that the user of the user device 232 may be notified that the first vehicle 910 is operating autonomously and is located close to a location of the second vehicle 920.

In some embodiments, the method 2200 includes operating the second vehicle 920 based on the mode of operation of the first vehicle 910 when a distance between the first vehicle 910 and the second vehicle 920 is less than a distance threshold (e.g., the first vehicle 910 is within a too close region of the second vehicle 920, the first vehicle 910 is within a range of the second vehicle 920, the first vehicle 910 being within a geofence bubble associated with the second vehicle 920, etc.). By way of example, the vehicle control system 100 of the second vehicle 920 may determine that the first vehicle 910 is a distance away from the second vehicle 920 that is less than the distance threshold and operate the user device 232 of an operator of the second vehicle 920 to provide an indication indicating that the first vehicle 910 is in an autonomous mode of operation based on the first vehicle 910 being in the autonomous mode of operation such that the user of the user device 232 may be notified that the first vehicle 910 is operating autonomously. By way of another example, the vehicle control system 100 of the second vehicle 920 may receive an indication from the remote systems 240 that the first vehicle 910 is within a geofence bubble of the second vehicle 920 (e.g., based on relative locations of the first vehicle 910 and the second vehicle 920, etc.) and may then operate the second vehicle 920 based on the mode of operation of the first vehicle 910.

In some embodiments, the method 2200 includes changing a mode of operation of the second golf cart based on the mode of operation of the first golf cart. By way of example, the vehicle control system 100 of the second vehicle 920 may activate a performance limiting mode of operation of the second vehicle 920 based on the first vehicle 910 being in a manual mode of operation such that performance of the second vehicle 920 is limited while the second vehicle 920 is proximate the first vehicle 910 that is being manually operated by an operator. By way of another example, the vehicle control system 100 of the second vehicle 920 may deactivate an autonomous mode of operation of the second vehicle 920 based on the first vehicle 910 being in a manually operated mode of operation (e.g., being manually operated, etc.) such that an operator of the second vehicle 920 manually drives the second vehicle 920 while the second vehicle 920 is proximate the first vehicle 910 that is being manually operated by an operator.

As utilized herein with respect to numerical ranges, the terms “approximately,” “about,” “substantially,” and similar terms generally mean +/−10% of the disclosed values, unless specified otherwise. As utilized herein with respect to structural features (e.g., to describe shape, size, orientation, direction, relative position, etc.), the terms “approximately,” “about,” “substantially,” and similar terms are meant to cover minor variations in structure that may result from, for example, the manufacturing or assembly process and are intended to have a broad meaning in harmony with the common and accepted usage by those of ordinary skill in the art to which the subject matter of this disclosure pertains. Accordingly, these terms should be interpreted as indicating that insubstantial or inconsequential modifications or alterations of the subject matter described and claimed are considered to be within the scope of the disclosure as recited in the appended claims.

It should be noted that the term “exemplary” and variations thereof, as used herein to describe various embodiments, are intended to indicate that such embodiments are possible examples, representations, or illustrations of possible embodiments (and such terms are not intended to connote that such embodiments are necessarily extraordinary or superlative examples).

The term “coupled” and variations thereof, as used herein, means the joining of two members directly or indirectly to one another. Such joining may be stationary (e.g., permanent or fixed) or moveable (e.g., removable or releasable). Such joining may be achieved with the two members coupled directly to each other, with the two members coupled to each other using a separate intervening member and any additional intermediate members coupled with one another, or with the two members coupled to each other using an intervening member that is integrally formed as a single unitary body with one of the two members. If “coupled” or variations thereof are modified by an additional term (e.g., directly coupled), the generic definition of “coupled” provided above is modified by the plain language meaning of the additional term (e.g., “directly coupled” means the joining of two members without any separate intervening member), resulting in a narrower definition than the generic definition of “coupled” provided above. Such coupling may be mechanical, electrical, or fluidic.

References herein to the positions of elements (e.g., “top,” “bottom,” “above,” “below”) are merely used to describe the orientation of various elements in the figures. It should be noted that the orientation of various elements may differ according to other exemplary embodiments, and that such variations are intended to be encompassed by the present disclosure.

The hardware and data processing components used to implement the various processes, operations, illustrative logics, logical blocks, modules, and circuits described in connection with the embodiments disclosed herein may be implemented or performed with a general purpose single-or multi-chip processor, a digital signal processor (DSP), an application specific integrated circuit (ASIC), a field programmable gate array (FPGA), or other programmable logic device, discrete gate or transistor logic, discrete hardware components, or any combination thereof designed to perform the functions described herein. A general purpose processor may be a microprocessor, or, any conventional processor, controller, microcontroller, or state machine. A processor also may be implemented as a combination of computing devices, such as a combination of a DSP and a microprocessor, a plurality of microprocessors, one or more microprocessors in conjunction with a DSP core, or any other such configuration. In some embodiments, particular processes and methods may be performed by circuitry that is specific to a given function. The memory (e.g., memory, memory unit, storage device) may include one or more devices (e.g., RAM, ROM, Flash memory, hard disk storage) for storing data and/or computer code for completing or facilitating the various processes, layers and modules described in the present disclosure. The memory may be or include volatile memory or non-volatile memory, and may include database components, object code components, script components, or any other type of information structure for supporting the various activities and information structures described in the present disclosure. According to an exemplary embodiment, the memory is communicably connected to the processor via a processing circuit and includes computer code for executing (e.g., by the processing circuit or the processor) the one or more processes described herein.

The present disclosure contemplates methods, systems, and program products on any machine-readable media for accomplishing various operations. The embodiments of the present disclosure may be implemented using existing computer processors, or by a special purpose computer processor for an appropriate system, incorporated for this or another purpose, or by a hardwired system. Embodiments within the scope of the present disclosure include program products comprising machine-readable media for carrying or having machine-executable instructions or data structures stored thereon. Such machine-readable media can be any available media that can be accessed by a general purpose or special purpose computer or other machine with a processor. By way of example, such machine-readable media can comprise RAM, ROM, EPROM, EEPROM, or other optical disk storage, magnetic disk storage or other magnetic storage devices, or any other medium which can be used to carry or store desired program code in the form of machine-executable instructions or data structures and which can be accessed by a general purpose or special purpose computer or other machine with a processor. Combinations of the above are also included within the scope of machine-readable media. Machine-executable instructions include, for example, instructions and data which cause a general purpose computer, special purpose computer, or special purpose processing machines to perform a certain function or group of functions.

Although the figures and description may illustrate a specific order of method steps, the order of such steps may differ from what is depicted and described, unless specified differently above. Also, two or more steps may be performed concurrently or with partial concurrence, unless specified differently above. Such variation may depend, for example, on the software and hardware systems chosen and on designer choice. All such variations are within the scope of the disclosure. Likewise, software implementations of the described methods could be accomplished with standard programming techniques with rule-based logic and other logic to accomplish the various connection steps, processing steps, comparison steps, and decision steps.

It is important to note that the construction and arrangement of the vehicle 10 and the systems and components thereof (e.g., the body 20, the operator controls 40, the driveline 50, the suspension system 60, the braking system 62, the beacon 64, the steering system 66, the sensor system 70, the vehicle control system 100, etc.) and the fleet monitoring and control system 200 (e.g., the remote systems 240, the user portal 230, the user sensors 220, etc.) as shown in the various exemplary embodiments is illustrative only. Additionally, any element disclosed in one embodiment may be incorporated or utilized with any other embodiment disclosed herein.

1. An autonomous golf cart system comprising:
one or more processing circuits configured to:
generate a green location proximate a green of a hole of a golf course;
monitor a current location of an autonomous golf cart;
acquire sensor data regarding an area of the golf course surrounding the autonomous golf cart; and
control operation of the autonomous golf cart to navigate from the current location to the green location based on the sensor data.

2. The autonomous golf cart system of claim 1, wherein the golf course includes a cart path, and wherein the one or more processing circuits are configured to control operation of the autonomous golf cart to navigate at least partially along the cart path from the current location to the green location.

3. The autonomous golf cart system of claim 2, wherein, when the current location and the green location are located along the cart path, the one or more processing circuits are configured to control operation of the autonomous golf cart to navigate entirely along the cart path from the current location to the green location.

4. The autonomous golf cart system of claim 2, wherein, when the current location is located off of the cart path, the one or more processing circuits are configured to control operation of the autonomous golf cart to navigate (i) from the current location to the cart path and (ii) at least partially along the cart path to the green location.

5. The autonomous golf cart system of claim 1, wherein the green location is generated based on a user input received from a user device remote from the autonomous golf cart.

6. The autonomous golf cart system of claim 1, wherein the green location is generated based on a location of a pin at the green of the golf course.

7. The autonomous golf cart system of claim 6, wherein the green location is located along a cart path of the golf course at a location where a distance between the pin and the cart path is minimized.

8. The autonomous golf cart system of claim 1, wherein the green is a first green and the hole is a first hole, wherein the golf course includes a second hole having a second green proximate the first green, and wherein the one or more processing circuits are configured to:
determine that a golfer associated with the autonomous golf cart is playing on the first hole; and
control the operation of the autonomous golf cart to navigate from the current location to the green location associated with the first hole.

9. The autonomous golf cart system of claim 1, wherein the one or more processing circuits include at least one of (i) a first processing circuit configured to be located on the autonomous golf cart or (ii) a second processing circuit configured to be located remote from the autonomous golf cart.

10. The autonomous golf cart system of claim 1, further comprising a sensor system configured to be installed on the autonomous golf cart, the sensor system configured to acquire the sensor data.

11. The autonomous golf cart system of claim 10, further comprising the autonomous golf cart.

12. The autonomous golf cart system of claim 1, wherein the one or more processing circuits are configured to:
generate a request based on an action of a golfer associated with the autonomous golf cart; and
initiate controlling the operation of the autonomous golf cart to navigate from the current location to the green location in response to the request.

13. The autonomous golf cart system of claim 12, wherein the request is generated on the autonomous golf cart.

14. The autonomous golf cart system of claim 12, wherein the request is generated remote from the autonomous golf cart.

15. An autonomous golf vehicle comprising:
a plurality of tractive elements;
a prime mover configured to drive at least one of the plurality of tractive elements to propel the autonomous golf vehicle;
a steering system configured to steer at least one of the plurality of tractive elements;
a sensor system; and
one or more processing circuits configured to:
acquire an indication of a green location proximate a green of a golf course;
acquire sensor data from the sensor system regarding an area of the golf course surrounding the autonomous golf vehicle; and
control the prime mover and the steering system to navigate the autonomous golf vehicle from a current location to the green location based on the sensor data.

16. The autonomous golf vehicle of claim 15, wherein the golf course includes a cart path, and wherein the one or more processing circuits are configured to control the prime mover and the steering system to navigate the autonomous golf vehicle at least partially along the cart path from the current location to the green location.

17. The autonomous golf vehicle of claim 15, wherein the green location is generated based on at least one of a location of a pin at the green of the golf course or a location of a golfer associated with the autonomous golf vehicle.

18. The autonomous golf vehicle of claim 15, wherein the one or more processing circuits are configured to:
receive a request based on an action of a golfer associated with the autonomous golf vehicle; and
initiate controlling the prime mover and the steering system to navigate the autonomous golf vehicle from the current location to the green location in response to receiving the request.

19. The autonomous golf cart of claim 18, wherein the request is generated on the autonomous golf vehicle or remote from the autonomous golf vehicle.

20. An autonomous golf cart system comprising:
an autonomous golf cart including:
a plurality of tractive elements;
a prime mover configured to drive at least one of the plurality of tractive elements to propel the autonomous golf cart;
a steering system configured to steer at least one of the plurality of tractive elements; and
a sensor system configured to acquire sensor data regarding an area of a golf course surrounding the autonomous golf cart, the golf course including a green and a cart path; and
one or more processing circuits configured to:
generate a green location proximate the green of the golf course;
monitor a current location of the autonomous golf cart; and
control the prime mover and the steering system to navigate the autonomous golf cart at least partially along the cart path from the current location to the green location based on the sensor data.
